(19) United States
(12) Patent Application Publication
(10) Pub. No.: US 2010/0265237 A1
(43) Pub. Date: Oct. 21, 2010

(54) EL DISPLAY DEVICE AND DRIVING METHOD THEREOF

(75) Inventor: Hitoshi TSUGE, Osaka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toshiba Mobile Display Co., Ltd., Fukaya-shi (JP)

(21) Appl. No.: 12/755,771

(22) Filed: Apr. 7, 2010

(30) Foreign Application Priority Data
Apr. 17, 2009 (JP) 2009-100698
Feb. 15, 2010 (JP) 2010-030179

(51) Int. Cl. G09G 5/00

(52) U.S. Cl. 345/211; 345/76

(57) ABSTRACT

There is provided an EL display device including: a drive transistor configured to determine an electric current to be supplied to the EL element; and a capacity for retaining a gate voltage of the drive transistor, wherein a gate electrode of the drive transistor is connected to a first electrode, which is one of electrodes of the capacity, a first power source and a second power source are connected alternately to a second electrode, which is the other electrode of the capacity, a power source of a reference voltage is connected in a first period in which a signal from a source signal line is applied to the drive transistor, and an EL anodic power source is connected in a second period in which the drive transistor supplies an electric current to the EL element.

### CROSS-REFERENCE TO RELATED APPLICATIONS

This application is based upon and claims the benefit of priority from the prior Japanese Patent Application No. 2009-100698, filed on Apr. 17, 2009 and the prior Japanese Patent Application No. 2010-30179, filed on Feb. 15, 2010; the entire contents of which are incorporated herein by reference.

### FIELD OF THE INVENTION

The present invention relates to an EL display device using a self-emitting light display panel such as an EL display panel using an organic or inorganic electroluminescence (EL) element or the like and a driving method thereof.

### DESCRIPTION OF THE BACKGROUND

An active matrix-type image display device in which an organic EL material or an inorganic EL material is used as an electro-optic converting substance changes in light-emitting luminance according to a current written in a pixel. The EL display device is of a self-emitting type having a light emitting element in each pixel. The EL display device has advantages such that visibility of images is high, light-emitting efficiency is high, no backlight is necessary, and response speed is high in comparison with a liquid crystal display panel.

In organic EL (PLED, OLED, OEL) panels, development of an active matrix system is in progress. This system is configured to control a current flowing in a light-emitting element in an interior of each pixel circuit by a positive element (in general, a thin film transistor, TFT) provided in the interior of the each pixel circuit (JP-A-2003-255856, JP-A-2003-271095).

The EL display panel employs a transistor array formed of low-temperature or high-temperature polysilicon to configure the panel. However, an organic EL element suffers from display unevenness when transistor characteristics of the polysilicon transistor array vary.

In other words, when a drive transistor which supplies a drive current to an EL element has characteristic variations, converted current signals also vary correspondingly. Normally, the transistor has the characteristic variations of 50% or more. Therefore, there is a problem that the characteristic variations of the drive transistor are displayed as display unevenness, and the image display quality is degraded.

Accordingly, the invention provides an EL display device which realizes image display without characteristic display unevenness and a driving method thereof.

### SUMMARY OF THE INVENTION

According to embodiments of the invention, there is provided an EL display device including pixels having an EL element arranged into a matrix pattern including:

a drive transistor configured to determine a current to be supplied to the EL element; and a capacity for retaining a gate voltage of the drive transistor, wherein

a gate electrode of the drive transistor is connected to a first electrode, which is one of electrodes of the capacity, (1) a first power source is connected to a second electrode, which is the other electrode of the capacity, in a first period in which a signal from a source signal line is applied to the drive transistor, and (2) a second power source is connected to the second electrode, which is the other electrode of the capacity, in a second period in which the drive transistor supplies an electric current to the EL element.

According to the embodiments of the invention, an image display without characteristic display unevenness is realized.

### BRIEF DESCRIPTION OF THE DRAWINGS

FIG. 1 is a drawing showing a configuration of a pixel of an EL display device according to a first embodiment of the invention;

FIG. 2 is an explanatory drawing showing a driving method of the EL display device according to the first embodiment;

FIG. 3 is a drawing showing a configuration of the pixel in the EL display device in a reference example;

FIG. 4 is a drawing showing a configuration of the pixel in the EL display device according to the first embodiment;

FIGS. 5A and 5B are drawings showing configurations of a power source of the EL display device;

FIG. 6 is a drawing showing a configuration of the power source of the EL display device;

FIG. 7 is a drawing showing a configuration of the pixel in the EL display device;

FIG. 8 is a drawing showing a configuration of the pixel in the EL display device;

FIG. 9 is a drawing showing the driving method of the EL display device;

FIG. 10 is a drawing showing a configuration of the pixel in the EL display device;

FIG. 11 is an explanatory drawing showing a driving method of the pixel in FIG. 10;

FIG. 12 is a drawing showing a configuration of the pixel in the EL display device;

FIG. 13 is a drawing showing a configuration of the pixel in the EL display device;

FIG. 14 is an explanatory drawing showing a driving method of the pixels in FIG. 12 and FIG. 13;

FIG. 15 is a drawing showing a configuration of the pixel in the EL display device;

FIG. 16 is an explanatory drawing showing a driving method of the pixel in FIG. 15;

FIG. 17 is a drawing showing a configuration of the pixel in the EL display device;

FIG. 18 is a drawing showing a configuration of the pixel in the EL display device;

FIG. 19 is an explanatory drawing showing a driving method of the pixel in FIG. 17;

FIG. 20 is a drawing showing a configuration of the pixel in the EL display device;

FIG. 21A is a block diagram showing a power source generating unit used in the EL display device;

FIG. 21B is a block diagram showing the power source generating unit used in the EL display device;

FIG. 22 is a drawing showing wiring from the power source generating unit to an array substrate in the EL display device;

FIG. 23 is a drawing showing wiring from the power source generating unit to the array substrate in the EL display device;

FIG. 24 shows an equivalent circuit at the time of video signal writing in the pixel configuration in FIG. 1;

FIG. 25 shows an equivalent circuit when an EL element emits light in the pixel configuration in FIG. 1;

FIG. 26 is a drawing showing a circuit configuration of an analogue-digital converter;

FIG. 27 is a drawing showing a configuration of the pixel when a switch for switching an EL anodic power source and a reference voltage is used in common for two rows;

FIG. 28 is a drawing showing actions of respective switches in the circuit configuration in FIG. 27;

FIG. 29 is a drawing showing a pixel circuit in a current driving system of the EL display device;

FIG. 30A to FIG. 30C are drawings showing fluctuations of a drive transistor gate voltage when the EL anodic power source in the pixel circuit shown in FIG. 29 fluctuates;

FIG. 31 is a drawing showing a configuration in which a source driver having current and voltage outputs is applied to the EL display device;

FIG. 32 is a drawing showing a configuration of a power source circuit in the pixel circuit in FIG. 29;

FIG. 33 is a drawing showing a driving method of the pixel circuit in FIG. 29;

FIG. 34 is a drawing showing actions of an analogue output and a pixel circuit in the circuit configuration in FIG. 31;

FIG. 35 is a drawing showing the pixel circuit in which an n-type drive transistor is used;

FIG. 36 is a drawing showing a voltage fluctuation at a nodal point A in the pixel circuit in FIG. 3;

FIG. 37 is a drawing showing an EL anodic power source wiring in the EL display device;

FIG. 38 is a drawing showing a pixel circuit of the EL display device;

FIG. 39 is a drawing showing an action of the pixel circuit in the reference example in FIG. 3;

FIG. 40A is a drawing showing a fluctuation of a gate voltage of a drive transistor 14 in FIG. 37 at a pixel 106b;

FIG. 40B is a drawing showing the fluctuation of the gate voltage of the drive transistor 14 in FIG. 37 at a pixel 106e;

FIG. 41 is a drawing showing wiring from the power source generating unit to the array substrate in a case where the reference voltage and an analogue power source are different;

FIG. 42 is a drawing showing the pixel circuit of the EL display device;

FIG. 43 is a drawing showing the pixel circuit of the EL display device;

FIG. 44 is a drawing showing an action of the pixel circuit in FIG. 42;

FIG. 45 is a drawing showing an action of the pixel circuit in FIG. 43;

FIG. 46 is a drawing showing a relationship of a lifetime with respect to a ratio of black insertion;

FIG. 47 is a drawing showing actions of an EL element and switches during an illuminating period and a non-illuminating period in the pixel circuits in FIG. 42 and FIG. 43;

FIG. 48 is a drawing showing a display pattern where white and black are displayed alternately at every two rows;

FIG. 49A and FIG. 49B are drawings showing fluctuations in current values of the switches, the EL anodic power source, and an EL cathodic power source which supply an electric current to the EL element in the display pattern shown in FIG. 48;

FIG. 50 is a drawing showing an action of changing a display luminance with respect to an illumination rate;

FIG. 51A is a drawing showing a pattern in which a left side part of the pattern where white and black are displayed alternately at every two rows is changed into a pattern where all the rows are white;

FIG. 51B is a drawing showing fluctuations in current value in the pattern in FIG. 51A;

FIG. 52 is a drawing showing a circuit for applying a voltage in line sequence to a plurality of rows of reference voltage lines;

FIG. 53 is a drawing showing signal wiring to gate drivers and switches of respective pixels in the pixel configuration shown in FIG. 27;

FIG. 54 is a drawing showing a drive waveform in the pixel configuration in FIG. 38;

FIG. 55 is a drawing showing a configuration of a system in which the EL display device in the first embodiment is used;

FIG. 56 is a drawing showing a video camera in which the EL display device in the first embodiment is used;

FIG. 57 is a drawing showing a digital camera in which the EL display device in the first embodiment is used;

FIG. 58 is a drawing showing a mobile information terminal in which the EL display device in the first embodiment is used;

FIG. 59 is a configuration drawing showing the EL display device in the first embodiment;

FIG. 60 is a drawing showing a pixel circuit in the EL display device having a signal line selected driving function;

FIG. 61 is a drawing showing a drive waveform in a circuit in FIG. 60;

FIG. 62 is a drawing showing a pixel circuit having a signal line selecting function and source signal lines different depending on whether the rows are odd-numbered rows or even-numbered rows;

FIG. 63 is a drawing showing a drive waveform in the pixel circuit in FIG. 62;

FIG. 64 is a drawing showing a pixel circuit in the EL display device according to a second embodiment;

FIG. 65 is a drawing showing the pixel circuit in the EL display device according to the second embodiment;

FIG. 66 is a drawing showing the pixel circuit in the EL display device according to the second embodiment;

FIG. 67 is a timing chart of the EL display device according to the second embodiment;

FIG. 68 is a drawing showing the pixel circuit in the EL display device according to the second embodiment;

FIG. 69 is an action waveform chart of the pixel circuit in FIG. 68;

FIG. 70 is a drawing showing the pixel circuit in the EL display device according to the second embodiment;

FIG. 71 is a drawing showing the pixel circuit of the n-type drive transistor according to the second embodiment;

FIG. 72 is a drawing showing a drive waveform of the pixel circuit in the EL display device according to a third embodiment;

FIG. 73 is a drawing showing a pixel circuit in the EL display device according to a fourth embodiment;

FIG. 74 is a drawing showing a drive waveform of the pixel circuit in the EL display device according to the fourth embodiment;

FIG. 75 is a drawing showing a pixel circuit in the EL display device according to a fifth embodiment;

FIG. 76 is a drawing showing a drive waveform of the pixel circuit of the EL display device according to the fifth embodiment; and

FIG. 77 is a drawing showing a pixel circuit in the EL display device according to a modification of the fifth embodiment.

### DETAILED DESCRIPTION OF THE INVENTION

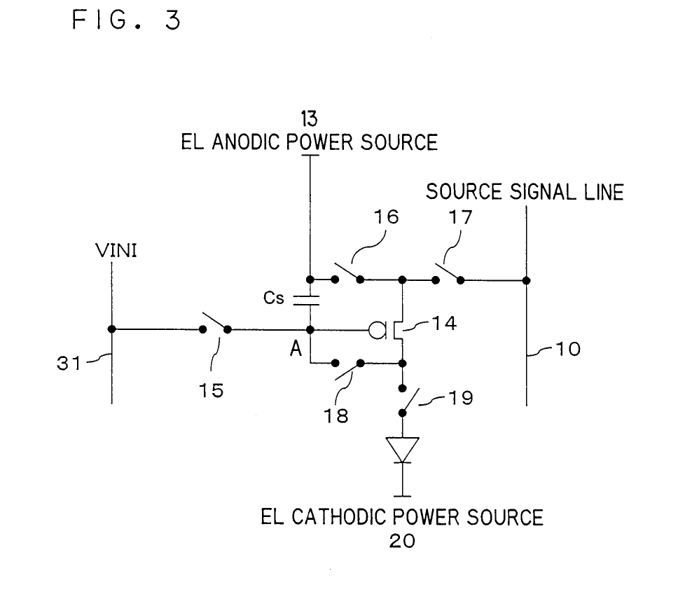

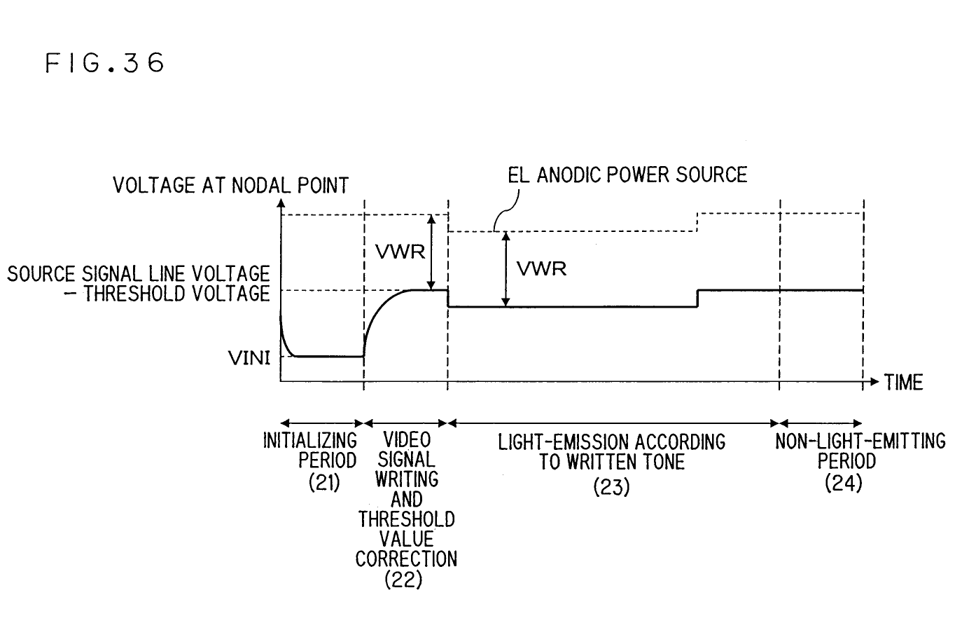

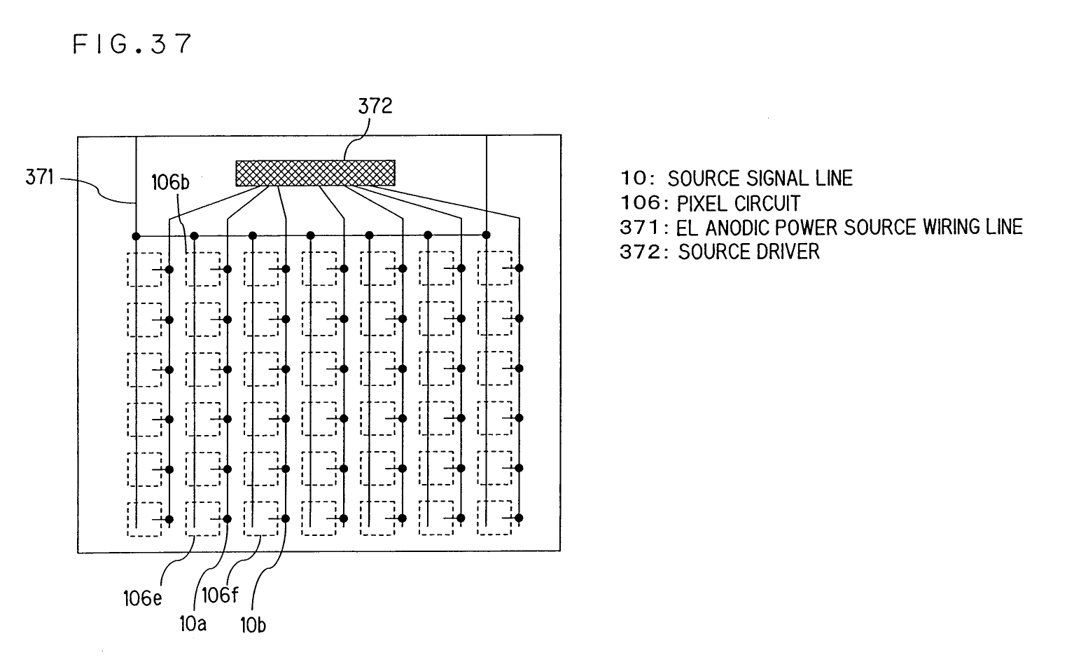

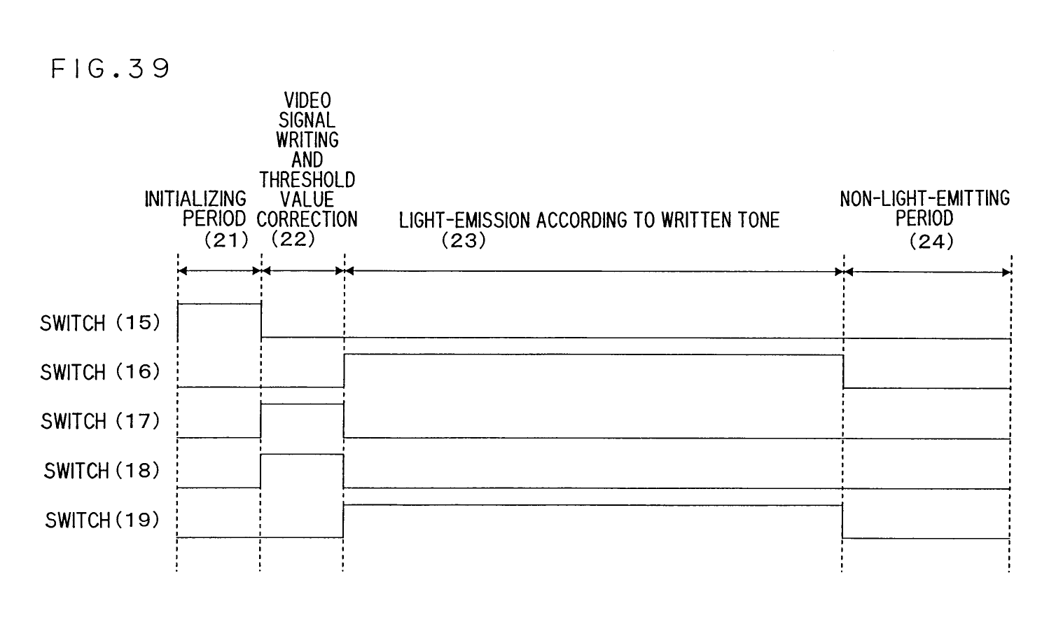

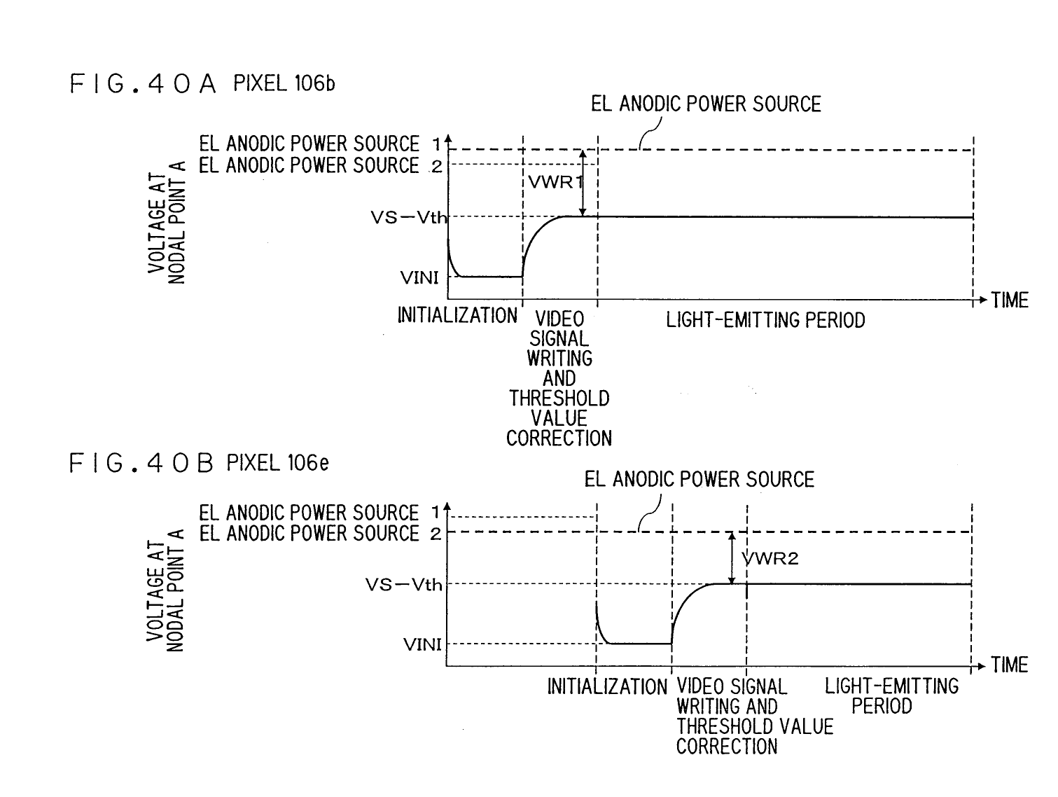

Referring now to FIG. 3, FIG. 36, FIG. 37, FIG. 39, and FIG. 40, an EL display device in a reference example will be described.

FIG. 3 is a drawing showing a circuit per pixel in the EL display device in the reference example. Here, switches 15 to 19 are made generally up of a transistor.

FIG. 39 shows an action in one frame in a pixel circuit in FIG. 3. One frame includes an initializing period 21, a video signal writing and threshold value correcting period 22, a light-emitting period 23, and a non-light-emitting period 24. Actions of the respective switches are shown by a high level as a conducting state and a low level as a non-conducting state.

In the initializing period, in order to perform a subsequent threshold correcting actions quickly, an initialization power source 31 (VINI) is applied to a gate voltage (nodal point A) of a drive transistor 14. In order to allow a drain current to flow, a low voltage is applied when the drive transistor 14 is a p-type transistor, and a high voltage is applied when it is an n-type transistor.

Subsequently, in the video signal writing and threshold value correcting period 22, a voltage according to a tone which is desired to be displayed is written in a pixel from a source signal line 10. According to the action of the switches in FIG. 39, a source signal line voltage is applied to a source voltage of the drive transistor 14, and a voltage which is lower than the source signal line voltage by an amount corresponding to the threshold voltage of the drive transistor 14 is applied to the gate voltage (nodal point A) of the drive transistor 14. A potential difference between an EL anodic power source 13 and the nodal point A of the video signal writing and threshold value correcting period 22 is retained for one frame by an accumulation capacity Cs.

In the subsequent light-emitting period 23, an electric current flows through the drive transistor 14 on the basis of an electric charge accumulated in the accumulation capacity Cs, and the EL element 81 emits light.

The non-light-emitting period 24 is brought into a non-light-emitting state in which a current flows through the EL element 81 when the switch 19 is brought into the non-conducting state, which is not necessarily required. A same visual effect as black insertion in the liquid crystal panel may be provided.

The voltage at the nodal point A is fluctuated as shown in FIG. 36.

When a display device is fabricated by wiring the EL anodic power source 13 as shown by reference numeral 371 in FIG. 37, there is a case where a large current may flow through the EL anodic wiring 371 for allowing a large current to flow to the EL element 81 depending on display patterns. Voltages different from pixel to pixel may be supplied as the EL anodic power voltage 13 due to existence of a wiring resistance. For example, a pixel 106b may be supplied with a voltage PVDD1 as a potential drop is little because it is located near a supply source, while a pixel 106e may be supplied with a voltage PVDD2 as the potential drop is large because it is located far from the supply source.

In contrast, a voltage supplied from the source signal line is not much affected by the wiring resistance because the electric current is low, and a same voltage (for example, VS) is applied to all the pixels when the voltage output from a source driver is not varied.

Voltage fluctuations at the nodal points A of the pixel 106b and the pixel 106e will be shown in FIG. 40A and FIG. 40B.

FIG. 40A shows about the pixel 106b, and FIG. 40B shows about the pixel 106e. The same voltages are applied to the nodal points A of the both pixels. Here, the characteristics of the drive transistors 14 are the same, but the EL anodic power sources 13 are different.

In this case, the voltages applied to the accumulation capacities Cs are VWR1 in the pixel 106b and VWR2 in the pixel 106e even though the same tones are written. In the light-emitting period, the drain current of the drive transistor 14 flows on the basis of the voltage to be applied to the accumulation capacity Cs. Therefore, the electric currents flowing through the pixel 106b and the pixel 106e in the EL elements 81 are different so that the displays at different degrees of luminance with respect to the same tone input are resulted.

### First Embodiment

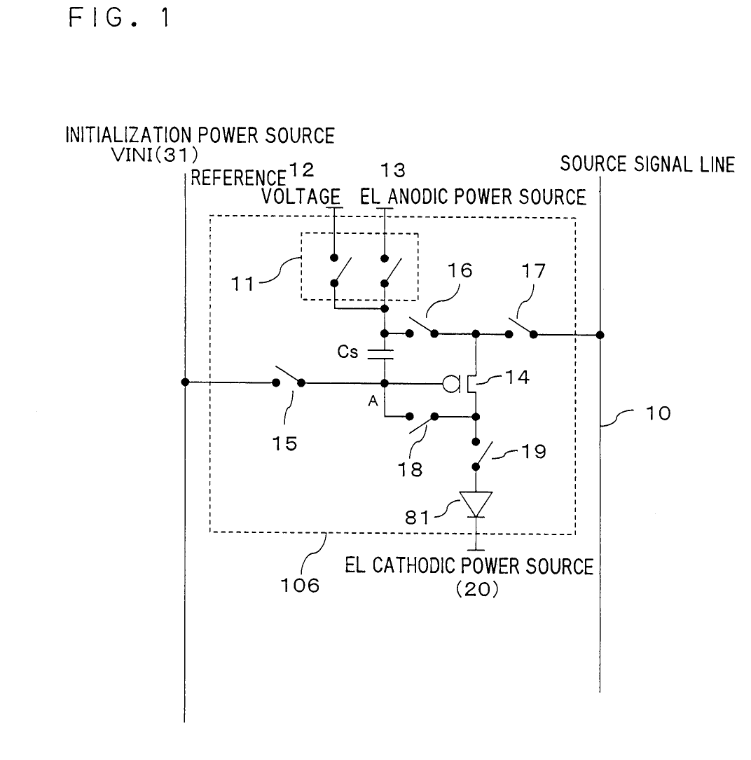

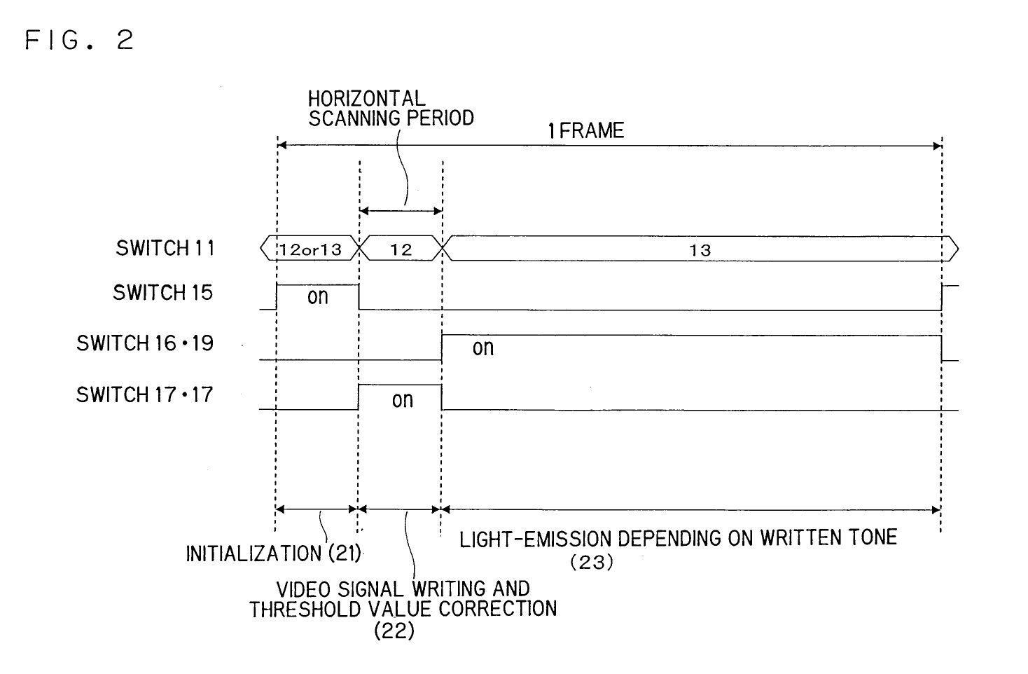

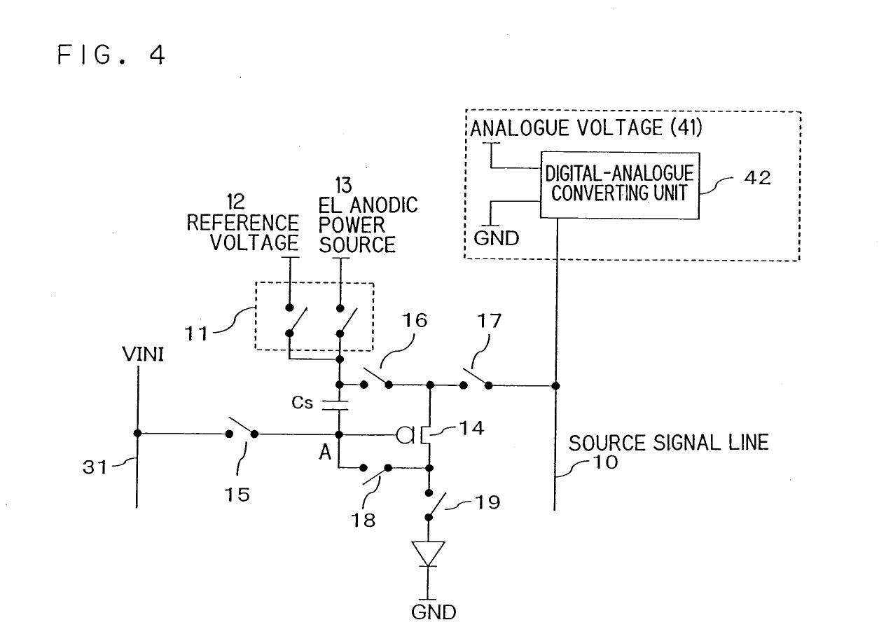

Referring now to FIG. 1, FIG. 2, and FIG. 4 to FIG. 63, the EL display device according to the first embodiment of the invention will be described.

FIG. 1 shows a circuit configuration of the EL display device in this embodiment. This configuration is characterized in that a reference voltage 12 is added to the pixel circuit in the reference example in FIG. 3, so that the voltage of an electrode different from the nodal point A of the accumulation capacity Cs can be applied by switching from the EL anodic power source 13.

FIG. 2 shows an action in the circuit configuration in FIG. 1.

In the initializing period 21, the initialization power source 31 is applied to the nodal point A. At this time, a switch 11 may select any one of these power sources. It is because the initialization power source 31 may be set so as to achieve a voltage at the nodal point A which allows a sufficient flow of the drain current to the drive transistor 14 in an initial state of the subsequent video signal writing and threshold value correcting period 22. In the initializing period 21, since there is no path for allowing the electric current to flow within the pixel irrespective of which one of the reference voltage 12 and the EL anodic power source 13 is selected via the switch 11, so that the same voltage can be supplied to any of the pixels even though the each wiring line has the wiring resistance.

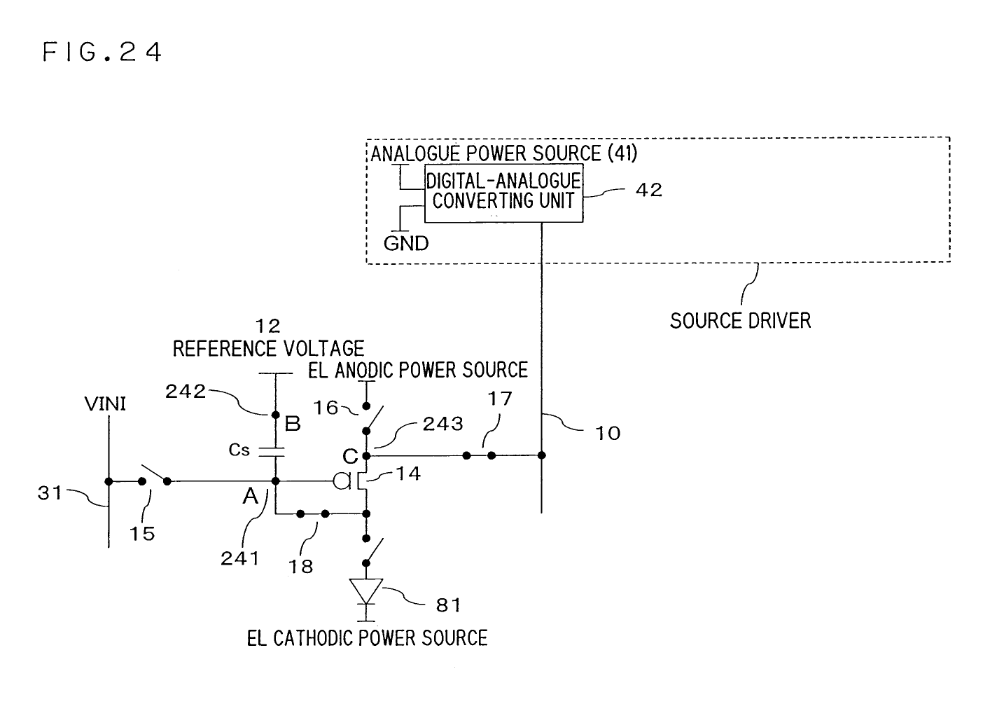

Subsequently, in the video signal writing and threshold value correcting period 22, the switch 11 selects the reference voltage 12. An equivalent circuit is shown as FIG. 24. Since the switch 16 is in the non-conducting state and only the accumulation capacity Cs is connected in the pixel circuit, the electric current does not flow to the reference voltage 12. Therefore, the same voltage can be supplied to all the pixels. An electric charge of an amount (voltage of reference voltage 12)−((voltage supplied from source signal line 10)−(threshold voltage of drive transistor 14)) is accumulated in the accumulation capacity Cs.

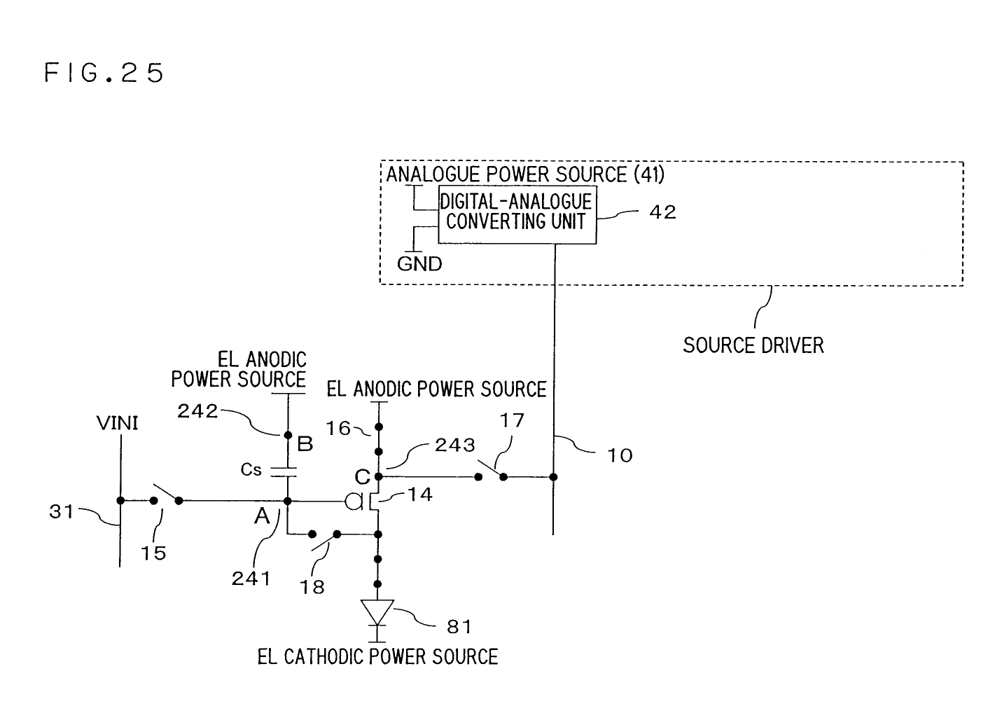

Finally, in the light-emitting period 23, the switch 11 selects the EL anodic voltage 13. The drive transistor 14 allows the drain current to flow into the EL element 81 on the basis of the voltage accumulated in the accumulation capacity Cs. At this time, the power source which supplies the electric current is the EL anodic power source 13 and an EL cathodic power source 20. The reference voltage 12 is not electrically connected to the pixel circuit, and the electric current does not flow neither in the light-emitting period 23. The equivalent circuit is shown in FIG. 25.

It is not necessary to supply a large current to the pixel from the reference voltage 12 in any period in one frame. Even though the same wiring as shown by the reference numeral 371 is done in a pixel array as shown in FIG. 37, substantially the same voltage can be supplied in all the pixels.

Accordingly, when the same voltages are supplied from the source signal line 10 and the threshold voltages of the drive transistors 14 are the same in the video signal writing and threshold value correcting period 22, the drift of the voltage to be accumulated in the accumulation capacity Cs is eliminated, and the voltages according to variations in voltages of the source signal line 10 and in threshold voltage of the drive transistors 14 can be accumulated in the accumulation capacity Cs, whereby the luminance fluctuations caused by the wiring resistance of the EL anodic power source line 371 can be prevented.

The wiring resistance of the EL anodic power source line 371 may be increased, whereby the wiring with thinner wire are enabled, so that a narrow frame design is allowed, and also the wiring design is allowed even with the pixel circuit having a smaller pixel area.

When the wiring widths are the same, the film thickness of a wiring layer may be reduced. It allows reduction of a wiring layer forming time and hence the cost reduction is achieved.

Even when the wiring resistance of the EL anodic power source line 371 is increased and the voltage drop is large until the voltage reaches the interior of the pixel, the voltages at a nodal point B and a nodal point C are lowered in an equivalent circuit drawing 25 in the light-emitting period 23, and the voltage at the nodal point A also drops in the same manner as the fluctuations at the nodal point B. Therefore, a gate-source voltage of the drive transistor 14 is kept constant without being affected by the voltage effect by the wiring resistance, so that the luminance fluctuation is prevented.

In the system of switching a power source at an end of the accumulation capacity Cs using the switch 11 as shown in FIG. 1, the source voltages of the reference voltage 12 and the EL anodic power source 13 can be changed. Although the reference voltage 12 when writing a video signal in the pixel affects the luminance, the EL anodic power source 13 and the EL cathodic power source 20 are of any voltage when causing the electric current to flow to the EL element 81. The minimum required potential difference is a sum of the voltage required for the EL element 81 and the source-drain voltage required for causing the drive transistor 14 to act as an electric current source.

As shown in FIG. 36, in the light-emitting period in which the EL anodic power source 13 is used, the electric current flowing to the EL element 81 is constant because the electric charge to be accumulated in the accumulation capacity Cs is maintained and hence a constant gate-source voltage is always applied to the drive transistor 14 even when the voltage of the EL anodic power source 13 fluctuates.

Since the arbitrary power sources may be used as the EL anodic power source 13 and the cathodic power source 20, one of them may be set to 0V (ground level). When being set to 0V, it is not necessary to prepare a voltage generating unit, so that reduction of a power source circuit is achieved.

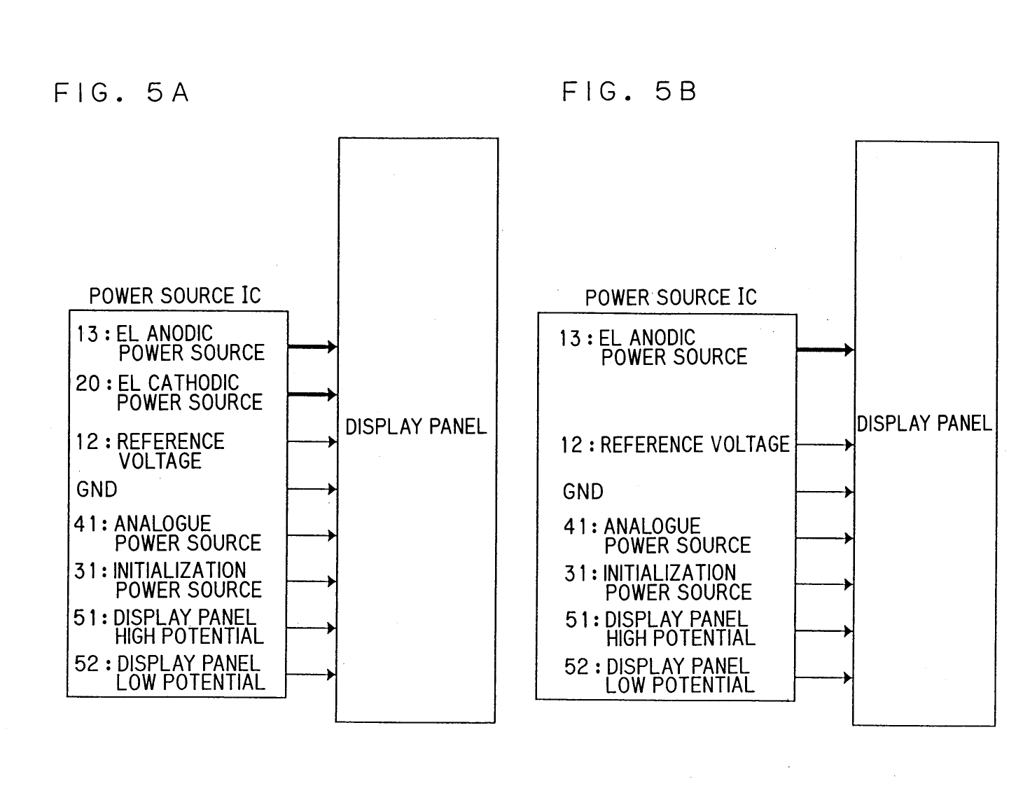

FIG. 4 shows a circuit in which the EL cathodic power source 20 is set to 0V (expressed as GND). According to the circuit configuration shown in FIG. 4, a power source IC as shown in FIG. 5B can be employed, and one power source may be reduced in comparison with the power source circuit (FIG. 5A) for the circuit shown in FIG. 1, whereby cost reduction and space saving by reduction of the number of components are realized. In particular, the EL anodic power source or the EL cathodic power source requires a large current capacity and occupies a large circuit area in comparison with other power sources, so that reduction of one power source is effective.

Here, setting the EL cathodic power source 20 to 0V in the configuration shown in FIG. 3 requires setting a blocking voltage of an output unit of the source driver to a high blocking voltage process of 10V or higher, or setting the potential difference between the EL anodic power source and the cathodic power source to 6V or lower.

The output of the source driver becomes a maximum voltage at the time of black display, and black is displayed when the voltages of the EL anodic power source 13 and the source signal line 10 are the same and the threshold value correcting action is sufficiently performed. The hither the voltage of the source signal line 10 with respect to the EL anodic power source 13, the less the electric current flows to the EL element 81. In contrast, the lower the voltage of the source signal line 10, the more electric current flows thereto.

An analogue power source 41 needs to have a voltage equal to or higher than the EL anodic power source 13 in order to perform the black display and to display deep black.

The maximum value of the analogue power source 41 is determined by the blocking voltage of the driver IC, and when considering reduction of the scale of the output stage of the driver IC and reduction of the deviation between the output terminals, the maximum voltage is in the order of 6V.

When the anodic voltage 13 is set to 6V, the EL element 81 and the drive transistor 14 are needed to be operated within 6V in total. However, the EL element 81 requires a voltage of 3V or higher and a voltage in the order of 3 to 5V is preferable for the drive transistor 14 because a signal of 6 to 10 bits is needed to be applied at an amplitude of 1V when writing the video signal and otherwise a resolution power falls short although the drive transistor 14 is normally operable at 1V.

Accordingly, by employing the configuration shown in FIG. 1 and FIG. 4 in contrast to the configuration in FIG. 3, application to the narrow frame design on the basis of the miniaturization of the wiring lines or to a display device having a smaller area per pixel or, alternatively, realization of the display device which can be fabricated in shorter film forming time at a lower manufacturing cost is achieved. In addition, in the configuration shown in FIG. 4, reduction in size of the power source circuit is achieved, so that cost reduction and space reduction are achieved and, in addition, since the number of output signals from a panel unit to an external flexible substrate is reduced, reduction of mounting cost and the cost of the flexible substrate is achieved.

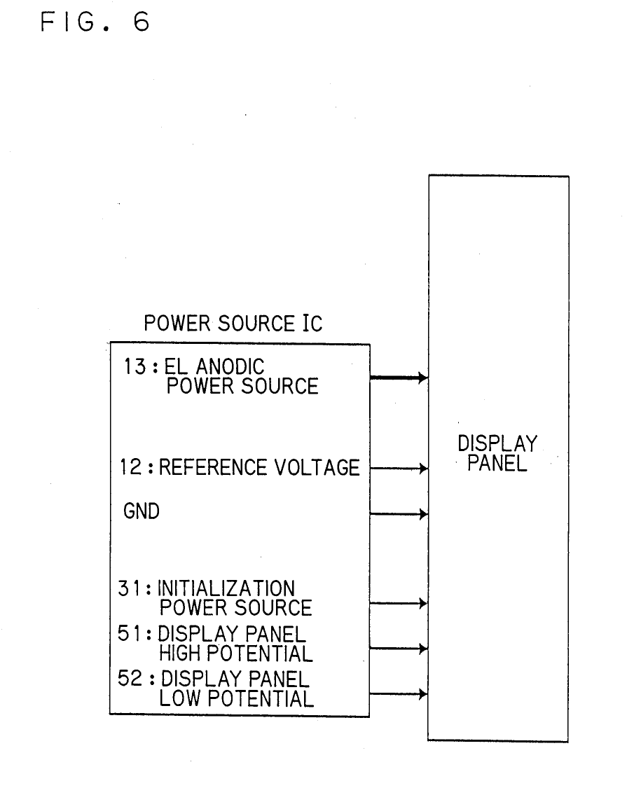

As regards the power source circuit, the theoretical maximum voltage of the source signal line must simply be the reference voltage 12 to be applied at the time of the black display, and the power source of a digital-analogue converting unit 42 can be used commonly with the reference voltage 12, so that still another power source can be reduced as shown in FIG. 6.

On the basis of the configuration in FIG. 5B, the analogue power source 41 and the reference voltage 12 may be configured individually, and the voltage of the reference voltage 12 may be set to a voltage lower than the analogue power source 41.

In the video signal writing and threshold value correcting period 22, a higher voltage can be applied as the voltage of a source electrode of the drive transistor 14, so that the voltage at the nodal point A becomes higher after having ended the video signal writing and threshold value correcting period 22 and hence the amount of the electric charge to be accumulated in the accumulation capacity Cs is reduced.

Since the drain current of the drive transistor 14 in the light-emitting period 23 is reduced, the display of deeper black is achieved.

Also, even when the threshold value correction is not sufficiently performed and hence the potential rise at the nodal point A is incomplete, a source-gate voltage of the drive transistor in the light-emitting period 23 is lowered by an amount of the potential difference between the analogue power source 41 and the reference voltage 12, so that occurrence of a black floating phenomenon is effectively avoided at the time of the black display.

When the analogue power source 41 and the reference voltage 12 are generated individually in the configuration in FIG. 5B, there is a case where the potential differences vary from one pixel to another when the voltages of the two power sources are fluctuated separately, thereby resulting in variations in luminance.

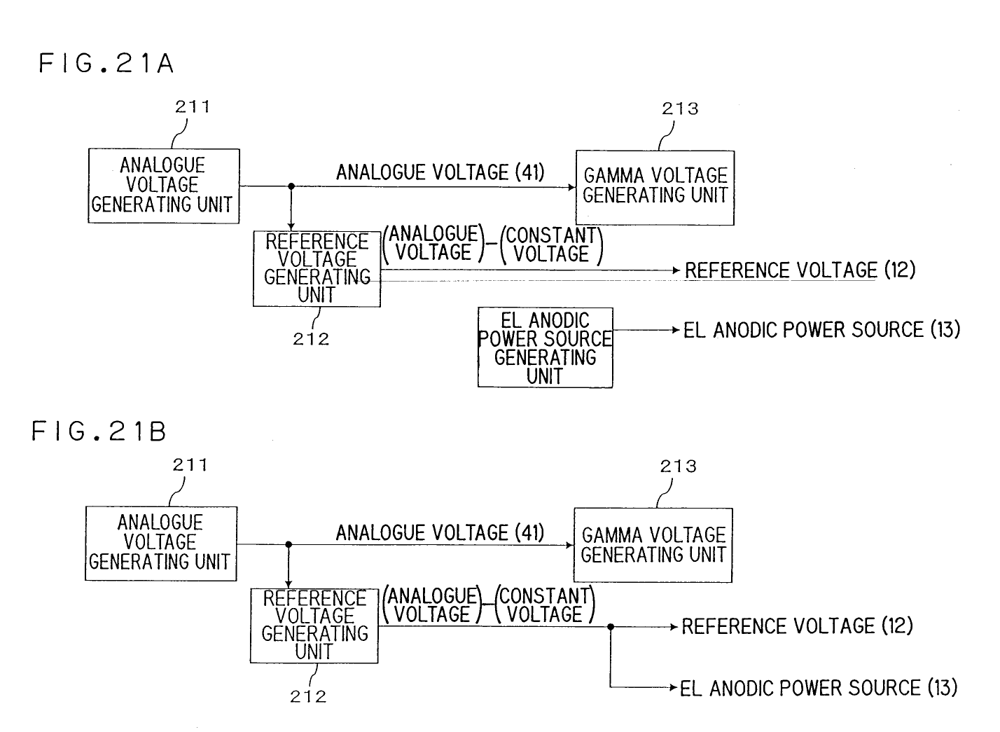

In order to prevent the luminance variations due to the fluctuations of the power source, a method of generating the power source as shown in FIG. 21A is effective as the power source circuit. In an analogue-voltage generating unit 211, a gamma voltage used in the digital-analogue converting unit of the source driver is generated. At the same time, the reference voltage 12 is generated at a reference voltage generating unit 212 on the basis of the voltage generated from the analogue-voltage generating unit 211. The reference voltage 12 is configured to have a circuit configuration which outputs a voltage lowered constantly by a certain voltage with respect to the analogue voltage 41, so that the analogue power source 41 and the reference voltage 12 are fluctuated in conjunction with each other, whereby the luminance variations caused by the individual fluctuations can be restrained. It is because that, in the video signal writing and threshold value correcting period 22, the potential differences between the tone voltage and the reference voltage 12 are the same in any pixel as long as the tones are the same.

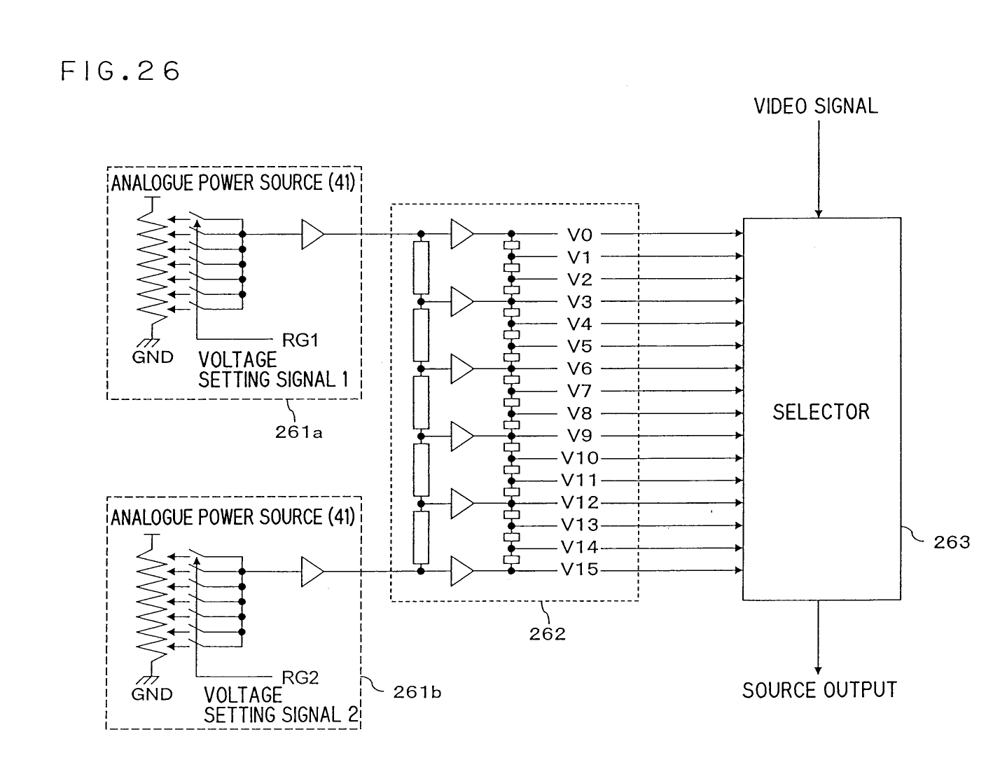

The configurations of the digital-analogue converting unit 42 and a gamma voltage generating unit are shown in FIG. 26. The power source for generating a gamma voltage is generated by the analogue power source 41 which is changed in conjunction with the reference voltage 12. FIG. 26 shows a configuration in which both the maximum voltage and the minimum voltage can be changed by an electronic volume 261, and the voltages of the maximum voltage and the minimum voltage are changed according to the fluctuations of the voltages of the analogue power sources 41 even though the settings are the same.

Since the voltages corresponding to the respective tones are generated by a resistance division shown by a reference numeral 262 using the outputs from the electronic volume 261, the voltage changes in conjunction with the analogue power sources 41. A video signal is converted into a voltage to be output to the source signal line by a selector 263 provided at each output of the source driver.

The tone signal output to the source signal line is output in conjunction with the analogue power source 41.

With the configuration as described above, since the voltage of one of the voltages of the source signal line voltage and the reference voltage 12 fluctuates in conjunction with the other one of those, constant voltages can be accumulated in the accumulation capacity Cs even when the voltage is fluctuated due to the wiring resistance or an external noise. The conditions are preferably such that the characteristics of the drive transistor 14 are the same and video signal amplitudes are the same.

Therefore, according to the pixel circuit in the first embodiment, the electric charges are held in the accumulation capacity Cs according only to the tones of the video signals and the characteristics of the drive transistors 14, realization of the display device insensitive to the power source fluctuations is achieved.

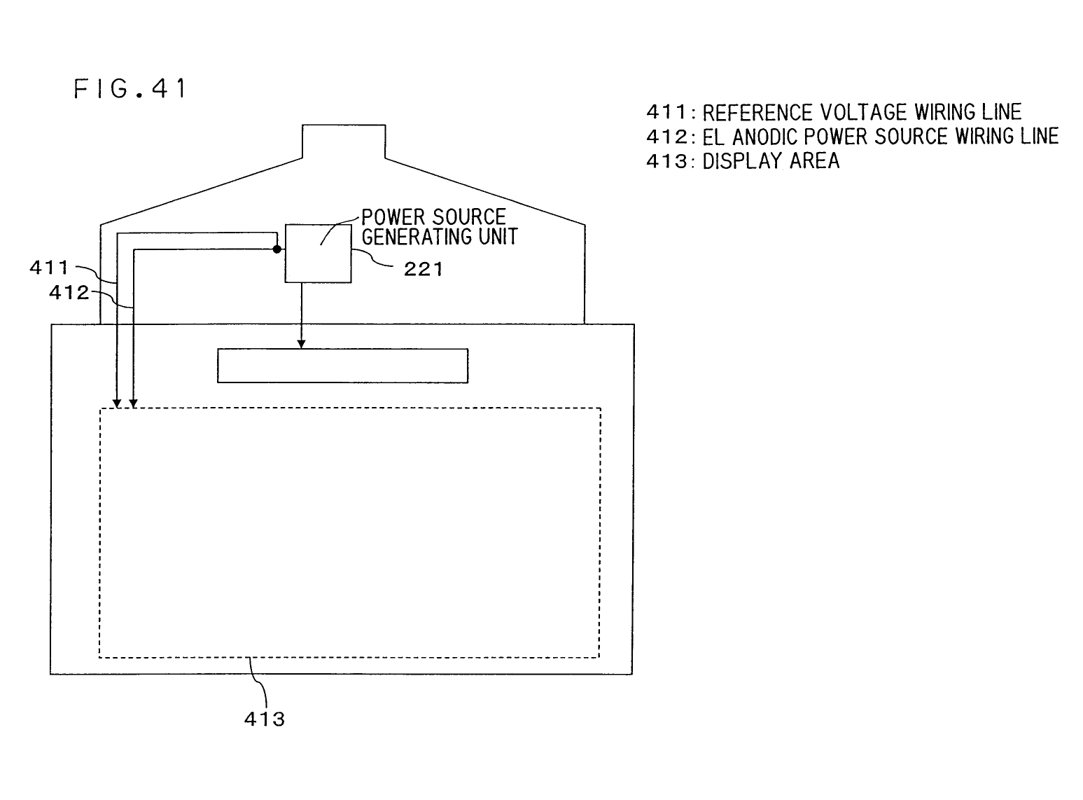

When the reference voltage 12 and the EL anodic power source 13 have the same voltage value, the voltage may be distributed from one reference voltage generating unit 212 as shown in FIG. 21B. In order to prevent an effect of the EL anodic current fluctuations and the potential fluctuations due to the wiring resistance, it is recommended to divide the EL anodic power source 13 and the reference voltage 12 at a position as close from a power source output unit as possible and provide individual wiring as shown in FIG. 41.

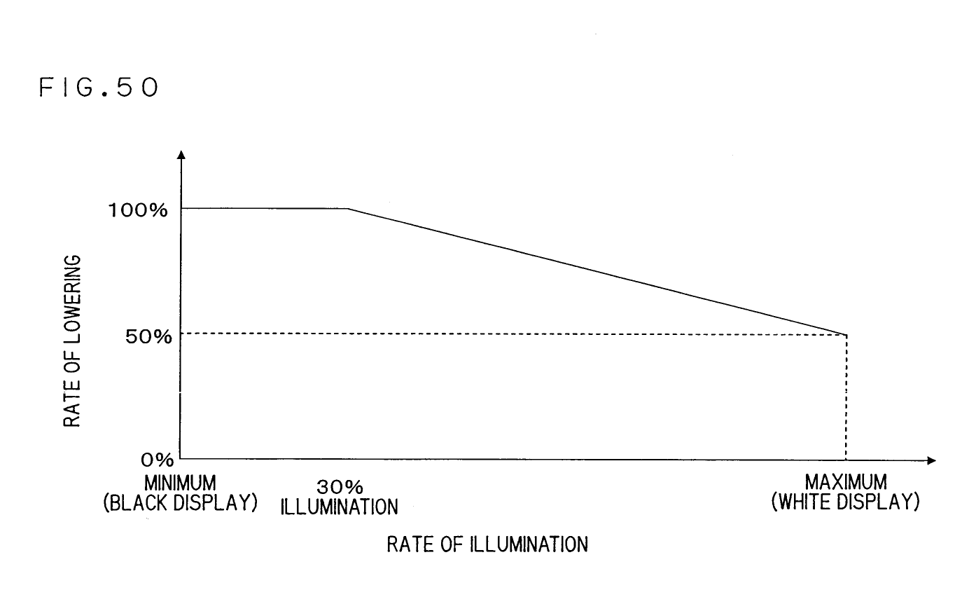

In order to reduce an electric power and downsize the power source circuit, there is a current restraining driving method which restrains the maximum current. The display pattern of the entire screen is detected and, when all the pixels having a maximum current value are illuminated at a highest luminance, the luminances of all the pixels are lowered by a predetermined value. The lowering rate varies according to the rate of illumination of a display section. The luminance is lowered to the maximum at the time of a white screen in which the rate of illumination is the maximum. The lowering rate is reduced with decrease of the rate of illumination, and the screen is illuminated as an input signal at the time of a black screen (see FIG. 50).

As a method of lowering the luminances of all the pixels by a certain value, there is a method of controlling the switches 16, 19 and 103 to provide a period in which no current flows to the EL element 81 in the period of one frame. It is a method of providing the non-light-emitting period 24 in FIG. 39. The longer the non-light-emitting period 24, the more luminance can be reduced. By changing the ratio of the light-emitting period 23 and the non-light-emitting period 24 in one frame, the lowering rate can be changed as shown in FIG. 50.

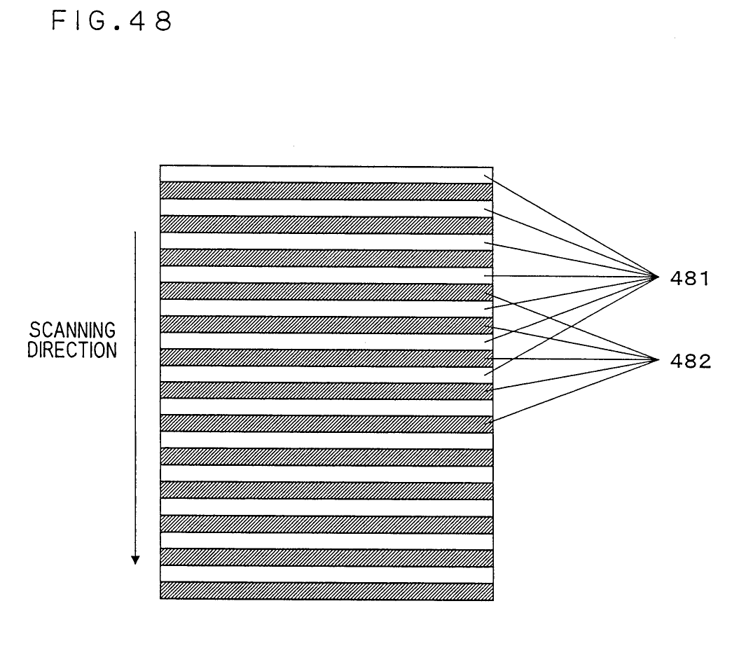

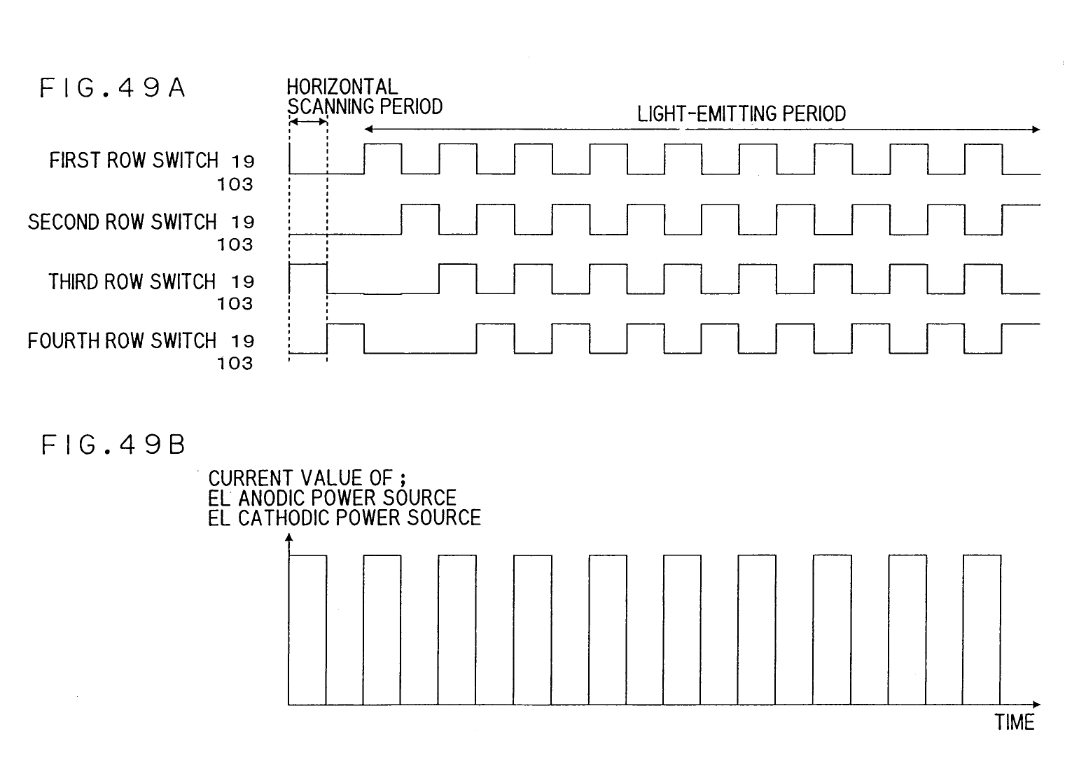

However, in the pixel configuration as shown in FIG. 3, when the light-emitting period 23 and the non-light-emitting period 24 are repeated at every horizontal scanning period as shown in FIG. 49A in a display pattern in which white (481) and black (482) are alternately repeated every two rows as shown in FIG. 48, the electric currents flowing to the EL anodic power source 13 and the EL cathodic power source 20 fluctuates significantly as shown in FIG. 49B. The electric current is specifically increased when the cycle in the vertical direction of the display pattern and the cycle of the light-emitting and non-light-emitting periods match, the switch of the rows 481 which are the white display and the switch of the rows 482 which are the black display are operated simultaneously, whereby flow of an electric current to cause pixels in half the rows to display white and flow of an electric current to cause pixels in half the rows to display black are performed alternately. The electric current at the time of the black display is substantially zero irrespective of the number of rows of the pixels, and an electric current of Iw flows at the time of the white display in this case. Since the electric currents are different significantly between the white display and the black display, the electric current of the EL power source fluctuates significantly. The electric currents for white (in the order of 30 to 100 mA) and black (0 mA) are flowed at every two horizontal scanning periods.

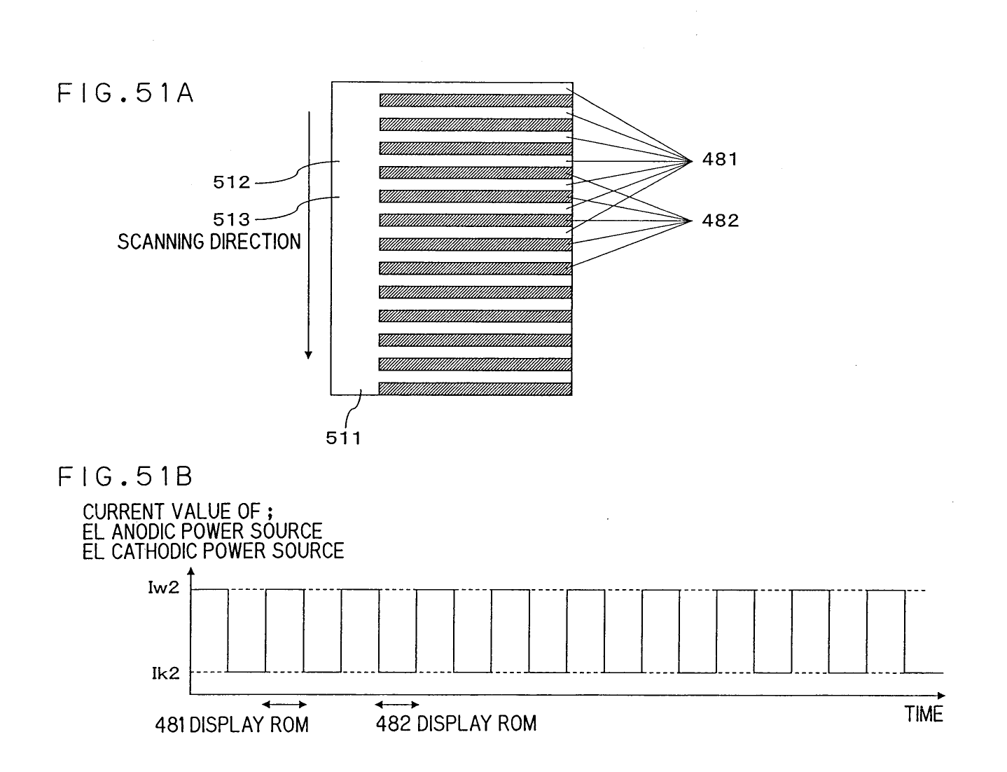

When part of the screen is set to the white display as the display pattern in FIG. 51A and the switch is operated as shown in FIG. 49A, the electric current flowing to the EL element 81 changes as shown in FIG. 51B.

In the case of the pixel configuration in the reference example, the electric current flowing to the EL anodic power sources 13 is changed between the display rows 481 and the display rows 482, and in areas 513 where the entire row is white and areas 512 including the black display portion in an area 511 where the white display continues in the vertical direction, the voltages of the EL anodic power source 13 are different in the video signal writing and threshold value correcting period 22 depending on the wiring resistance. Therefore, even when the voltage with respect to the identical video signal is supplied to the source signal line, there arises a problem of difference in luminance, and hence control as in FIG. 49A in which the light-emitting periods and the non-light-emitting periods are provided is impossible. If there is no non-light-emitting period, the electric current flows to the EL element uniformly during one frame, so that the current fluctuations as in FIG. 49B and FIG. 51B do not occur.

According to the embodiment in the invention, since the luminance does not change even when the voltage of the EL anodic voltage 13 fluctuates, a switching action as shown in FIG. 49A can be performed.

Accordingly, there is an advantage such that a current restraining function shown in FIG. 50 can be performed by adjusting the duration of the non-light-emitting period by the action of the switch 19.

In addition, the fact that the non-light-emitting period 24 can be provided means that the black display period can be provided. Provision of the black display period has such advantage that moving image responsiveness is improved. Even though the display device is a hold type, display such as a CRT of an impulse type is enabled by intermittent illumination. Improvement of the moving image responsiveness is effective in bringing out the characteristics of a fast-response organic EL element.

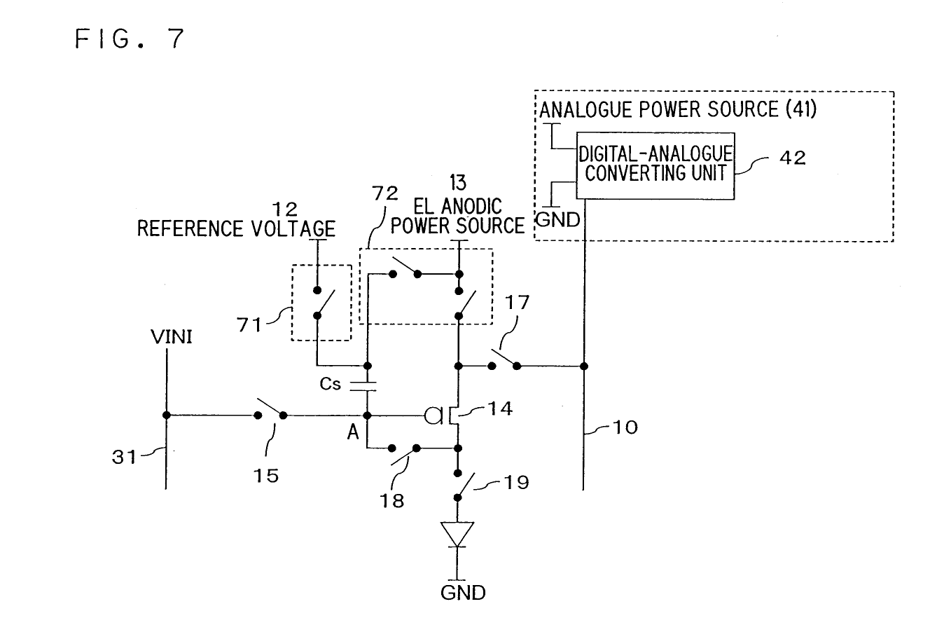

The switch 11 and the switch 16 in the configuration in FIG. 1 or FIG. 4 may be replaced with switches 71 and 72 shown in FIG. 7.

The switches 71 and 72 assume opposite phases in ON and OFF and, in this case, the switch 71 is configured to be in the conducting state during the initializing period 21 and the video signal writing and threshold value correcting period 22, and the switch 72 is configured to be in the conducting state during the light-emitting period 23. The analogue power source 41 may be common with the reference voltage 12 as described thus far.

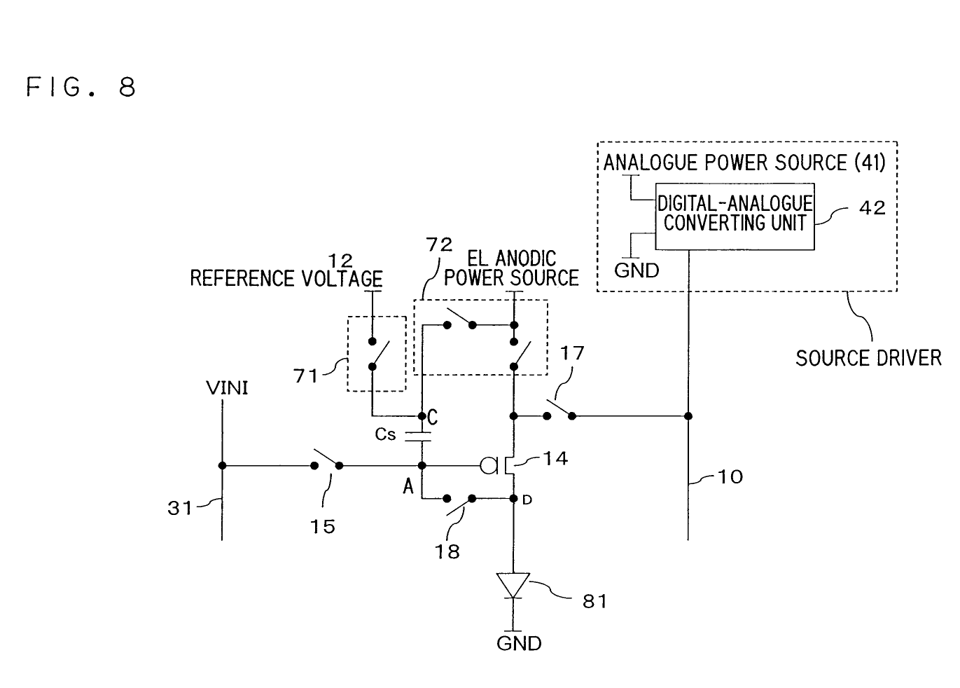

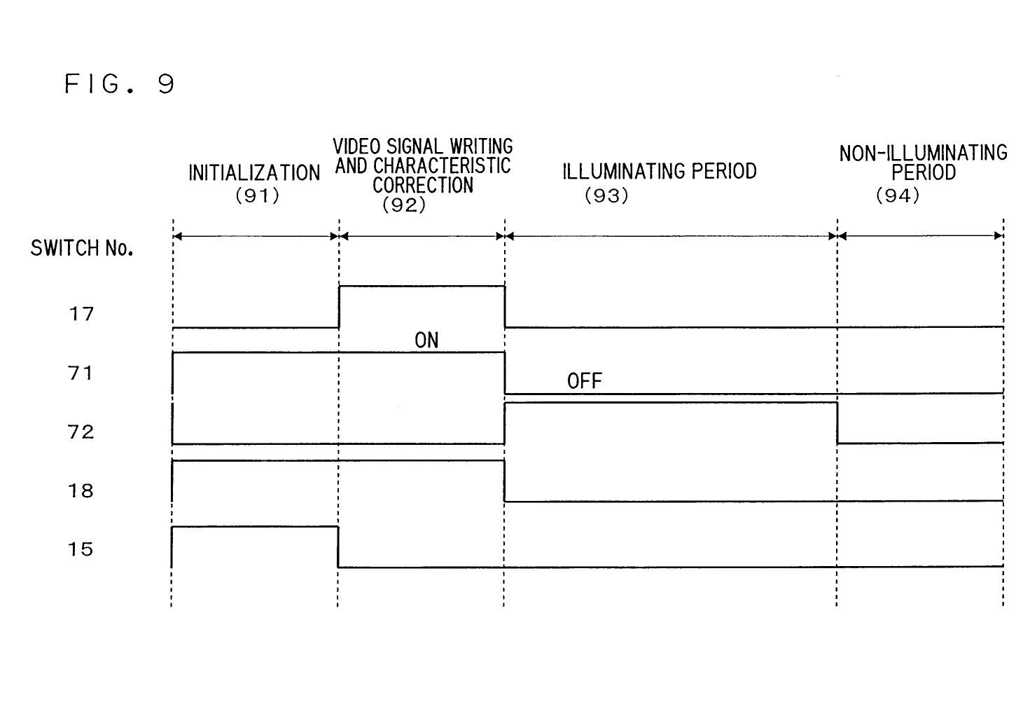

In the pixel circuit in which the reference voltage 12 is used, a first system for reducing the number of switches per pixel is shown in FIG. 8. The operations of the respective switches are shown in FIG. 9.

The switch 19 is eliminated from the configuration in FIG. 7.

In an initializing period 91, the initialization power source 31 is applied to a gate electrode of the drive transistor 14. The switch 72 is in the non-conducting state and the switch 17 for deriving a signal from the source signal line is also in the non-conducting state. Therefore, the drain current does not flow in the drive transistor 14 irrespective of the voltage of the gate electrode. In addition, by bringing the switch 18 into the conducting state, the initialization power source 31 is applied to the anodic electrode of the EL element 81. By setting the voltage of the initialization power source 31 to be a voltage lower than that of the cathodic electrode of the EL element 81, a reverse-biased voltage is applied to the EL element 81, so that no current flows. Accordingly, the same action as in a case where the switch 19 is brought into the non-conducting state in the configuration shown in FIG. 7 is achieved.

Subsequently, in a video signal writing and characteristic correcting period 92, a voltage corresponding to a video signal is applied to the source electrode of the drive transistor 14 from the source signal line 10. The voltage at the nodal point A rises to a voltage lowered from the voltage of the source signal line 10 by an amount corresponding to the threshold voltage. In the period 92, since the switch 18 is in the conducting state, a nodal point D assumes the same potential as the nodal point A. The voltage applied to the EL element 81 is the voltage at the nodal point D, and when the voltage at the nodal point D is lower than the threshold voltage of the EL element 81, no electric current flows to the EL element 81, and an offset cancelling action of the drive transistor 14 is enabled in the same manner as a case where the switch 19 is in the non-conducting state.

In an illuminating period 93, by bringing the switch 72 into the conducting state and other switches into the non-conducting state, the drain current of the drive transistor 14 corresponding to the electric charge accumulated in the accumulation capacity Cs flows to the EL element 81, thereby emitting light.

In order to bring a non-illuminating state, the switch 72 may be brought into the non-conducting state so that a power source supply path from the EL power source is blocked as shown in a non-illuminating period 94.

The switch 71 may either be in the conducting state and in the non-conducting state according to the controllability.

When writing the video signal, by determining the channel size of the drive transistor 14 and the voltage range of the source signal line 10 so that a voltage equal to or higher than the threshold voltage is not applied to the EL element 81, the switch 19 is no longer necessary, and the number of the transistors per pixel circuit can be reduced by one, whereby application to the smaller pixel area is achieved.

The same effect is achieved also by eliminating the switch 19 from the circuit shown in FIG. 4.

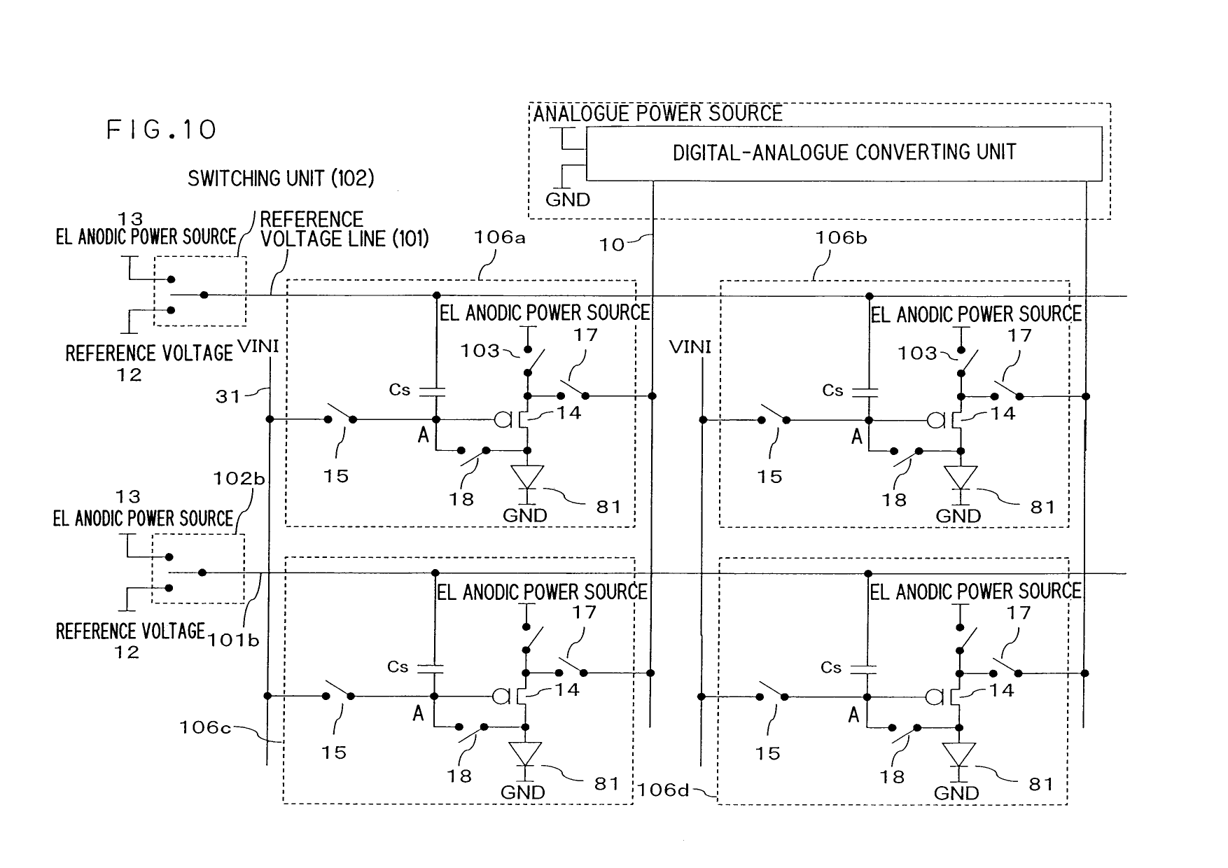

Downsized pixel circuits having a function to switch the voltage of an electrode which is different from the electrode to be connected to the gate electrode of the drive transistor 14 of the accumulation capacity Cs are shown in FIG. 10.

The configuration in FIG. 10 is characterized in that the function to switch the voltage at the nodal point C of the circuit in FIG. 8 is used commonly in every two rows, and one switching unit 102 is provided per row. Accordingly, two switches included in a pixel circuit 106 can be eliminated from the configuration in FIG. 8.

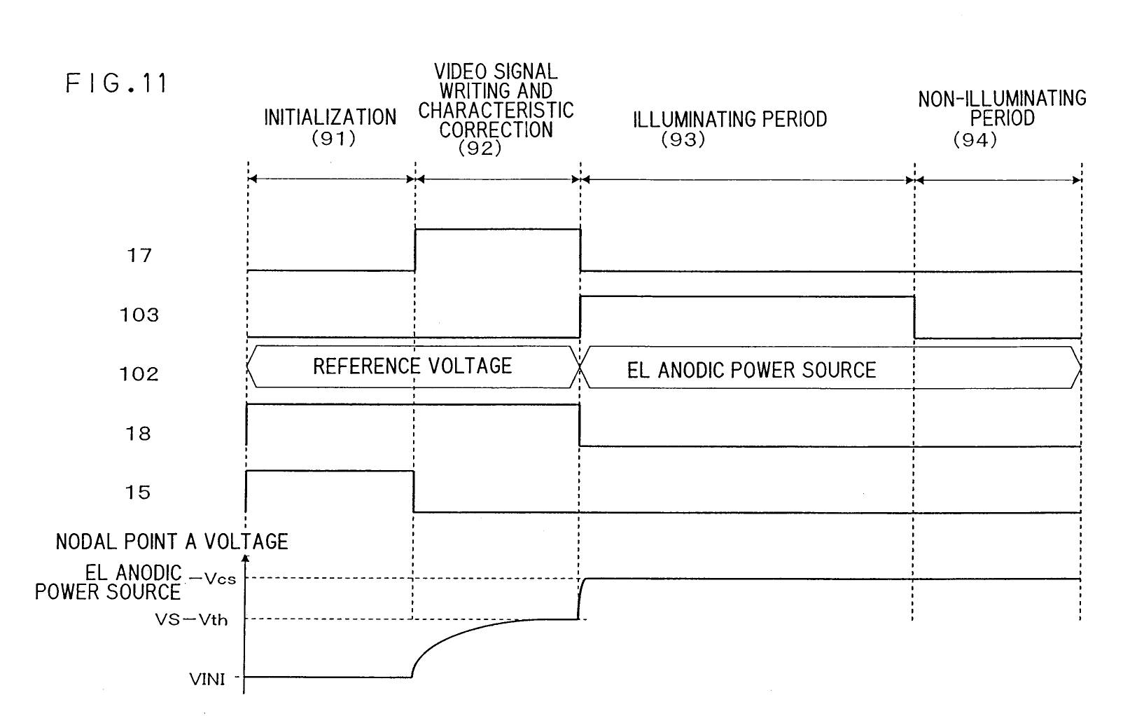

As shown in FIG. 11, by causing the respective switches to act, video signal writing, characteristic correction, and illumination as in FIG. 8 are enabled.

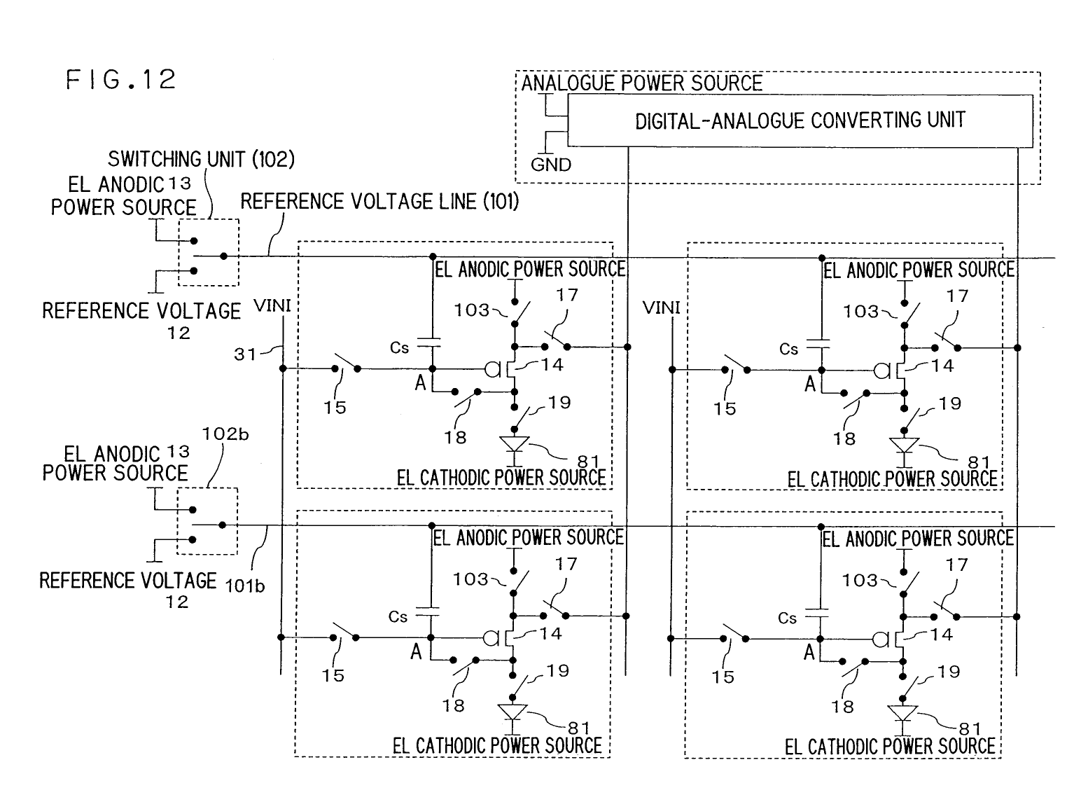

The action to switch the voltage at the nodal point C in FIG. 8 on the line-to-line basis can be implemented with the configurations in FIG. 1 and FIG. 4 in which the switch 19 exists. The circuit configuration is shown in FIG. 12.

A different point between FIG. 12 and FIG. 10 is that the threshold value is corrected by bringing the switch 19 into the non-conducting state in the video signal writing and characteristic correcting period 92 by the existence of the switch 19.

Although the number of the transistors per pixel is increased by one in comparison with the configuration in FIG. 10, the EL cathodic voltage 20 can be set to a given voltage including 0V, so that the amplitudes of the source signal line 10 can be determined irrespective of the threshold voltage of the EL element 81. Since the EL cathodic voltage 20 can be set to the given voltage, the EL anodic voltage 13 can also be designed at a given voltage in the same manner.

By designing the EL anodic power source 13 and the reference voltage 12 to the same voltage, the voltage of a reference voltage line 101 is maintained to substantially the same voltage for one frame except for the potential drop due to the wiring resistance. Therefore, it is superior in that the potential fluctuation in the reference voltage line 101 is small, and the coupling noise to other wiring lines due to the potential fluctuation is prevented from being generated.

In FIG. 12, a configuration in which the analogue power source 41 of the driver and the reference voltage 12 may be commonly used, or a configuration in which the voltage of only one of the power sources is dropped from the same voltage generating unit is also applicable.

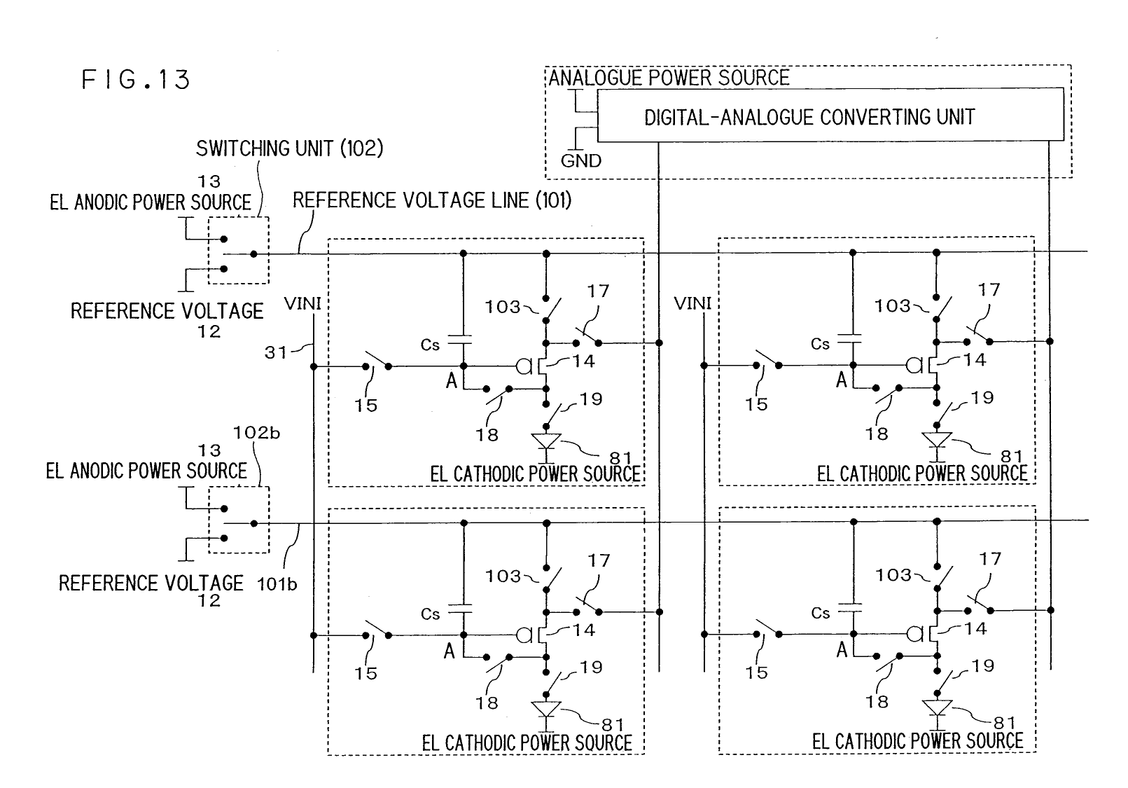

A configuration in FIG. 13 is characterized in that the power source at an end of the switching unit 102 is connected to the reference voltage line 101 instead of the direct connection with the EL anodic power source 13 in the configuration shown in FIG. 12. By supplying the EL anodic power source 13 via the reference voltage line 101, wiring for the EL anodic power source 13 in the interior of the pixel circuit 106 is not necessary any longer, so that the layout is facilitated by the effect of reduction of the number of provisions of the wiring lines.

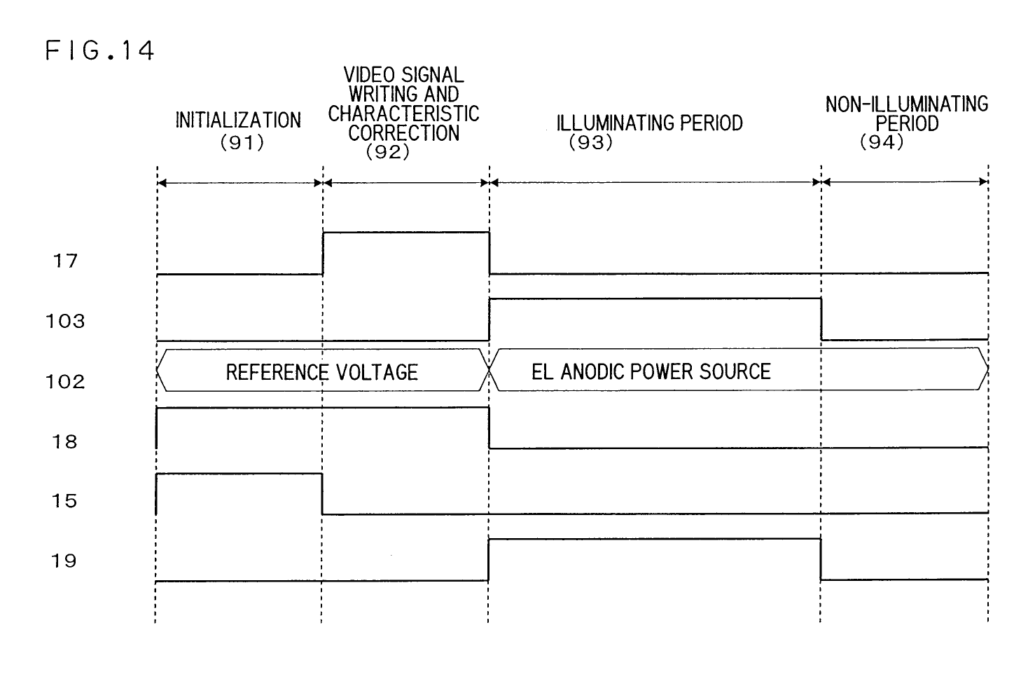

In the configuration in FIG. 13 as well, since the reference voltage 12 or the EL anodic power source 13 is switched by the switching unit 102 in each of the pixels in the same row, the reference voltage 12 is supplied to the pixel circuit 106 when the writing of the video signal is being performed. Since the switch 103 is in the non-conducting state as in FIG. 14, there is no path for supplying the electric current from the reference voltage 12 to the pixel circuit. Therefore, the voltage drop is small even when the wiring resistance exists, so that a constant reference voltage 12 can be supplied irrespective of the position of the pixel or the written tone, whereby the occurrence of the luminance unevenness due to the fluctuation of the voltage can be prevented as in the embodiment of the invention described thus far.

In contrast, since the EL anodic power source 13 is supplied to the pixel circuit in the display period, a large current flows only in the wiring line of the EL anodic power source 13, and a voltage is supplied from the switching unit 102 and the reference voltage line 101 via the accumulation capacity Cs and the switch 103.

Since the gate-source voltage of the drive transistor 14 is defined by the voltage accumulated in the accumulation capacity Cs, the drain current of the drive transistor 14 is not changed even when the EL anodic power source 13 fluctuates. Therefore, it is not necessary to care about the wiring resistance as regards the EL anodic power source 13, and the design with thin wiring lines or wiring with thin film thickness is also possible.

As regards the switching unit 102, it is recommended to provide only the switch of the EL anodic power source 13 at a low resistance. If the resistance is too high, the amount of lowering of the voltage is too large, and hence the voltage of the EL anodic power source 13 must be set to a high voltage in order to achieve application of sufficient voltage to the EL element 81. Therefore, power consumption is increased, and hence an ON resistance of the switching unit 102 is preferably set to a low value.

Since control of the switching unit 102 is performed synchronously with a sequence of the pixel circuit 106, the actions of all the rows can be activated by performing the sequential scanning by a shift resistor in the same manner as the control of the switches 15, 17 to 19, and switch 103.

The configurations in FIG. 12 and FIG. 13 can also be implemented in the same manner even when the switch 19 as in FIG. 10 does not exist.

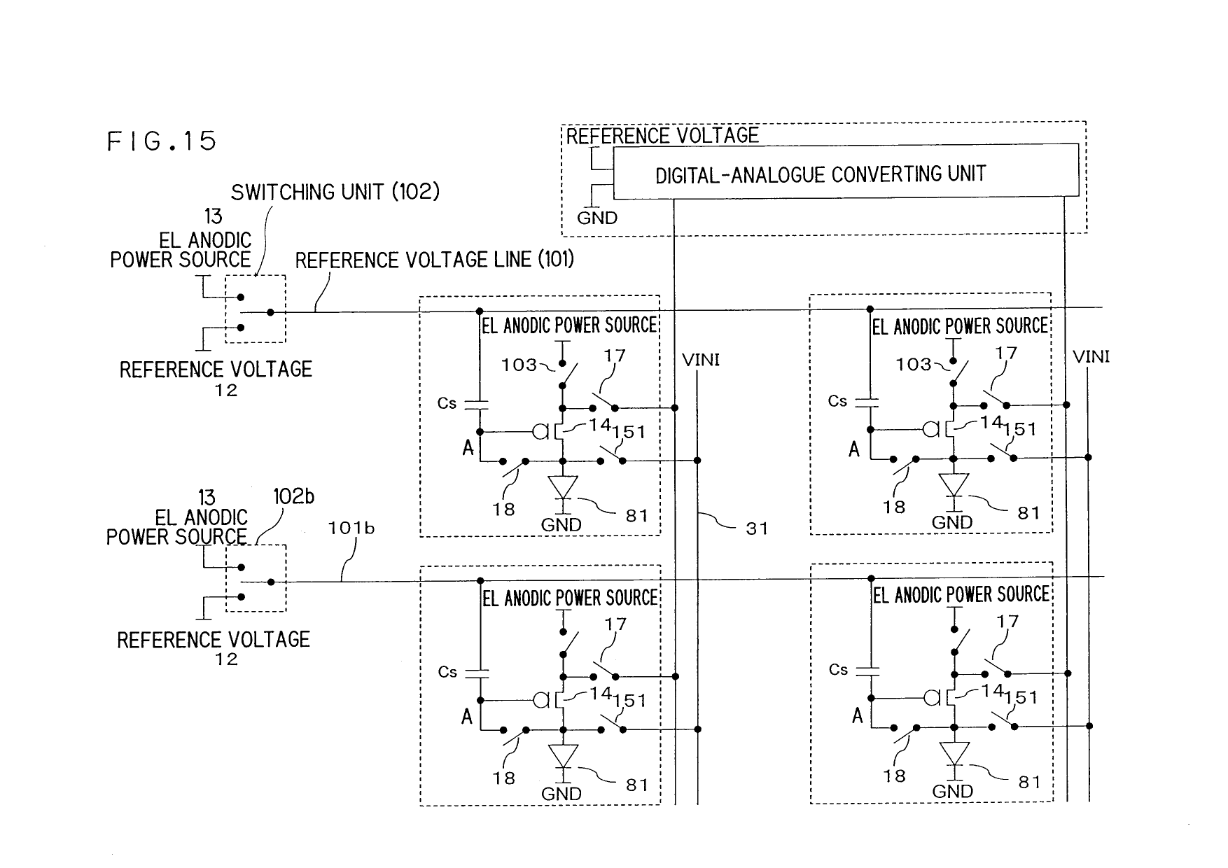

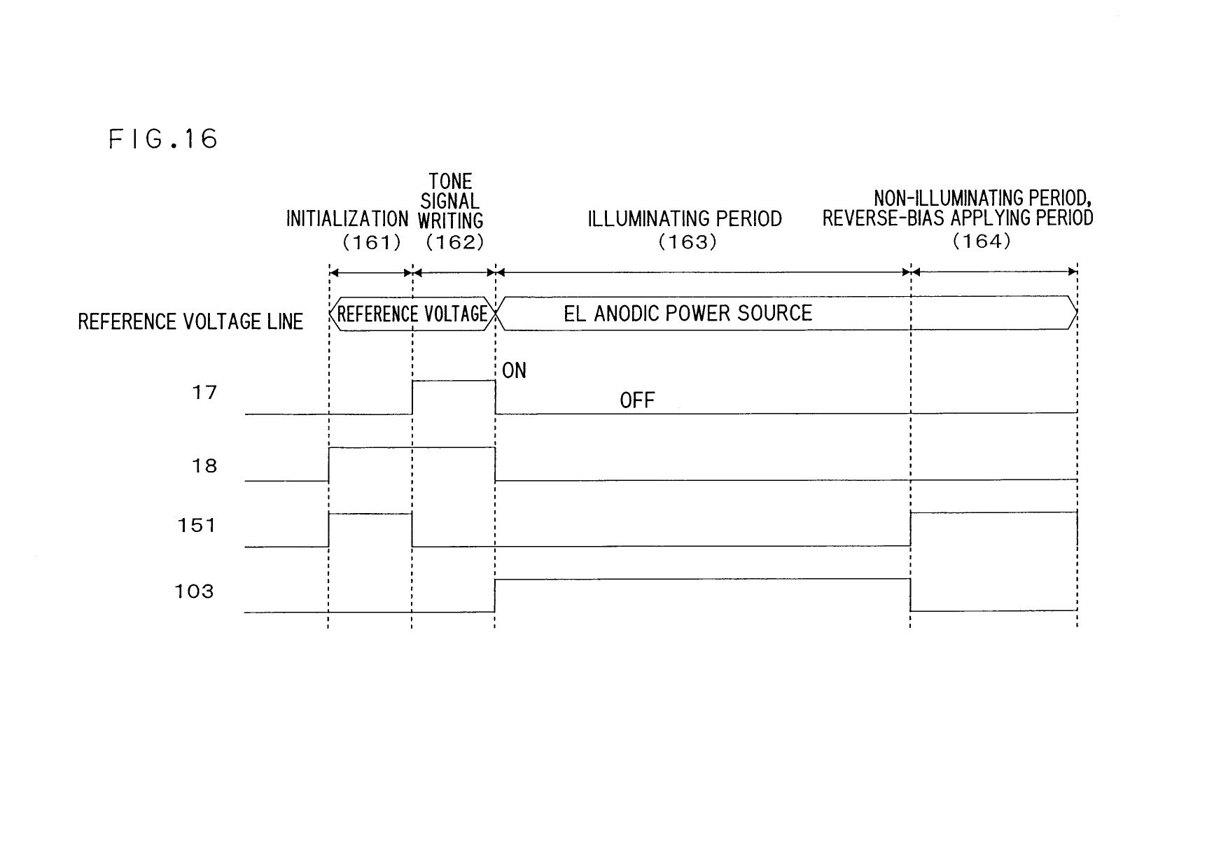

A configuration in FIG. 15 is characterized in that the initialization power source 31 for initialization can be input to the anodic electrode of the EL element 81 via a switch 151 instead of the gate electrode of the drive transistor 14 on the basis of the configuration in FIG. 10. FIG. 16 shows a signal waveform during one frame in the circuit configuration in FIG. 15.

The circuit configuration in FIG. 15 is characterized in that since the initialization power source 31 can be input to the anodic electrode of the EL element 81, a reverse bias can be applied to the EL element 81 by inputting the initialization power source 31 at a voltage lower than the cathodic electrode of the EL element 81.

Application of the reverse-biased voltage to the EL element 81 has an advantage such that an EL lifetime defined in the emission luminance of half or less the early stage is elongated in comparison with the case where the reverse-biased voltage is not applied.

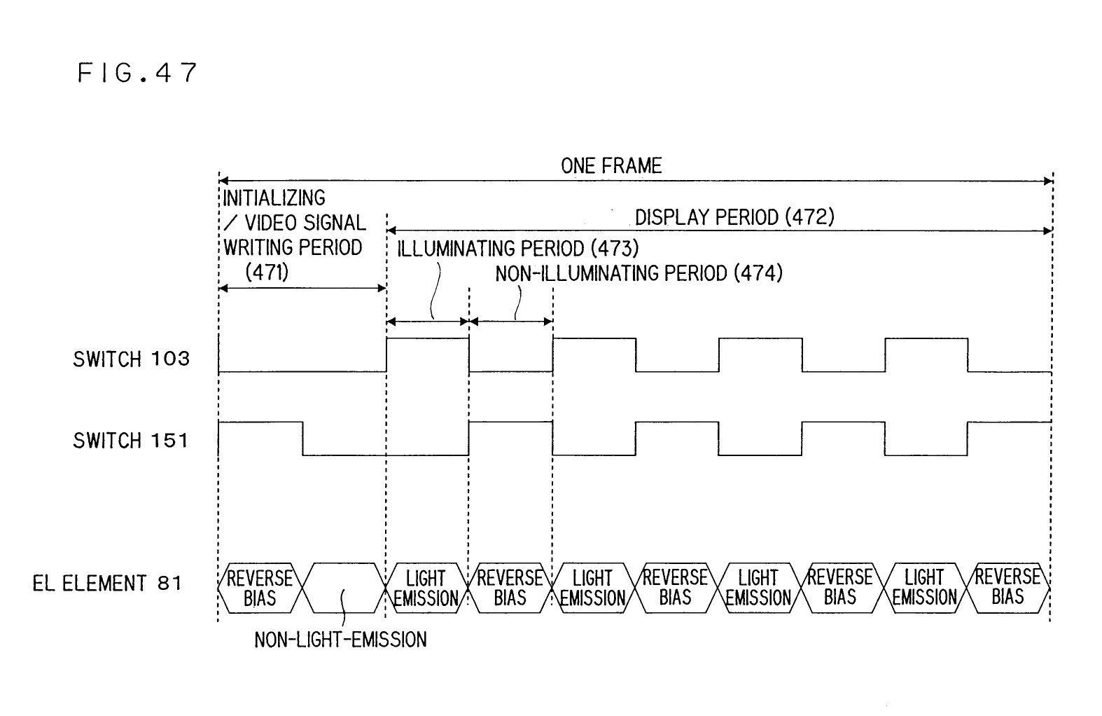

In this embodiment, provision of the non-light-emitting period is possible and illuminating periods 473 and non-illuminating periods 474 are provided in display period 472 excluding the initializing and writing periods also in FIG. 47. Although the illuminating period 473 and the non-illuminating period 474 are provided uniformly and alternately in this embodiment, they may be arranged in a given ratio at a given length. A configuration in which a first half is the illuminating period 473 and a latter half is the non-illuminating period 474 is also applicable. Also, the ratio may be changed from one frame to another by current restraining control.

The configuration in FIG. 15 is characterized in that the reverse-biased voltage can be applied to the EL element 81 by bringing the switch 151 into the conducting state in the non-illuminating period 474 (shown in FIG. 47).

At this time, since the switches 103, 17, and 18 are in the non-conducting state and the voltage at the nodal point A does not fluctuate, the electric charge accumulated in the accumulation capacity Cs does not fluctuate as well.

Accordingly, the illuminating period 473 can be implemented again after the non-illuminating period 474. Transition from the non-illuminating period 474 to the illuminating period 473 is achieved by bringing the switch 103 into the conducting state after having brought the switch 151 into the non-conducting state. The EL element 81 emits light on the basis of the electric charge accumulated in the accumulation capacity Cs in a video signal writing period 471. The EL element 81 emits light at the constant luminance in the illuminating period 473 even when there are any number of non-illuminating periods 474 interposed therein unless otherwise performed the initialization and video signal writing again.

In the circuit configuration shown in FIG. 10, an initializing voltage is applied to the accumulation capacity Cs when the initialization power source VINI (31) is applied in the non-illuminating period, and hence the luminance is changed. Therefore, the reverse bias can only be applied after having implemented the last illuminating period 473 in the display period 472. However, in the circuit configuration in FIG. 15, application of the reverse bias to the EL element 81 by the initialization power source 31 can be implemented anytime in the non-illuminating period 474.

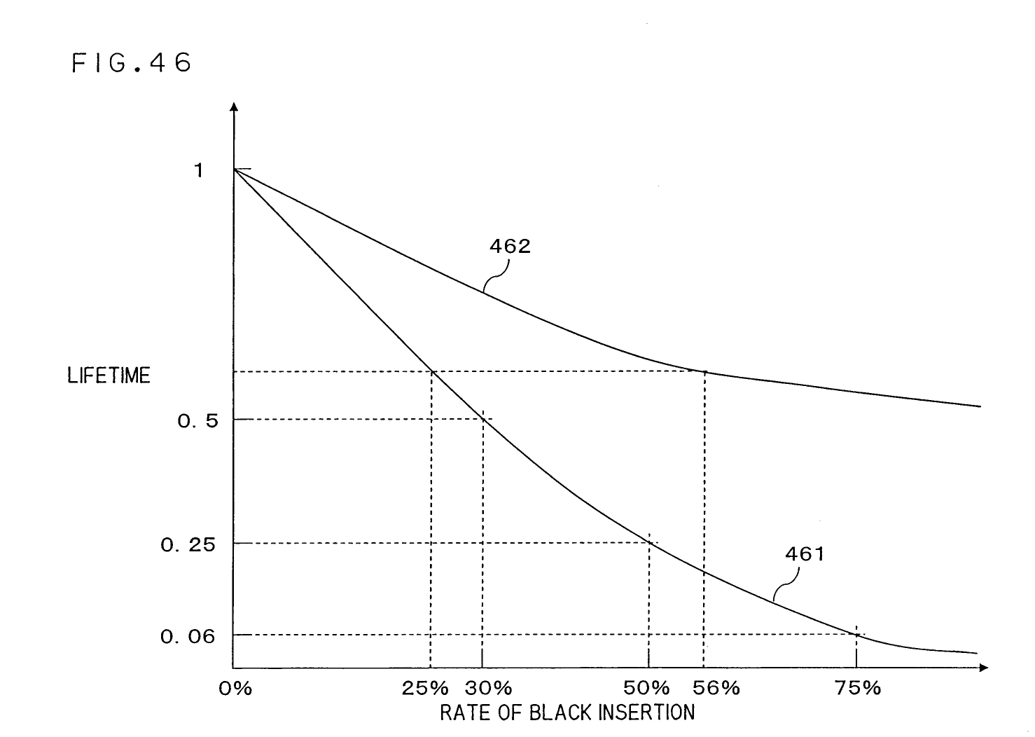

By the application of the reverse-biased voltage, a relationship of the lifetime with respect to the ratio of black insertion (see a curved line 461 in FIG. 46) in a case where the black insertion is performed without applying the reverse bias is effectively improved as shown by a curved line 462 in FIG. 46. Since the reverse bias cannot be applied when the ratio of black insertion is zero, the reference example is the same as this embodiment.

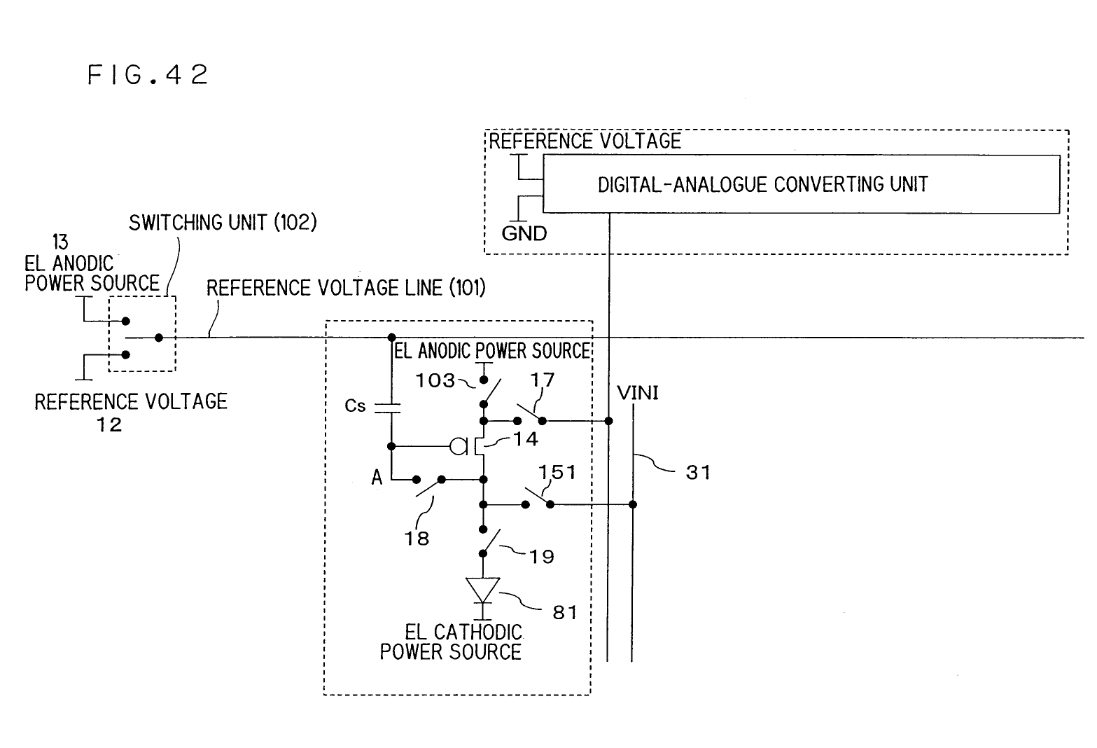

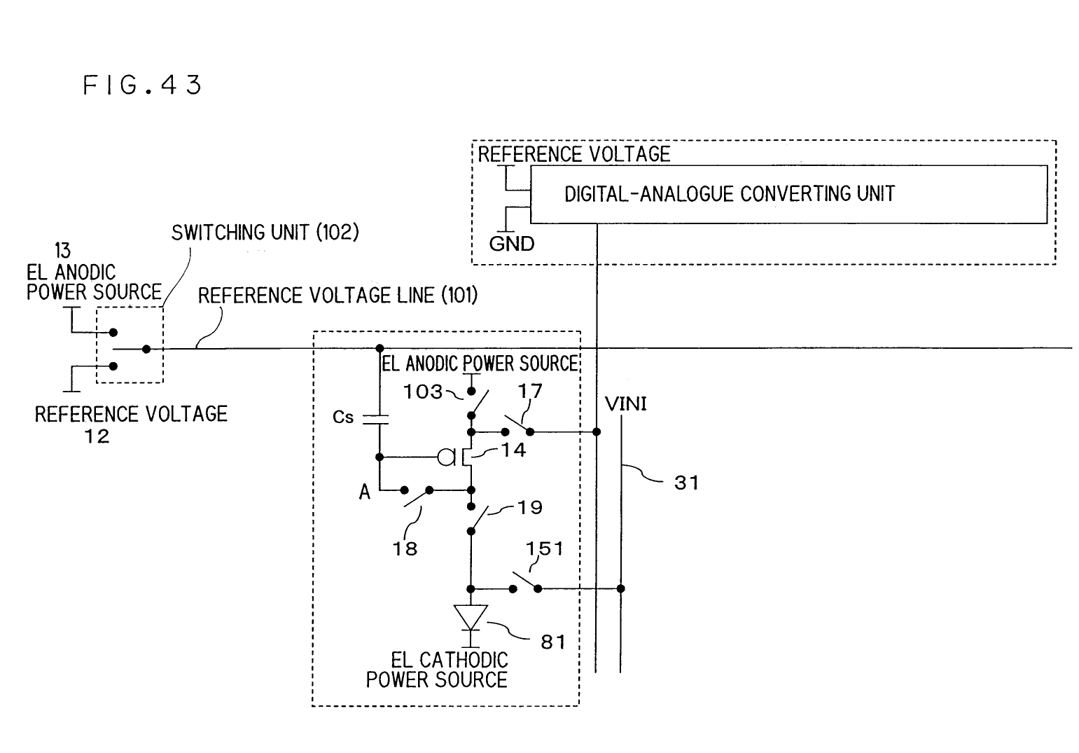

Configurations in FIG. 42 and FIG. 43 can also be implemented as pixels to be applied with the reverse-biased voltage in the non-illuminating period shown in FIG. 15.

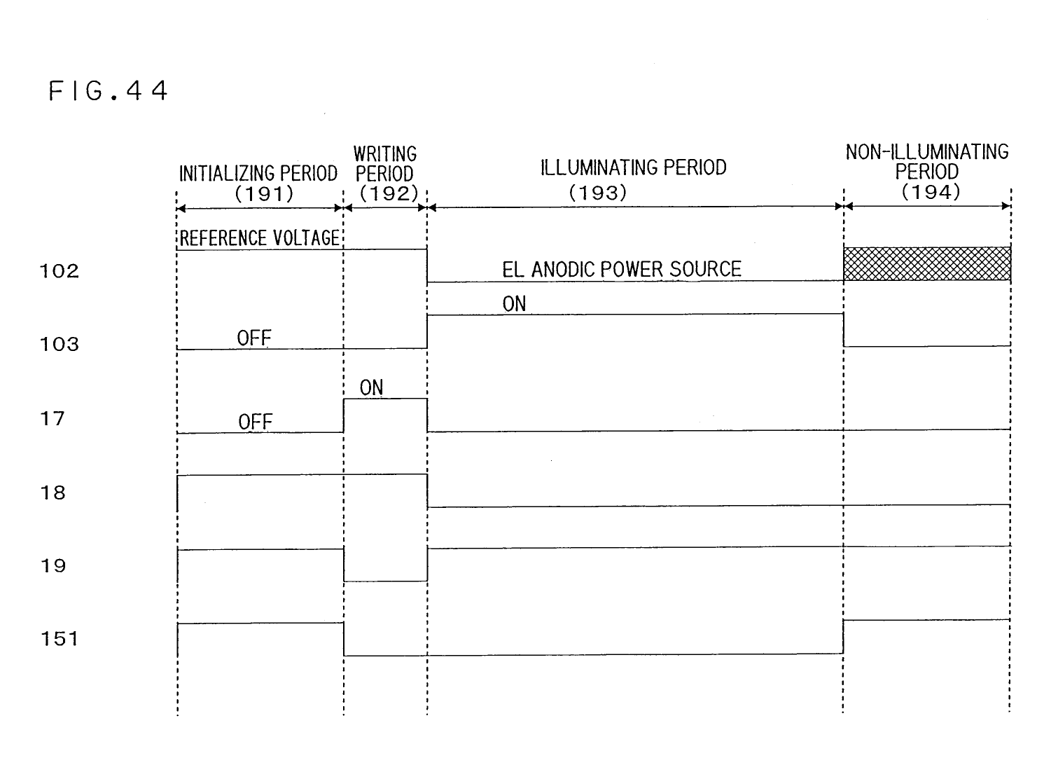

In the case of the pixel configuration shown in FIG. 42, the switch is caused to act as shown in FIG. 44. The switch 19 exists between the EL element 81 and the drive transistor 14. The switch 19 may be set to the conducting state during the illuminating period, and is set to the non-conducting state when the reverse bias is not applied to the EL element 81 during the non-illuminating period. In contrast, when the reverse bias is applied to the EL element 81, the switch 19 and the switch 151 are brought into the conducting state even though it is the non-illuminating period, and the initialization power source 31 is applied to the anodic electrode of the EL element 81. In this case, the switch 103 is preferably in the non-conducting state in order to prevent the electric current from flowing to the drive transistor 14.

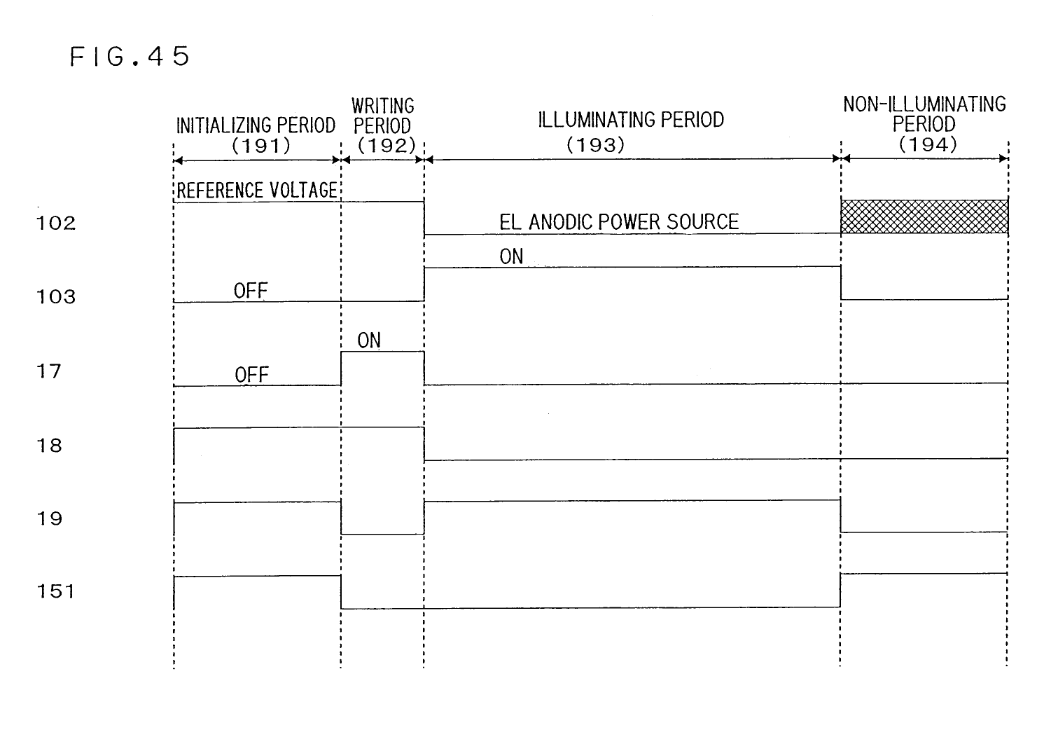

The switch 151 for inputting the initialization power source 31 may be provided between the EL element 81 and the switch 19. The pixel circuit at this time is shown in FIG. 43. The action is shown in FIG. 45. By bringing the switch 151 into the conducting state during the non-illuminating period, the reverse-biased voltage is applied to the EL element 81 since the switch 19 is in the non-conducting state. This configuration is characterized in that it is necessary to initialize the gate voltage of the drive transistor 14 via the switch 19 and the switch 18 in addition to the switch 151 in an initializing period 191, and the conducting state is achieved even when the switches 18 and 19 are in the initializing period 191.

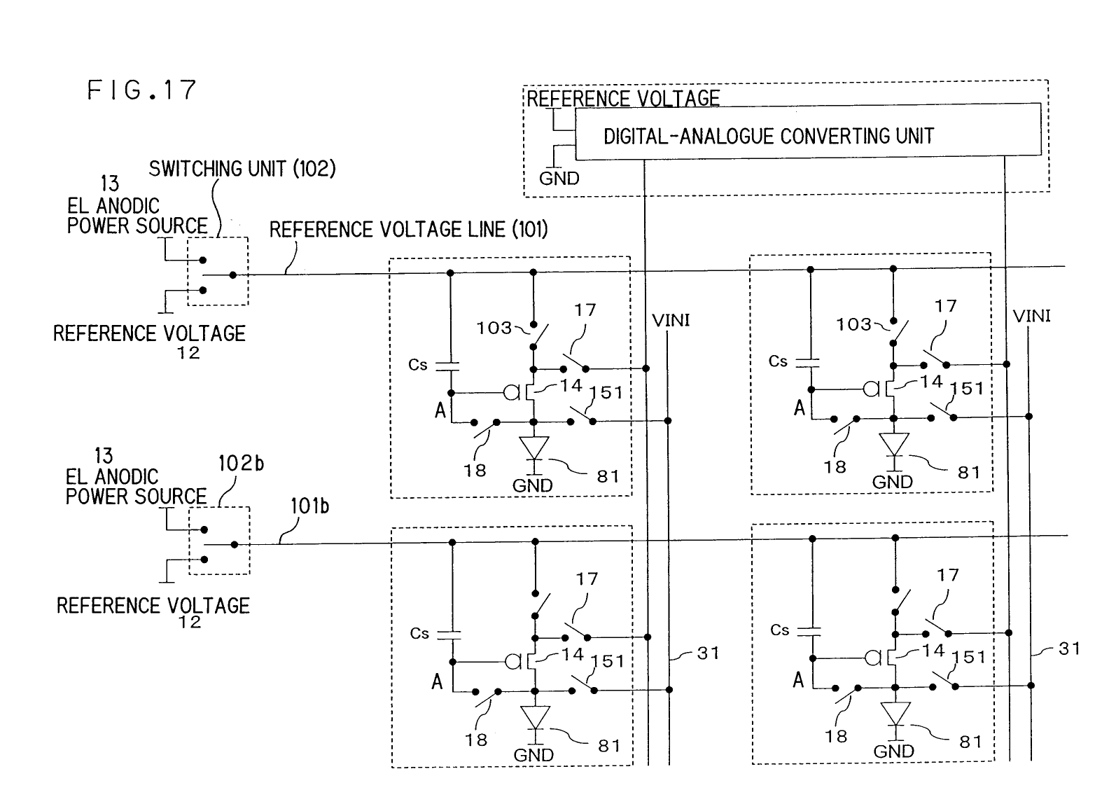

In the circuit configuration as in FIG. 15, FIG. 42, and FIG. 43, the EL anodic power source 13 may be supplied to all the pixels in the same row from the reference voltage line 101. An example of the case of the pixel configuration in FIG. 15 is shown in FIG. 17. The same configuration is conceivable also in FIG. 42 and FIG. 43.

In the initializing period, a method of preparing the initialization power source 31 and inputting the initializing voltage to the pixel circuit 106 has been described as a method of initializing the gate voltage of the drive transistor 14.

In this embodiment, in order to eliminate the initialization power source 31, the wiring line for the initialization power source, and the switch 15 for further reducing the circuit scale, the EL cathodic power source 20 having a voltage as low as the initialization power source 31 is used for initializing the drive transistor 14.

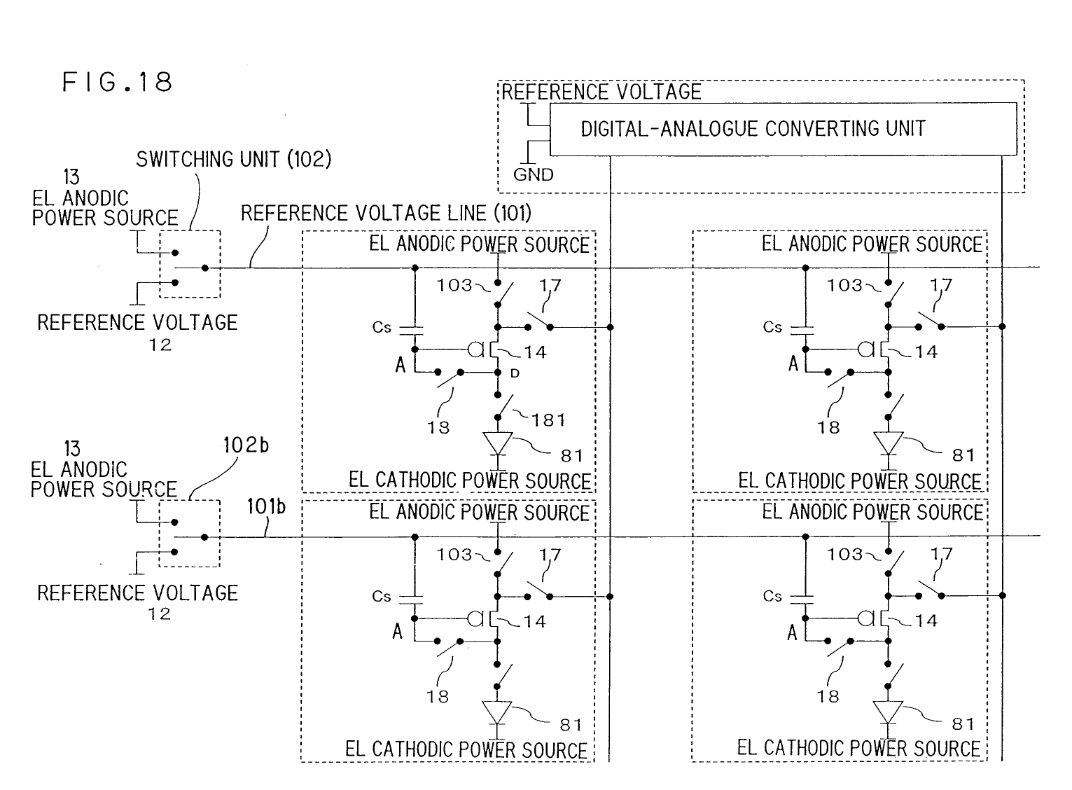

An example of the circuit for initializing the drive transistor 14 using the EL cathodic power source 20 is shown in FIG. 18. The circuit in FIG. 18 is characterized in that the initialization power source 31 does not exist and the initializing voltage is applied from the EL cathodic power source 20 to the nodal point A via the EL element 81, and the switches 18 and 181.

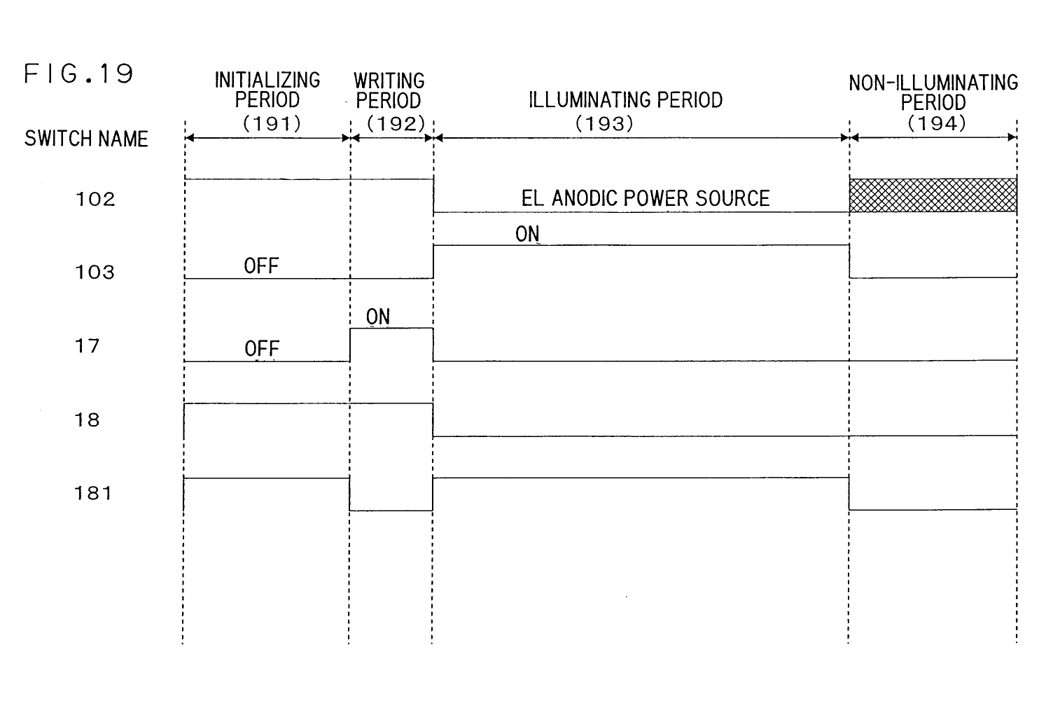

FIG. 19 shows an action in one frame.

In the initializing period 191, the switches 17 and 103 are brought into the non-conducting state to avoid the drain current of the drive transistor 14 from flowing. In addition, the switches 18 and 181 are brought into the conducting state. Although a forward voltage is applied to the EL element 81, since no electric current flows, only a voltage equal to or lower than the threshold voltage is generated in the EL element 81. Only a voltage of (EL cathodic power source 20)+(threshold voltage of EL element 81) is applied to the nodal point D even in a case where the highest voltage is applied thereto. Since the voltage at the nodal point A which used to be initialized in the related art is the same as the voltage at the nodal point D, a low voltage can be applied to the nodal point A by setting the EL cathodic power source 20 to a sufficiently low voltage, so that the initialization is enabled. The reference voltage 12 is applied to the reference voltage line 101.

In a writing period 192, a voltage corresponding to the video signal is applied to the drive transistor 14 from the source signal line via the switches 17 and 18.

In an illuminating period 193, by causing an electric current to flow from the EL anodic power source 13 to the EL cathodic power source 20 via the drive transistor 14 and the EL element 81, the electric current corresponding to the voltage written in the writing period 192 flows to the EL element 81, and light is emitted at a predetermined luminance.

A non-illuminating period 194 is performed in a case where the black insertion is implemented, and is not necessarily required. If at least one of the switches 103 and 181 is brought into the non-conducting state, the path for allowing the electric current to flow to the EL element 81 does not exist, and hence the non-illuminating state is achieved. By inserting the non-illuminating period 194, an effect of improving moving image visibility is achieved by inserting the non-illuminating period 194.

With the actions as described above, even though the initialization power source 31 does not exist, writing of predetermined tone voltages according to the variations in characteristics of the drive transistors 14 is possible, and a display device having a smaller pixel circuit having one piece of power source wiring line and one switch eliminated therefrom is realized.

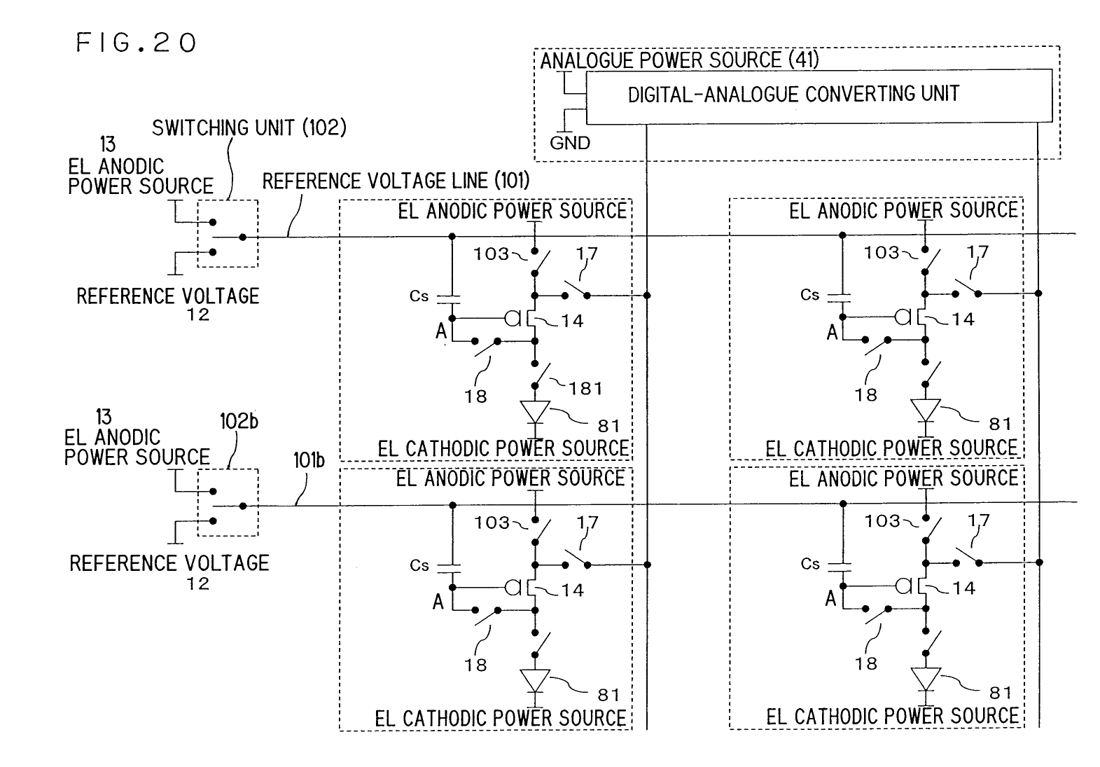

In FIG. 18, an example in which the gamma voltage of the source driver is generated from the reference voltage 12 is shown taking the voltage fluctuation into consideration. However, it can also be implemented in the same manner by utilizing the power source configuration in FIG. 21A and FIG. 21B, and using the gamma voltage of the source driver as the analogue power source 41 as shown in FIG. 20.

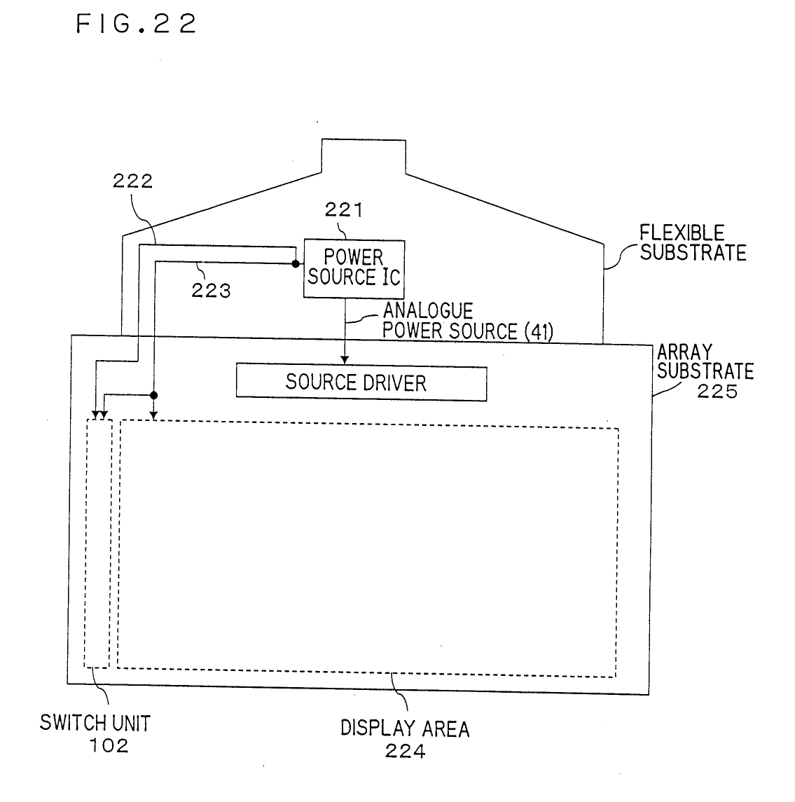

In the case of the circuit configuration in FIG. 20, when preparing the configuration power source IC221 shown in FIG. 21B, a power source from the reference voltage generating unit 212 is generated and output in addition to the analogue power source 41 from the power source IC221 as shown in FIG. 22. The reference voltage generating unit 212 is an original voltage of the EL anodic power source 13 and the reference voltage 12, and is divided into wiring lines 222 and 223 in the vicinity of the power source IC221 in order to avoid the effect of the voltage fluctuation caused by the wiring resistance and the load current fluctuations as described above.

The reference voltage 12 is supplied to the switching unit 102 via the wiring line 222, and the EL anodic power source 13 is input to a display area 224 including the switching unit 102 and the pixel circuit 106 via the wiring line 223. The wiring lines 222 and 223 are designed to be divided at a position as close to the power source IC221 as possible, and are preferably divided before being wired on an array substrate 225 where the wiring resistance is increased.

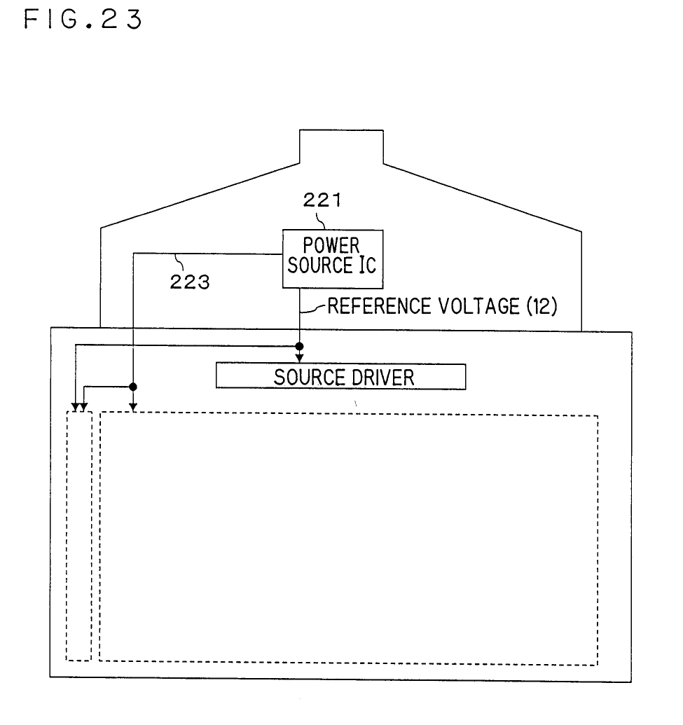

When the reference voltage 12 is used as the analogue power source of the driver IC as in the circuit configuration in FIG. 18, the power source is adapted to be supplied to the driver IC from the wiring line 222. Since one power source output is missing from the configuration in FIG. 20, an output terminal may be provided on the power source IC221 for the reference voltage and the analogue power source to achieve the wiring as shown in FIG. 23. In this case, an effect of a bump resistance of the power source IC221 can be eliminated as well.

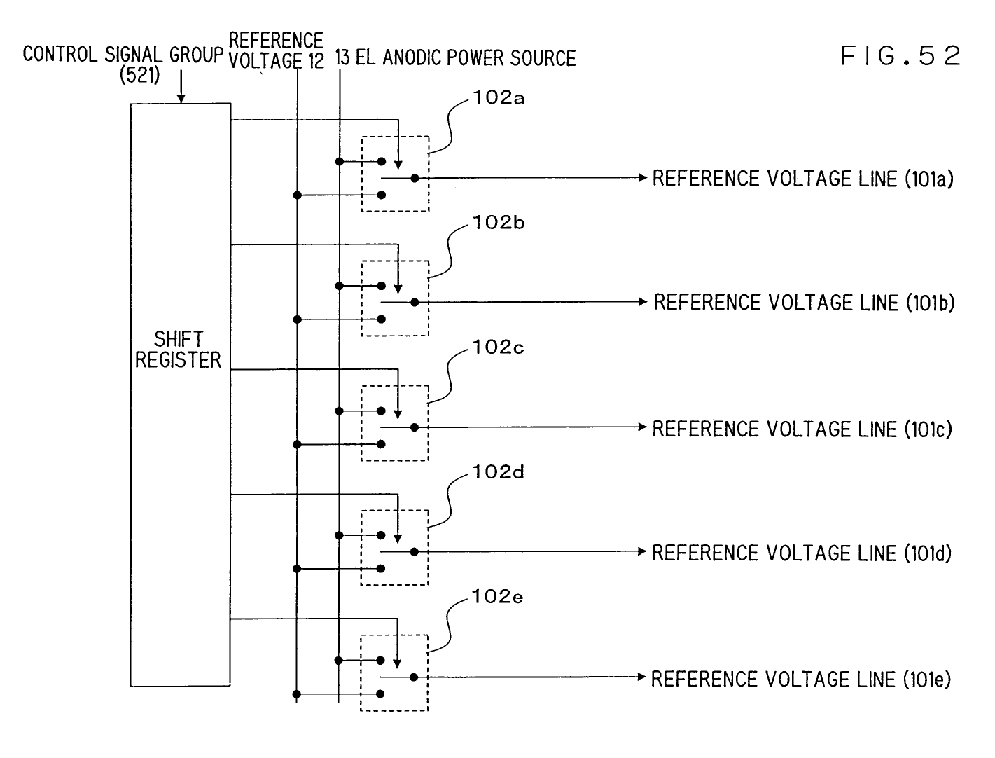

The switching unit 102 may be implemented by one circuit for several rows as a unit. Control of the switching unit 102 is implemented by a shift register or the like. It is configured as shown in FIG. 52. The shift register and the switching units 102 corresponding to the number of the rows are necessary.

The fluctuations of the signal voltage of the reference voltage line 101 are scanned in sequence from one line to another. The reference voltage 12 is applied in the initializing and video signal writing periods, and the EL anodic power source 13 is applied in the illuminating and non-illuminating periods.

If the voltage switching periods can be equalized for the plurality of rows, only one switching unit 102 for the plurality of rows and one register stage of the shift register also for the plurality of rows are necessary, so that the circuit to be arranged around the display area can be simplified, and hence a display device with a small frame can be provided.

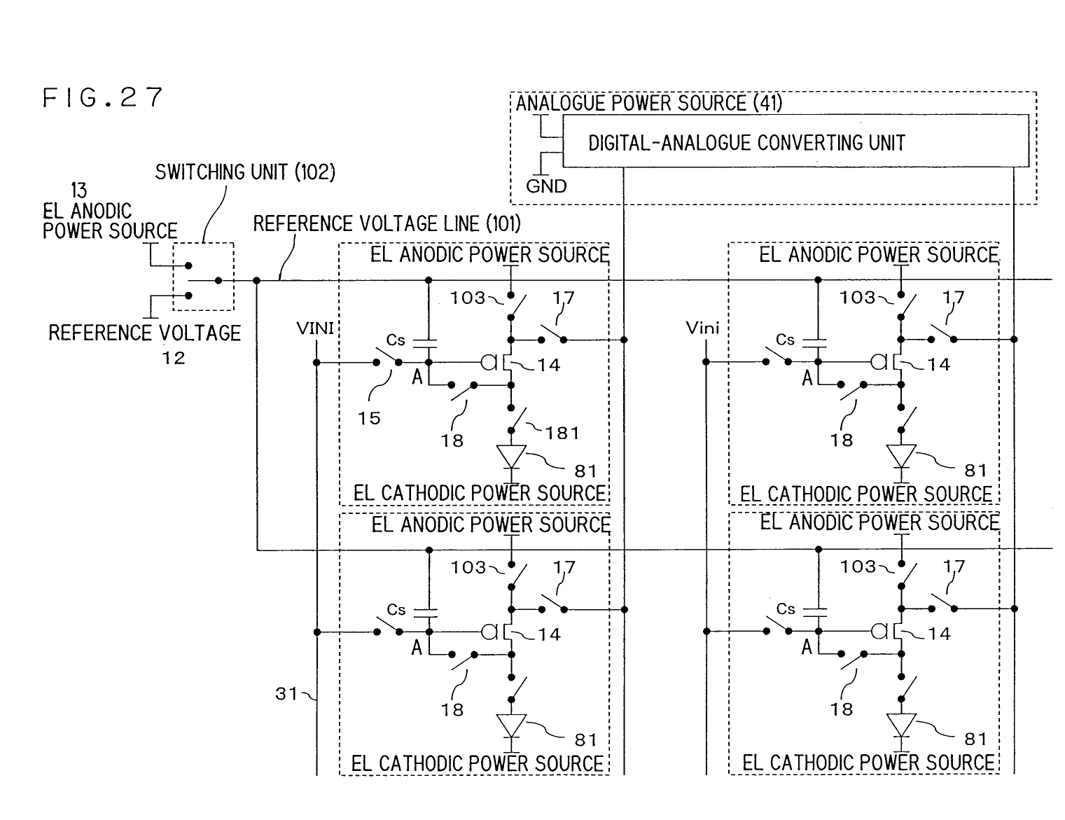

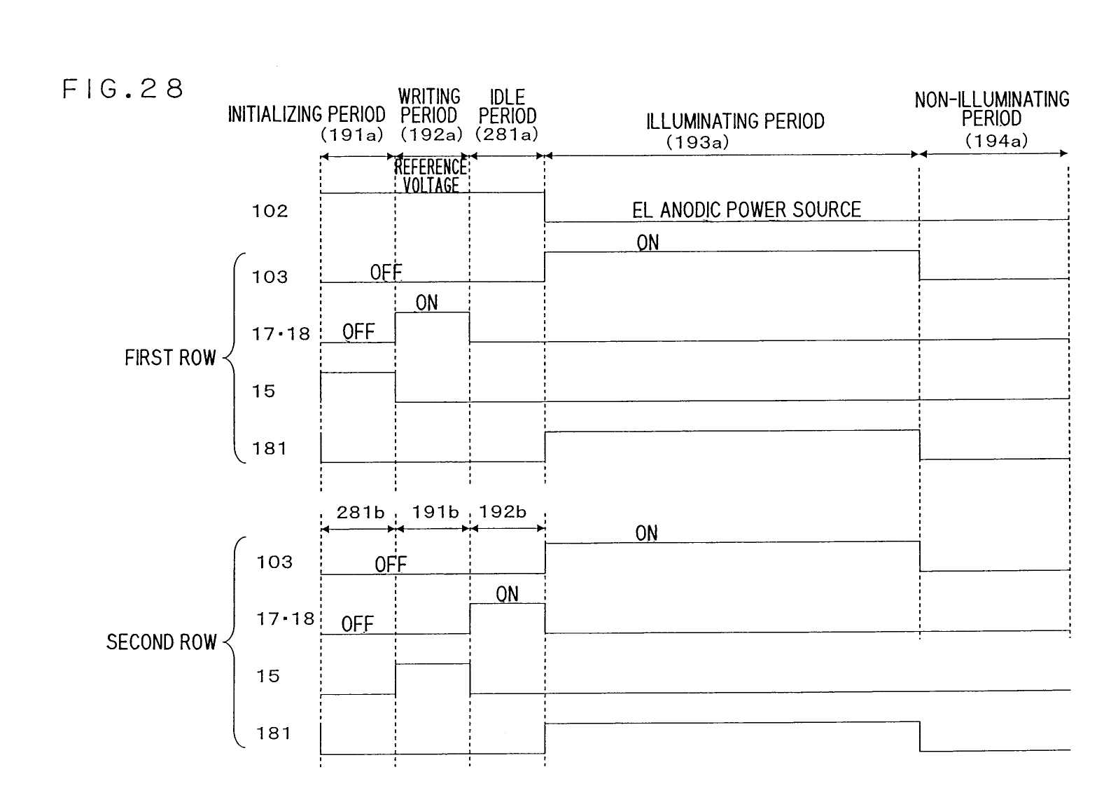

FIG. 27 and FIG. 28 show an example in which the switching units are arranged in every two rows.

In the circuit configuration in FIG. 27, since the voltages of the reference voltage line 101 are the same for two rows, it is assumed that either one of the pixels for two rows which are connected during a period in which the voltage of the reference voltage line 101 corresponds to the reference voltage 12 is the initializing period 191 or the video signal writing and characteristic correcting period 192. Since the rows are scanned in sequence from one row to another, the switching unit 102 selects the reference voltage during three horizontal scanning periods as shown in FIG. 28.

In one of the two rows, which is scanned first (first row in this case), an idle period 281a in which the electric charges in the accumulation capacity Cs are retained without writing and illumination is provided in one horizontal scanning period next to an initializing period 191a and a writing period 192a. After the idle period 281a, the illuminating period 193 is provided and the non-illuminating period 194 is implemented as needed.

In one of the two rows, which is scanned at last (second row in this case), since the writing period is provided in the horizontal scanning period after having terminated the writing in the first row, a writing period 192b is provided while the first row is in the idle period 281.

The initializing period may be implemented in any of the two horizontal scanning periods before the writing period 192b. What is essential is to implement the initializing period in at least one horizontal scanning period, and hence it may be implemented in both the two horizontal scanning periods. In FIG. 28, the initializing period 191b is provided in the horizontal scanning period before the writing period 192b, and an idle period 281b is provided before the initializing period 191b in the horizontal scanning period.

The actions in the second row are the idle period 281b, the initializing period 191b, the writing period 192b, the illuminating period 193, and the non-illuminating period 194 as needed.

It is possible to unify the signals acting at the same timing from a signal waveform in FIG. 28. What is essential is that a signal which controls the switches 17 and 18 is input after the one horizontal scanning period of the signal which controls the switch 15. Therefore, when considering that it is a line sequence scanning, what is essential is that the signal of the switch 17 is acted using the signal of the switch 15 which is to be scanned one row after.

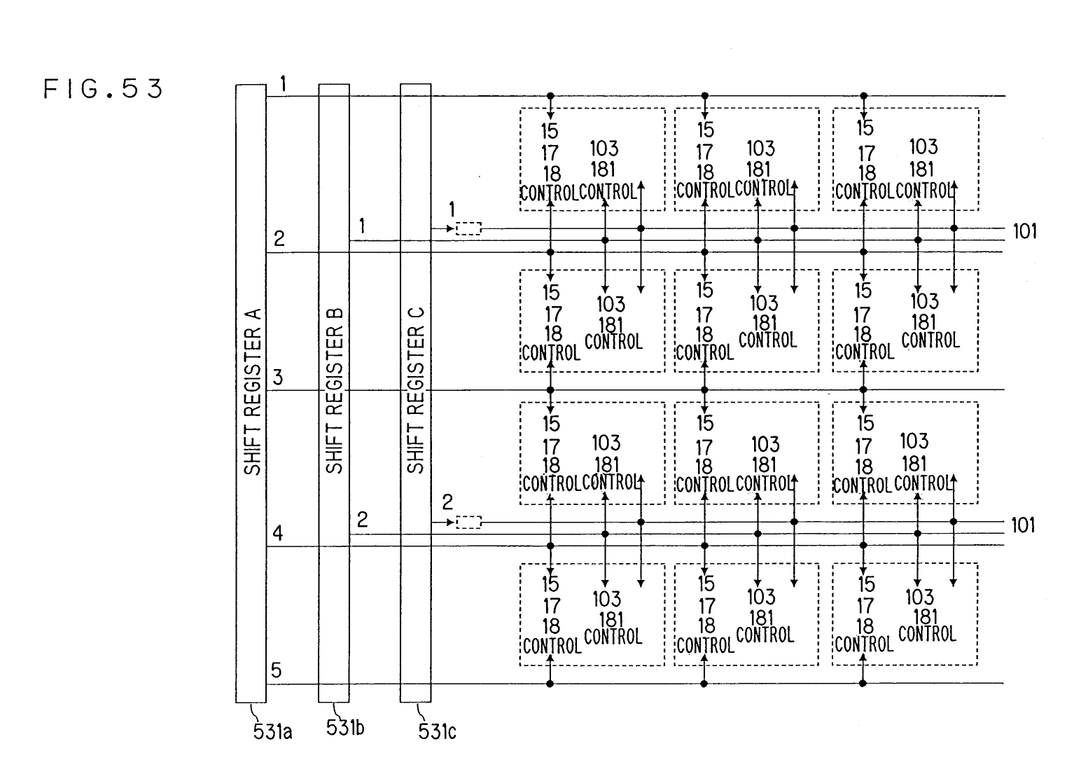

Accordingly, the circuit having a pixel configuration shown in FIG. 27 can be brought into action by three shift registers as shown in FIG. 53.

Since the switching units 102 and the switches 103 and 181 of the three shift registers are brought into action simultaneously in every two rows, the outputs from the shift register in every two rows, that is, half the normal output, are sufficient. Accordingly, the number of stages of two shift registers (531b and 531c) may be half, so that downsizing of the circuit is achieved.

A system to supply a voltage to an end of the accumulation capacity Cs from different power sources at the time of writing and at the time of illuminating in this embodiment may be applied also to a current drive system.

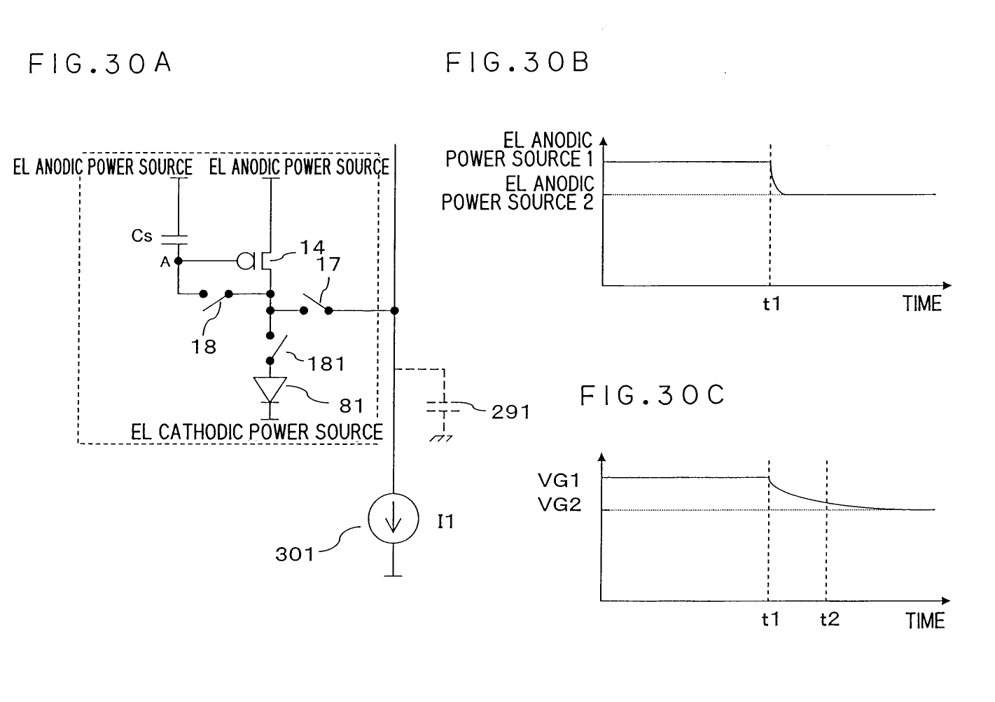

An example of a current drive pixel circuit in the reference example is shown in FIG. 30A. Here, although a current copier circuit is exemplified for description, the same description is also applicable to a current mirror circuit configuration. It is because the action at the time of writing the video signal is the same.

In the pixel in FIG. 30A, when writing, the switches 17 and 18 are in the conducting state, and the switch 181 is in the non-conducting state. An electric current I1 according to the tone is supplied from a current source 301. The voltage at the nodal point A is determined on the basis of the gate-source characteristics of the drive transistor 14 which receives the electric current I1 as the drain current. Assuming that the voltage of the EL anodic power source is changed from the EL anodic power source 1 to the EL anodic power source 2 (FIG. 30B), it is necessary to change the voltage at the nodal point A by an amount corresponding to the change of the EL anodic voltage in order to maintain the gate-source voltage of the drive transistor 14.

The voltage at the nodal point A is needed to be changed from VG1 to VG2 as shown in FIG. 30C. This is associated with charging and discharging of the electric charges accumulated in a floating capacity 291 of the source signal line. When the electric current I1 of the current source 301 is small, it takes time to change the voltages of the source signal line and the nodal point A to VG2 by the current source 301. When the writing time is ended until the change to VG2 is achieved (for example, the time t2), the voltage different from the predetermined voltage is accumulated at the nodal point A, and the gate-source voltage of the drive transistor 14 becomes a voltage different from the predetermined voltage, so that there arises a problem that the electric current flowing to the EL element 81 at the time of light emission is different from the predetermined current.

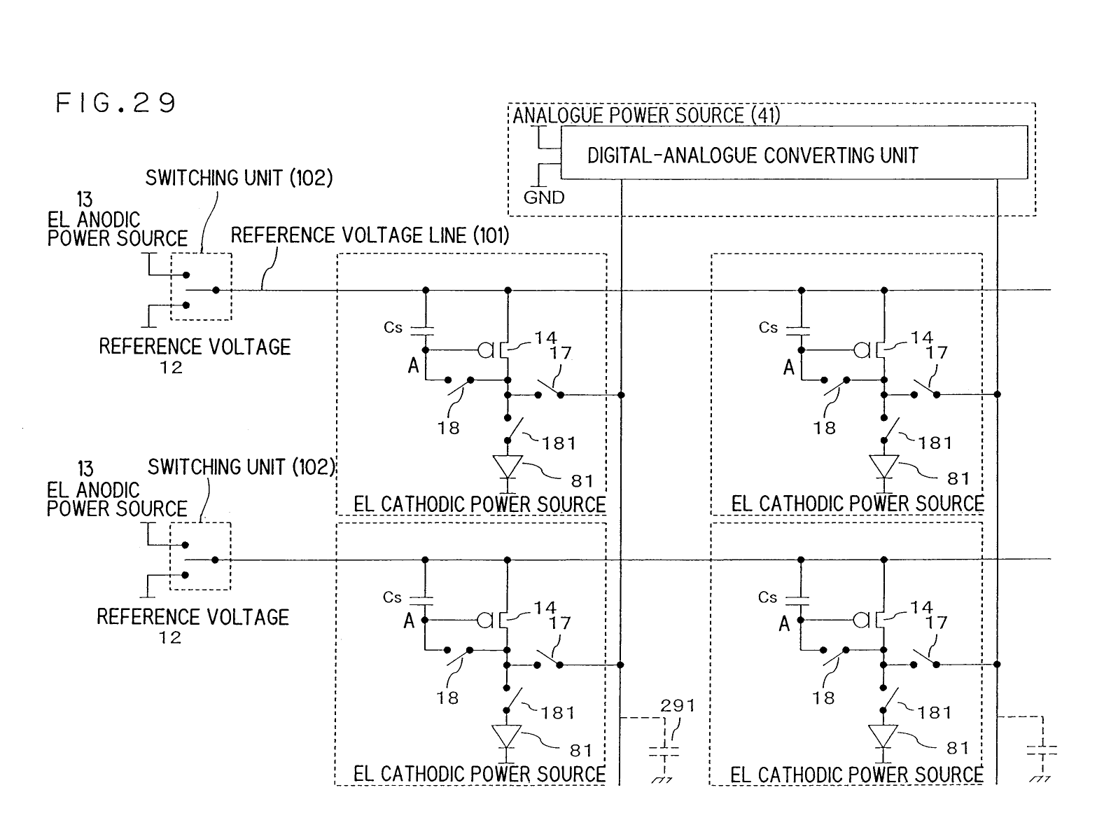

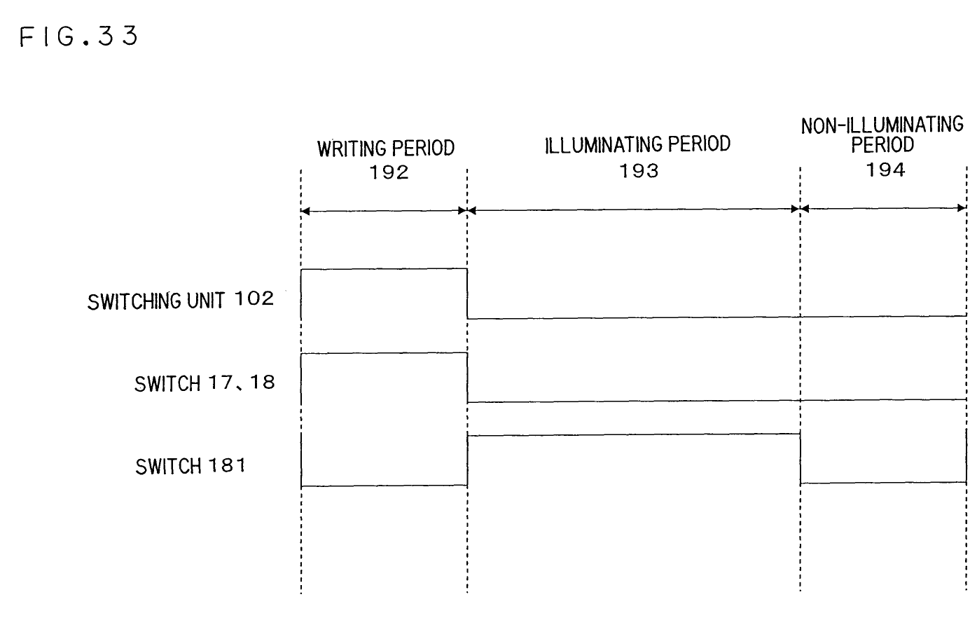

In this embodiment, by the action shown in FIG. 33 in the circuit shown in FIG. 29, the source voltages of the drive transistor 14 are selectively used by switching the same to the different values at the writing time and the illuminating time. By using the reference voltage 12 at the writing time to write in a state of less voltage fluctuation, a correct voltage is applied to the nodal point A, and an effect of the fluctuations of the EL anodic voltage on the display luminance is avoided.

Accordingly, the EL anodic power source can employ the circuit configuration which allows the output voltage to fluctuate according to the load current as long as the EL element 81 has a heavy current output function for supplying the electric current.

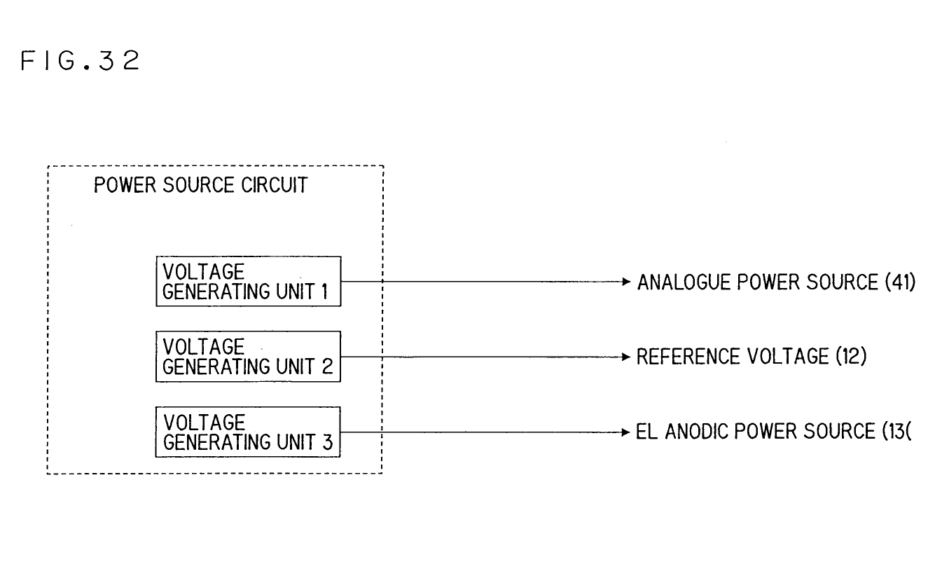

In the case of the current drive, since the source signal line voltage is determined by the electric currents of the drive transistor 14 and the current source 301, a configuration in which the gamma voltage fluctuates simultaneously with the reference voltage as in the case of writing by the voltage is not necessarily required. The power source of the digital-analogue converting unit may be any power source including the analogue power source 41 as long as it is a current source which is capable of outputting a voltage which achieves a maximum source signal line voltage with respect to a current output from the current source 301. Therefore, as shown in FIG. 32, the power source circuit may be such that the analogue power source 41, the reference voltage 12, and the EL anodic power source 13 are independently fabricated and prepared. In order to reduce the number of the power sources, it may have a common configuration. However, design insensitive to the voltage fluctuation of the EL anodic power source 13 is required.

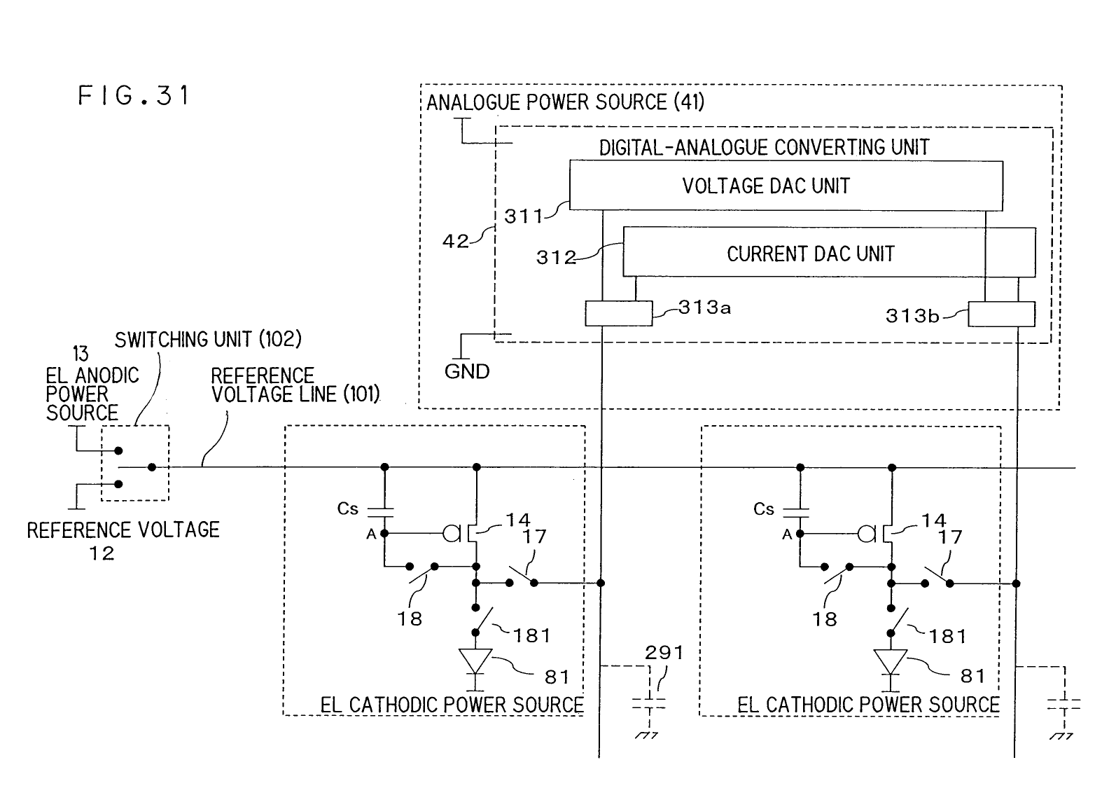

As a countermeasure for the fact such that predetermined tones cannot be written easily at the time of low tone (low current) display, which is a problem in the current drive, there is a method of providing a DAC (voltage DAC unit 311) for outputting voltages in addition to a DAC (current DAC unit 312) for outputting currents in the digital-analogue converting unit 42 of the source driver unit as shown in FIG. 31, changing the voltages at the source signal line and the nodal point A to values near the predetermined tones first by the output from the voltage DAC unit 311 which can change the voltage easily even when there is the floating capacity 291 to correspond to the characteristic variations of the drive transistors 14, and then changing the voltage at the nodal point A to a voltage according to the characteristics of the drive transistor 14 and the output current of the current DAC unit 312 by the current DAC unit 312.

By changing the potential rapidly to a required voltage by the voltage DAC unit 311 and fine-adjusting the same to a final voltage value by the current DAC unit 312, the voltage of the nodal point A is changed to a state in which the predetermined current flows to the drive transistor 14 quickly even at the time of low-current output.

Even with the source driver and the pixel configuration having the output shown in FIG. 32, the method of selectively using the accumulated capacities and the source voltages of the drive transistor 14 by switching the same to the different values at the writing time and the light-emitting time according to the first embodiment is effective.

In particular, at the time of output from the voltage DAC unit 311, the voltage according to the tone is applied to the nodal point A from the source driver as in the method of applying the voltage according to the tone to the source signal line as described thus far. The drain current of the drive transistor 14 is determined by the potential difference between the voltage applied to the source electrode of the drive transistor 14 and the nodal point A. Therefore, the source electrode of the drive transistor 14 at the writing time is needed to receive the supply of constantly stable voltages.

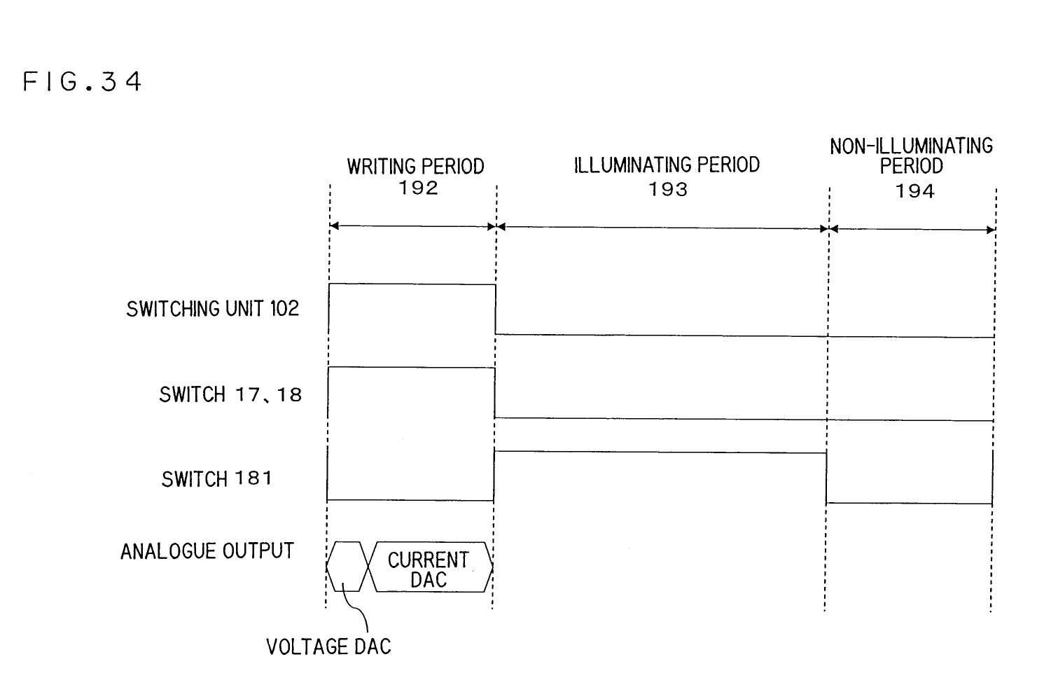

Therefore, in the switching unit 102, the actions to apply the reference voltage 12 to the pixels during the writing period 192 is employed as shown in FIG. 34.

As regards the analogue power source 41 of the source driver, it is necessary to configure such that the same potential fluctuations occur in the reference voltage 12 and the analogue power source 41 by generating the voltage from the same power source as the reference voltage 12.

Accordingly, in all the pixels in the writing period 192, the source potentials of the drive transistors 14 and the voltages at the nodal points A on the basis of the output from the voltage DAC of the source driver are stably supplied, and the fluctuations of the source-gate voltage of the drive transistor 14 due to the potential fluctuations are eliminated, so that the display device without display unevenness is realized.

In addition, in order to realize the device with less display unevenness, the circuit having gate-source voltage fluctuations of the drive transistor 14 as small as possible in the light-emitting period is preferable.

In the case of the pixel configurations shown in FIG. 10 and FIG. 12, since the EL anodic power source 13 supplied via the switching unit 102 and the EL anodic power source 13 of the pixel circuit 106 are supplied from different wiring lines depending on the EL anodic power source wiring and the illumination pattern of the pixel, there is a case where the voltages do not necessarily match.

Assuming that only a certain column illuminates at a maximum luminance and other pixel columns are illuminated at a minimum luminance, in the column illuminating at the maximum luminance, the potential drop of the EL anodic power source 13 in the pixel farthest from a supply unit is larger than other pixel columns.

In a case where the EL anodic power source 13 is supplied from the reference voltage line 101 via the switching unit 102 and hence the illuminating period 93 is started in this state, a state in which the source potential of the drive transistor 14 is different because the EL anodic power source voltage in the pixel circuit 106 is different only in a certain column, the drain current is different because the source-gate voltage of the drive transistor fluctuates, and the luminance of the EL element 81 is different from the predetermined value is resulted.

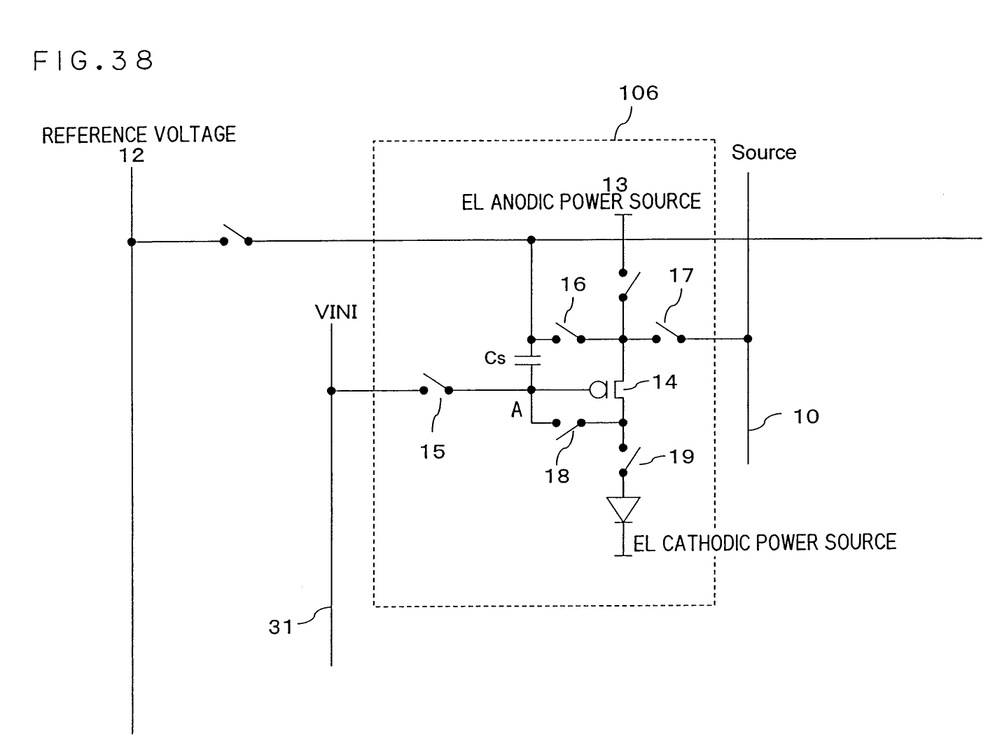

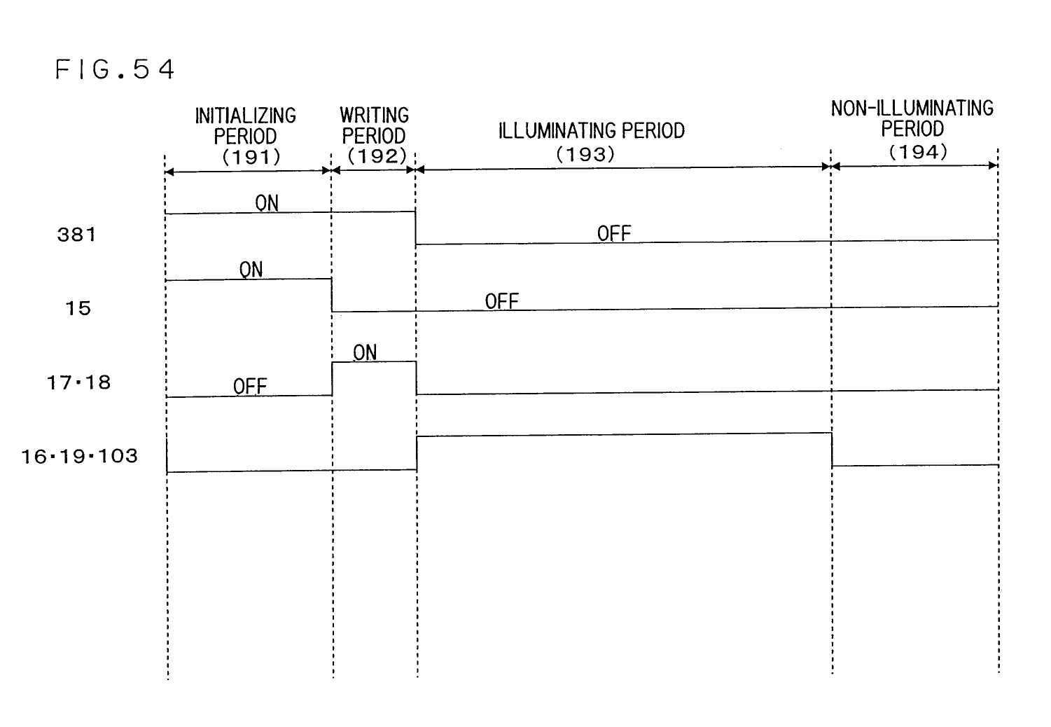

FIG. 38 shows a configuration in which the EL anodic power source 13 is applied to the source of the drive transistor 14 and the accumulation capacity Cs at the time of light emission so as to allow the predetermined current to flow even when the luminances of the pixels in the respective columns are significantly different. Although the circuit scale is increased by an amount corresponding to the added switch 16, even when the voltage of the EL anodic power source 13 of a specific column fluctuates and the source potential of the drive transistor 14 is changed, for example, by V2, the potential of the accumulation capacity Cs is also changed by V2 via the switch 16, so that the voltage at the nodal point A is changed correspondingly by V2, whereby the source-gate voltage of the drive transistor 14 is irrelevant to the potential fluctuation of the EL anodic power source 13 (actions are shown in FIG. 54).

In a case where only a specific column becomes to have a high luminance or a low luminance in comparison with other columns, visibility is deteriorated in comparison with the remarkable luminance unevenness in which only the luminance varies and all the columns have the same luminance. Therefore, the pixel configurations shown in FIG. 38 or FIG. 10, FIG. 12, and so on may be selected according to the maximum luminance, the wiring length of the EL anodic power source 13, the panel size, the number of vertical scanning lines.

The pixel circuit 106 shown in FIG. 38 is also applicable in the same manner even when it is the pixel circuit shown thus far in the first embodiment.

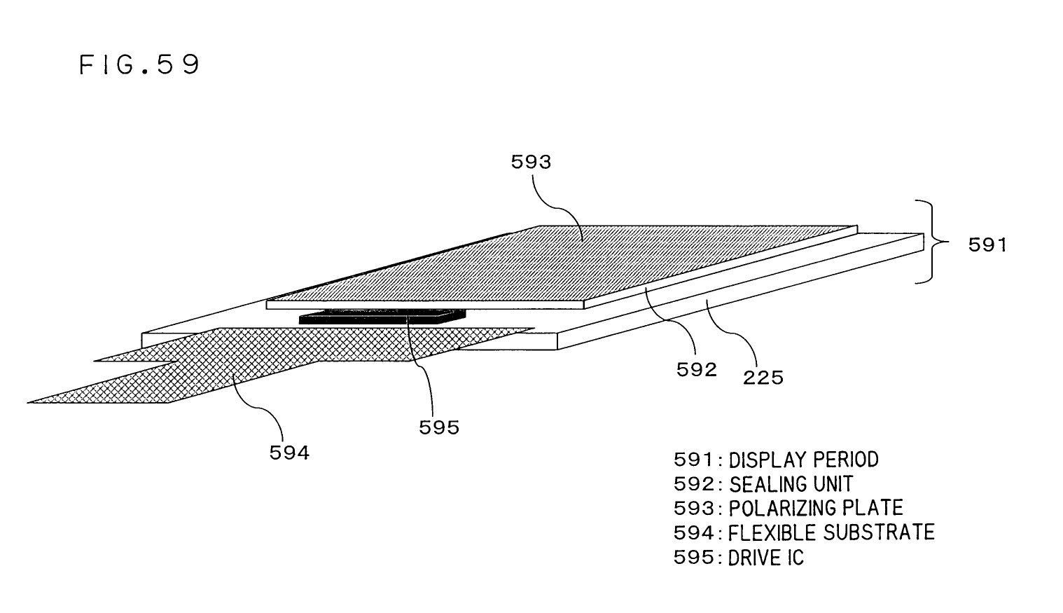

The pixel circuit in this embodiment is applicable to a display panel as shown in FIG. 59. In FIG. 59, a polarizing plate 593 is used. However, the polarizing plate does not necessarily have to be provided as long as the visibility by the external light reflection is secured. A sealing portion 592 may be a protective film formed of a thin film, or may have a configuration to protect an upper surface using a separate glass substrate or a plastic substrate and connect the same with the array substrate 225 with a sealing agent or the like as long as it is capable of protecting the circuit including the organic EL element 81 formed on the array substrate 225 from oxygen or moisture in the air.

Although a drive IC 595 is mounted on the array substrate, it may be mounted on the flexible substrate or may be formed as a circuit directly on the array substrate 225. It may include a control IC or a power source circuit integrated therein.

The control IC or the power source circuit may be mounted on a flexible substrate 594.

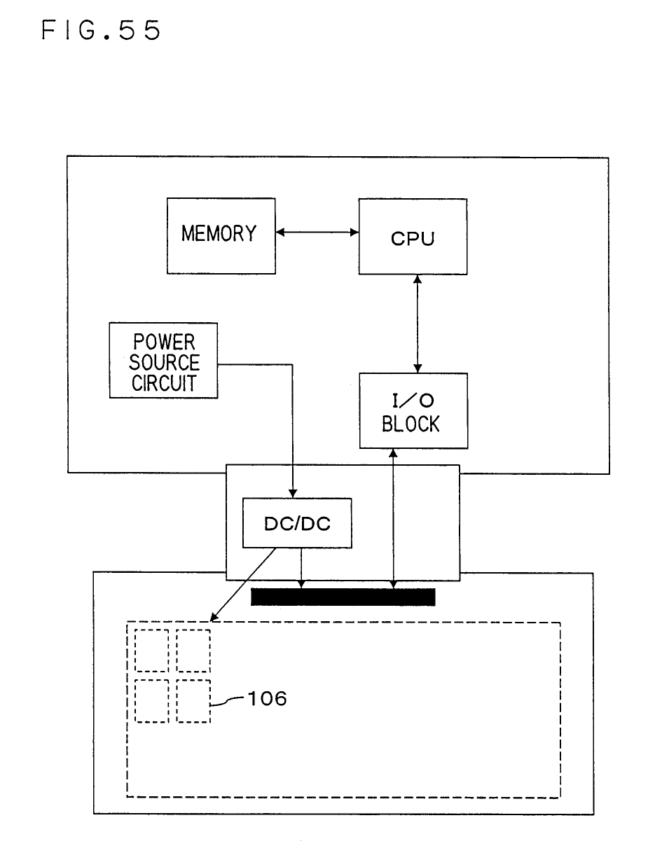

A connection with a system side is achieved by the flexible substrate 594, and the power source and video data to be displayed are exchanged with each other. FIG. 55 shows an example of a circuit configuration on the system side.

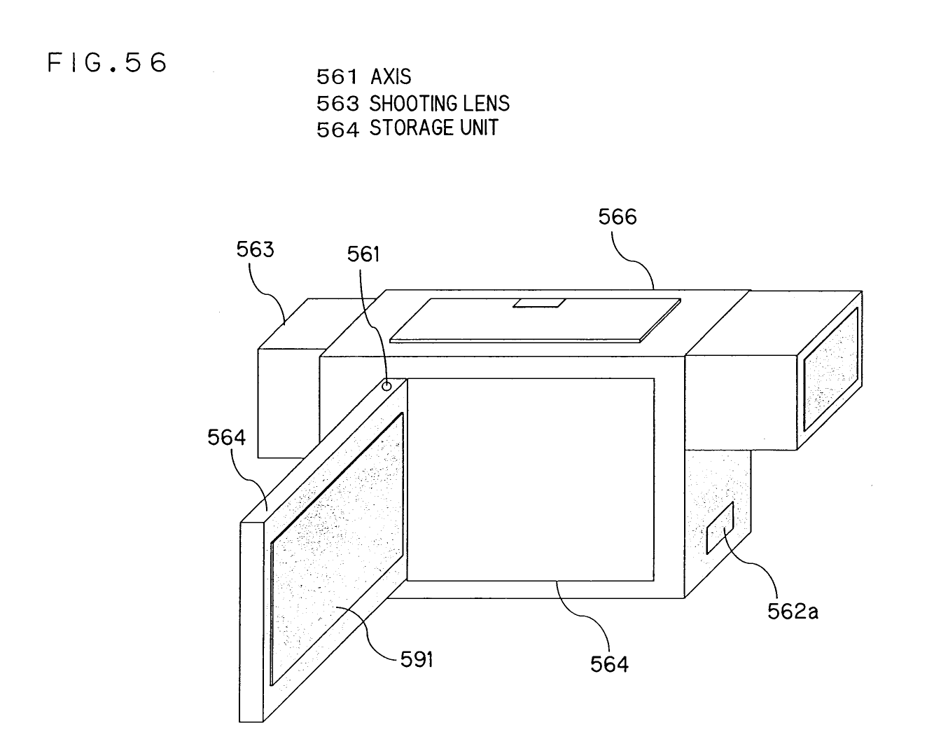

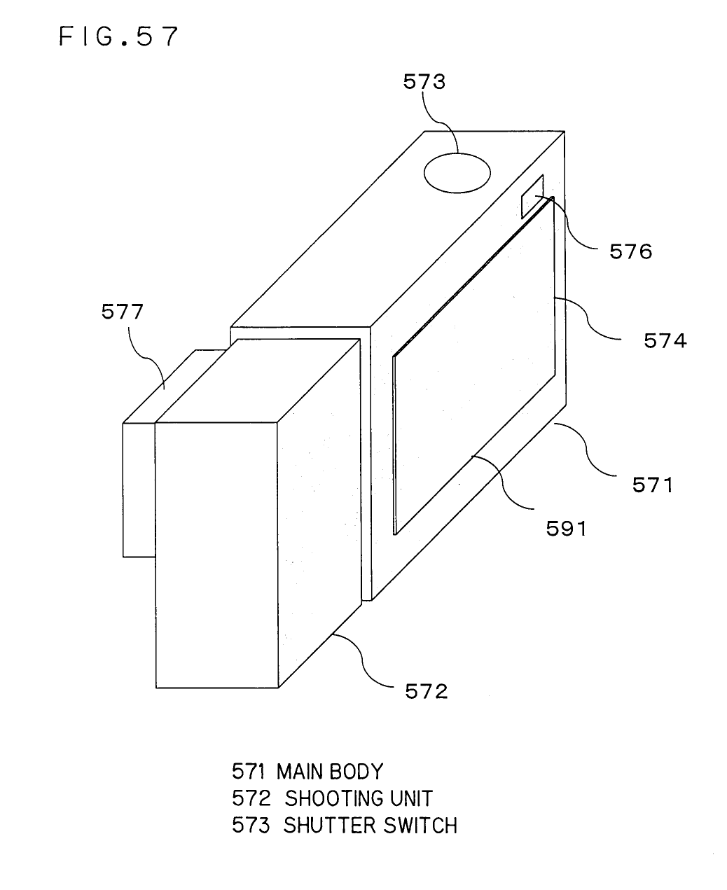

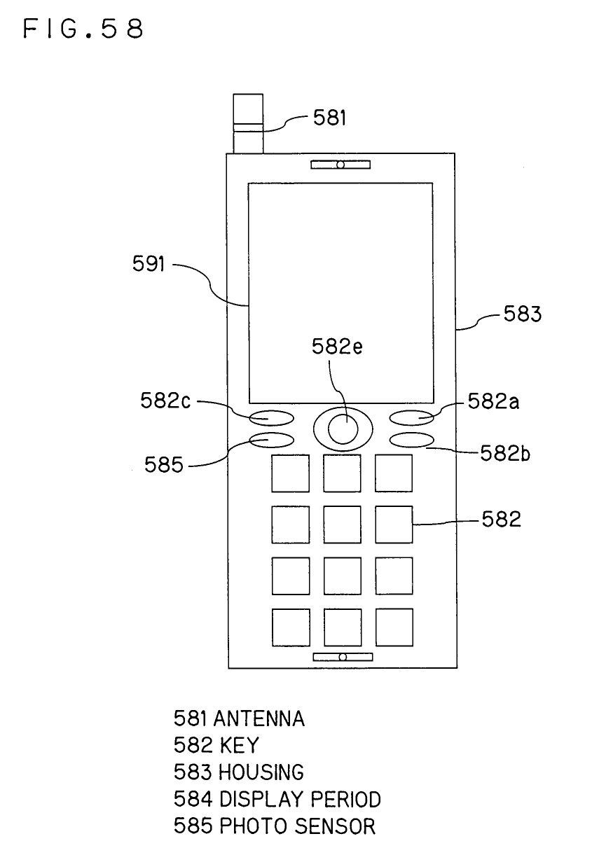

The display panel fabricated in this manner is mounted on apparatuses as shown in FIG. 56, FIG. 57, and FIG. 58.

The reference voltage line 101 may employ separate wiring lines for each display color. It is applicable in a case where the voltages of the EL anodic power sources 13 are differentiated from one display color to another when the required voltages are different depending on the emitted colors from the EL element 81. When wiring lines are provided for respective display colors, the number of wiring lines is increased. However, the power consumption can be reduced because there are colors which reduce the voltage values.

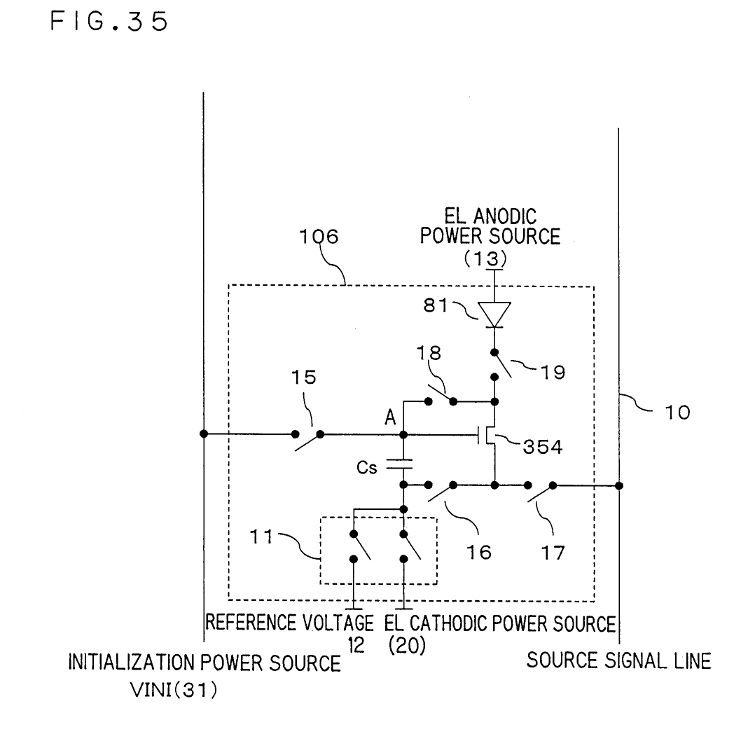

The drive transistors 14 are all described as the p-type transistors. However, this embodiment can also be implemented in the case of n-type transistors. A circuit in which the pixel circuit in FIG. 1 is configured by an n-type drive transistor 354 is shown in FIG. 35. Since the direction of flow of the drain current of the drive transistor 354 is inverted, the connection of the EL element 81 is inverted, so that the EL anodic power source 13 and the EL cathodic power source 20 are replaced. The relations between high and low of the voltage and between black and white are also to be inverted.

In other pixel circuits, this embodiment may be implemented by inverting the relation of the voltages, or inverting the connection of the EL elements in the same manner.

This embodiment is also applicable to a signal line selected driving system in which one source driver is connected to a plurality of source signal lines 10 in sequence.

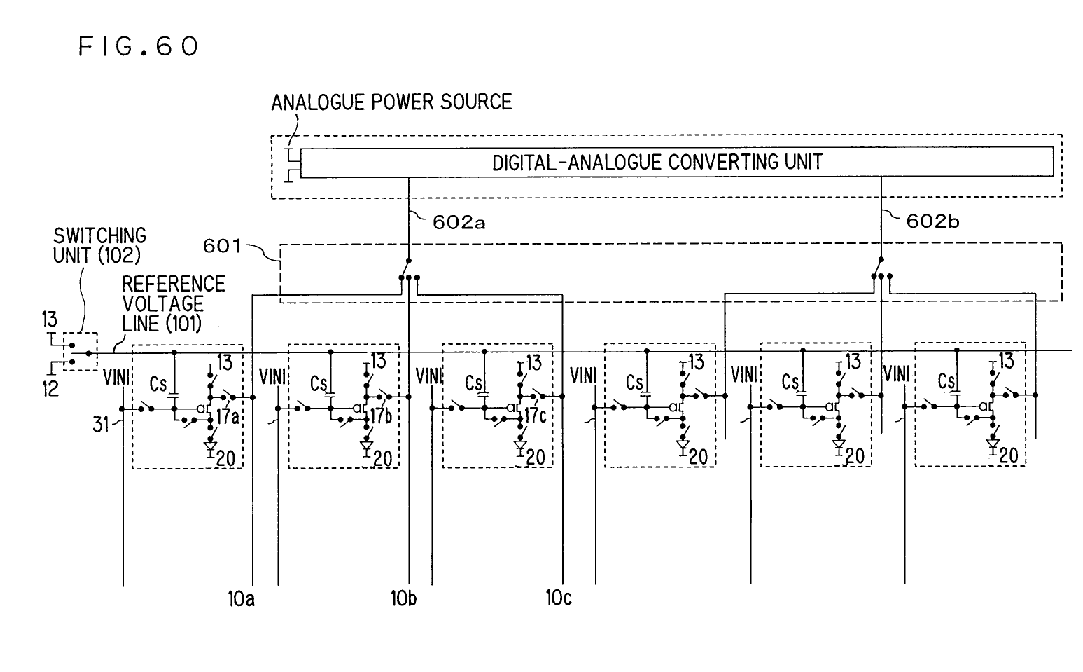

As shown in FIG. 60, three source signal lines 10a, 10b, and 10c can be connected to an output 602 of the source driver for bringing the same into action. It does not have to be three source signal lines, and it can be realized as long as there are two or more source signal lines.

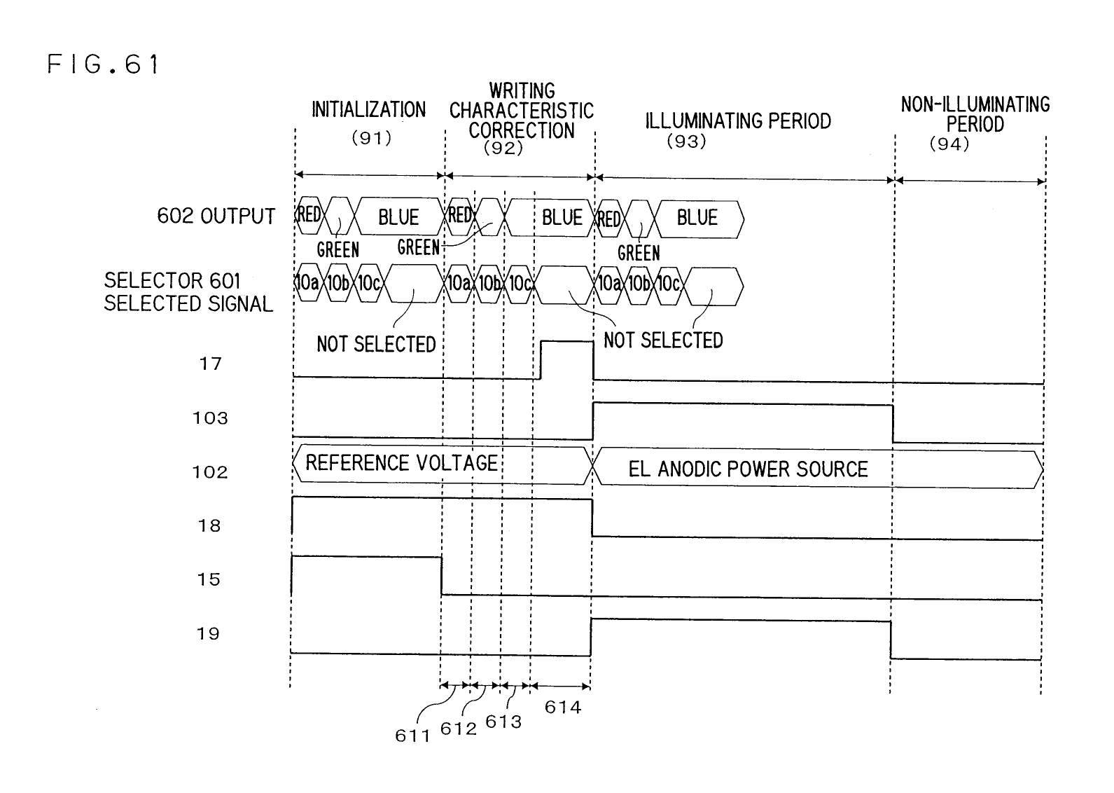

Since the signals are output to the three signal lines in sequence as shown in FIG. 61, the input times of the signals to the source signal lines 10a, 10b, and 10c are different. Data of one row before the corresponding pixel remains on the source signal line until the signal is written by a selector 601, and hence a wrong signal is written. Therefore, it is necessary that writing to the pixel from the source signal line is disabled until the signal corresponding to at least a pixel as an object is written, and the switch 17 is kept in the non-conducting state even in the writing and characteristic correcting period 92.

Since the luminance varies if the characteristic correction times vary one pixel to another, it is necessary to align the times for all the pixels. Accordingly, the switch 17 is brought into the conducting state in a period 614 after the selector 601 has selected for all the pixels to be selected as shown in FIG. 61 and the periods of characteristic correction are aligned.

In the writing and characteristic correcting period 92, the actions of the pixels described thus far are achieved by the same actions except that the conduction period of the switch 17 is shorter, so that the display device in which an effect of the voltage drop of the EL anodic power source line is reduced.

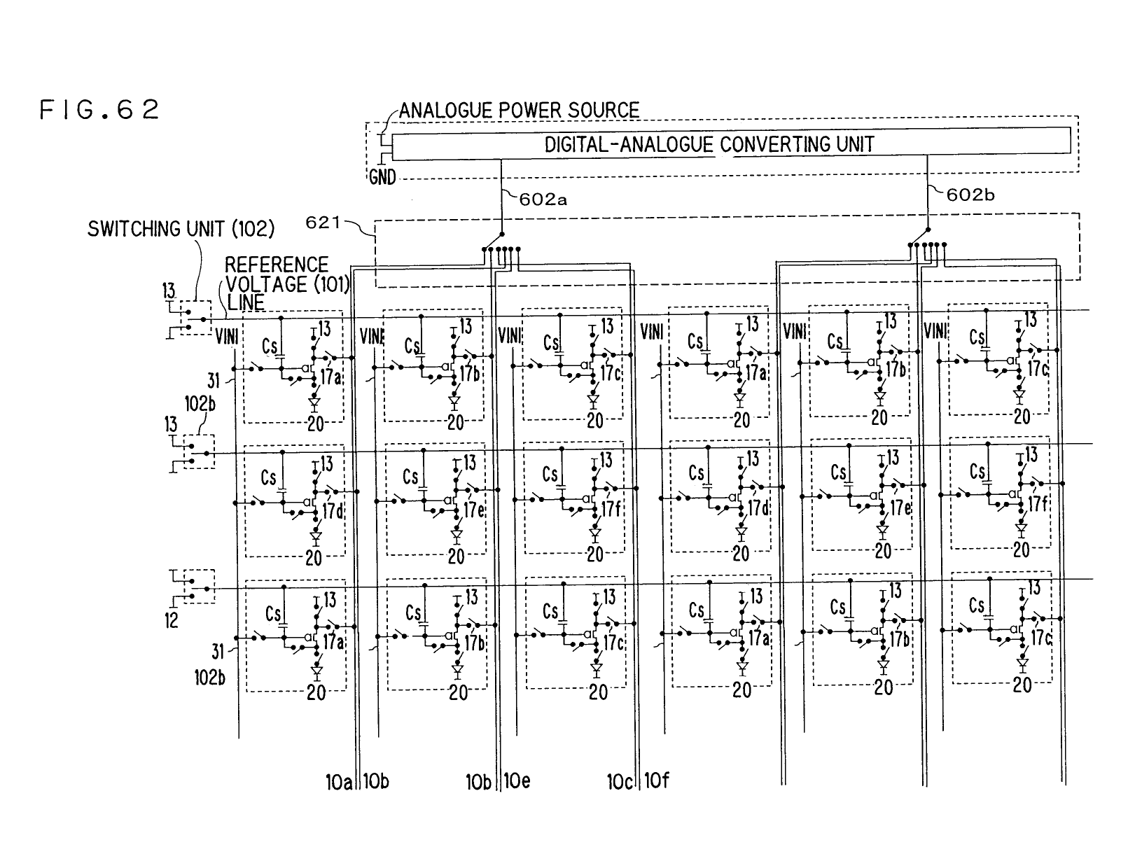

In addition, in this embodiment, the different source signal lines are used for the odd-numbered rows and the even-numbered rows as shown in FIG. 62 and, for example, in the case of the three source signal line selected driving, a system in which six source signal lines in total for the even-numbered rows and the odd-numbered rows are controlled by the selector 621 can also be applied to the respective pixels in the first embodiment.

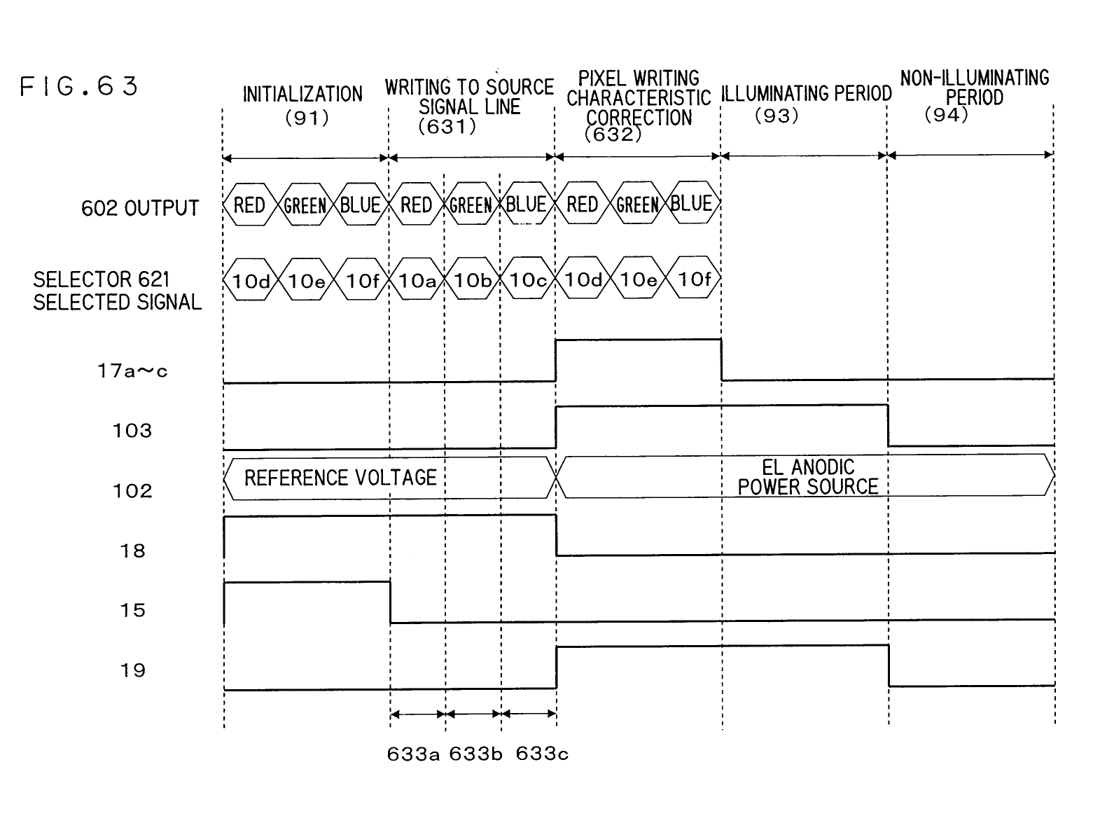

The selector 621, an output 602 from the source driver, and the actions of the switch 17 are shown in FIG. 63. Since the data from the source signal line 10 varies at every two horizontal scanning periods, the output voltages 602 of the source driver are written in the source signal line 10 in sequence during the first horizontal scanning period (writing period 631 to the source signal line). In the next horizontal scanning period, the switch 17 is brought into the conducting state with the pixel circuit from the source signal line 10, so that the signal writing to the pixel and characteristic correction are performed (corresponding to a period 632).

In this configuration, the action of the characteristic correction, which takes time, can be performed during substantially one horizontal scanning period, so that the signal can advantageously be written into the pixel to a sufficiently desired voltage. In addition, by using the pixel circuit 106 in this embodiment, an effect of preventing luminance fluctuations due to the wiring resistance of the power source supplied to the EL element 81 is demonstrated.

Since the number of outputs of the source driver is reduced and the number of the wiring lines from the source driver to the display section is reduced owing to the signal line selected drive, the number of wired lines is reduced, and the wiring in the area corresponding to the frame on the outside of the display section is reduced, so that the narrow frame design is achieved. In combination with the pixel circuit in this embodiment in which the power source wiring line to the EL element can be thinned, the frame is further downsized, and such advantage that a housing can be downsized to a size close to the size of the display area is achieved in compact video display terminals as shown in FIG. 56 to FIG. 58.

### Second Embodiment

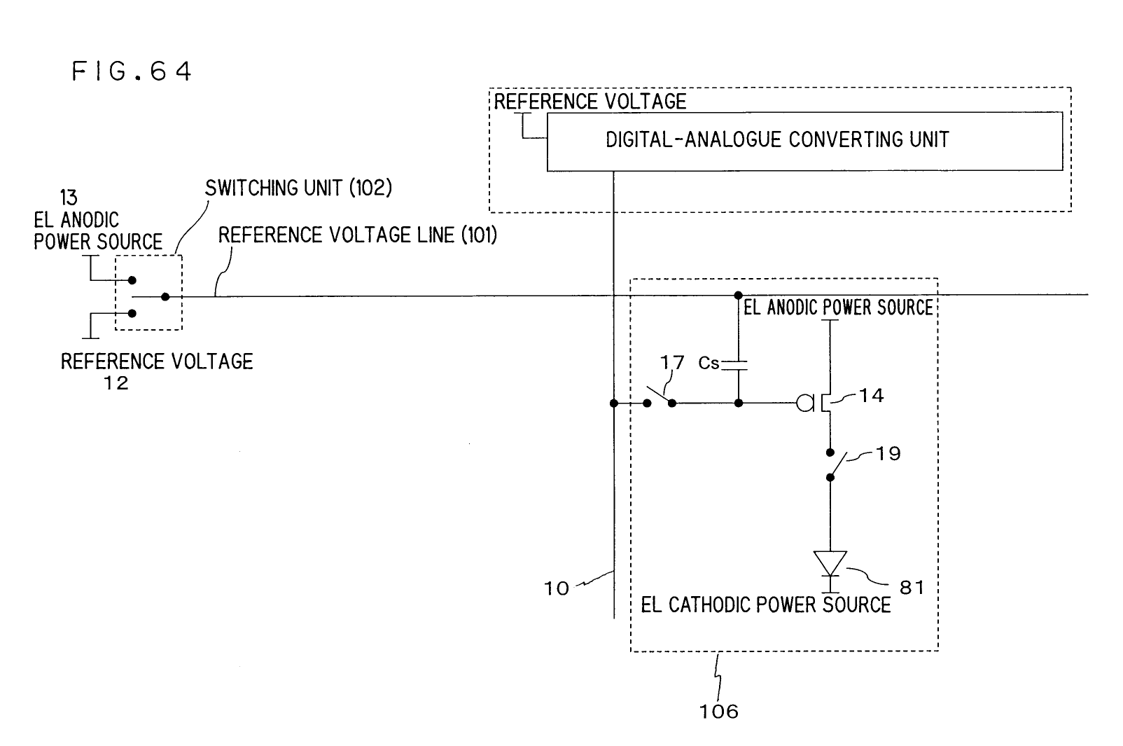

Referring now to FIG. 64 to FIG. 71, an EL display device according to a second embodiment of the invention will be described.

FIG. 64 shows a circuit applied to a different pixel circuit 106 in the EL display device in this embodiment. The pixel circuit 106 in FIG. 64 is configured to input the voltage from the source signal line 10 to the gate electrode of the drive transistor 14 via the switch 17, and determine the drain current from the drive transistor 14 by the voltage difference between the EL anodic power source 13 and the source signal line 10. The drain of the drive transistor 14 is connected to the EL element 81 via the switch 19, and the drain current of the drive transistor 14 determines the emission luminance of the EL element 81.

When accumulating the video signals from the source signal line 10 in the accumulation capacity Cs in the switch 17, the voltage at one end of the accumulation capacity Cs is set as the reference voltage 12, which is a voltage different from the EL anodic power source 13 for supplying the electric current to the EL element 81, so that the effect of the voltage fluctuations due to the wiring resistance is eliminated, and the voltage to be accumulated in the accumulation capacity Cs is applied on the basis of the voltage supplied from the source signal line 10 in the writing period. Accordingly, the voltage corresponding to the video signal on the basis of the voltage of the source signal line 10 is accumulated in the accumulation capacity Cs irrespective of the display pattern and the luminance.

In the illuminating period, by applying the EL anodic power source 13 to the reference voltage line 101, the same voltage as the source electrode of the drive transistor 14 is applied, and the voltage accumulated in the accumulation capacity Cs is applied between the source gates of the drive transistor 14.

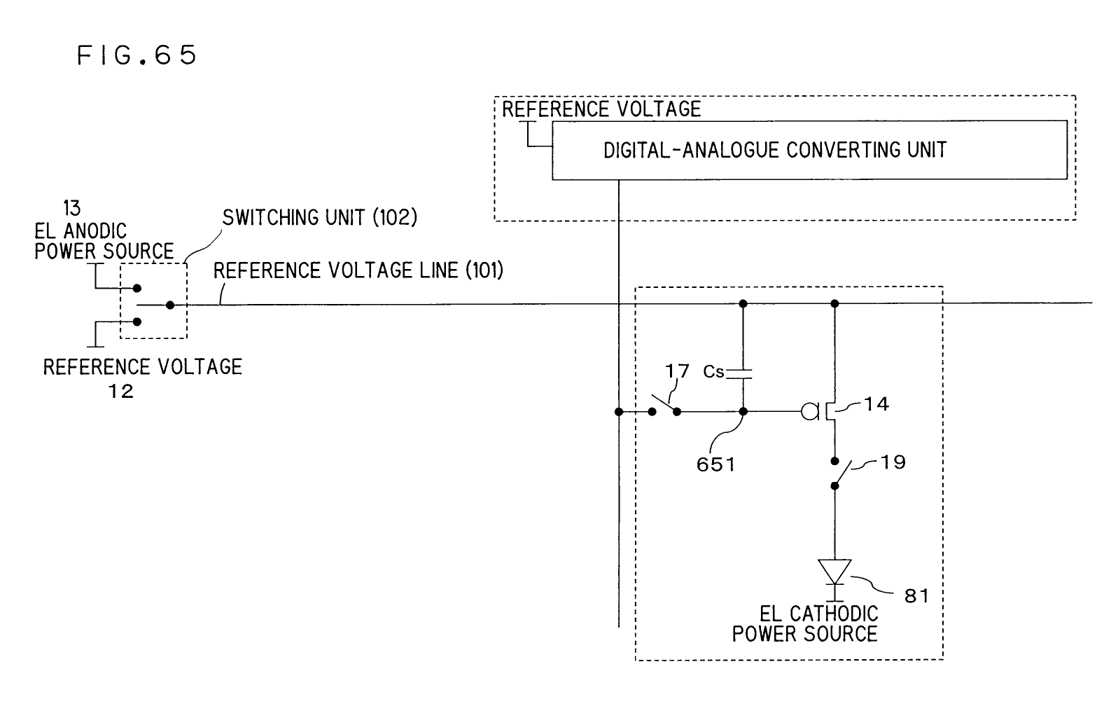

The implementation is also possible in the same manner by the configuration in which the source electrode of the drive transistor 14 is connected to the reference voltage line 101 as shown in FIG. 65 so as to supply an electric current from the EL anodic power source 13 via the switching unit 102 in the illuminating period instead of connecting to the EL anodic power source 13.

The switch 19 may be omitted if the non-illuminating period is not necessary in FIG. 64.

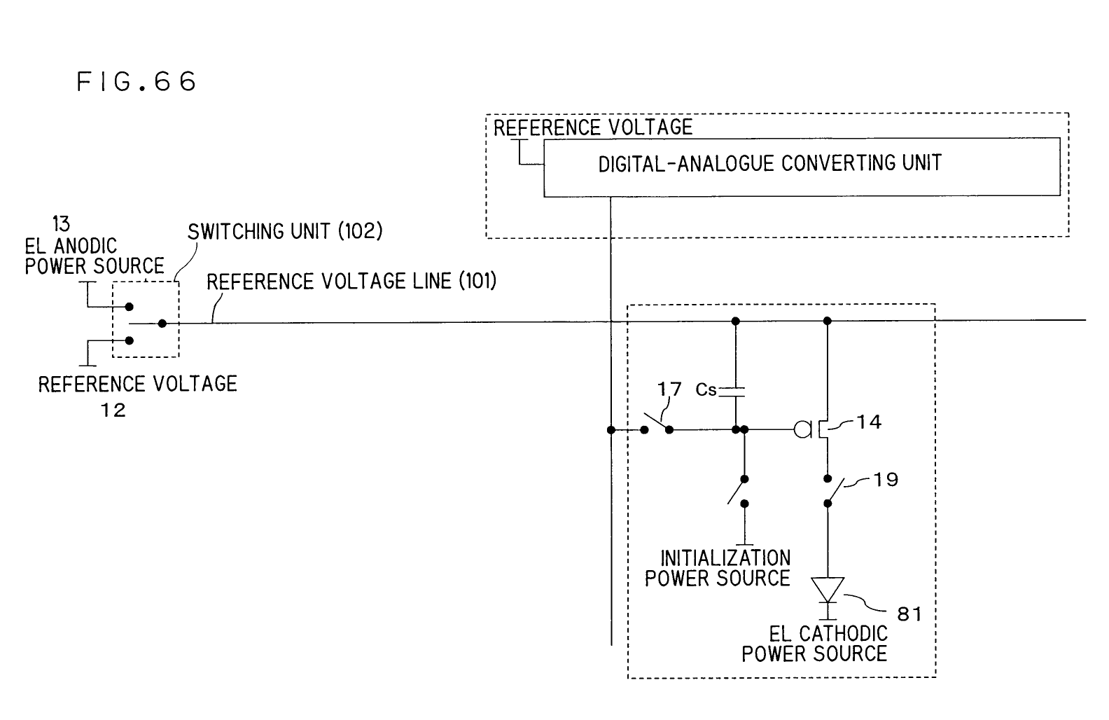

In addition, as a countermeasure for the fact that a bias voltage is applied to the drive transistor 14 in the pixel 106 and hence such phenomenon that gate voltage drain current characteristics of the drive transistor 14 is shifted occurs, there is a case where the characteristic shift is reduced by preparing an initialization power source 661, inputting the initialization power source 661 to the gate electrode of the drive transistor 14 in the non-illuminating period, and applying a reverse-biased voltage (see FIG. 66).

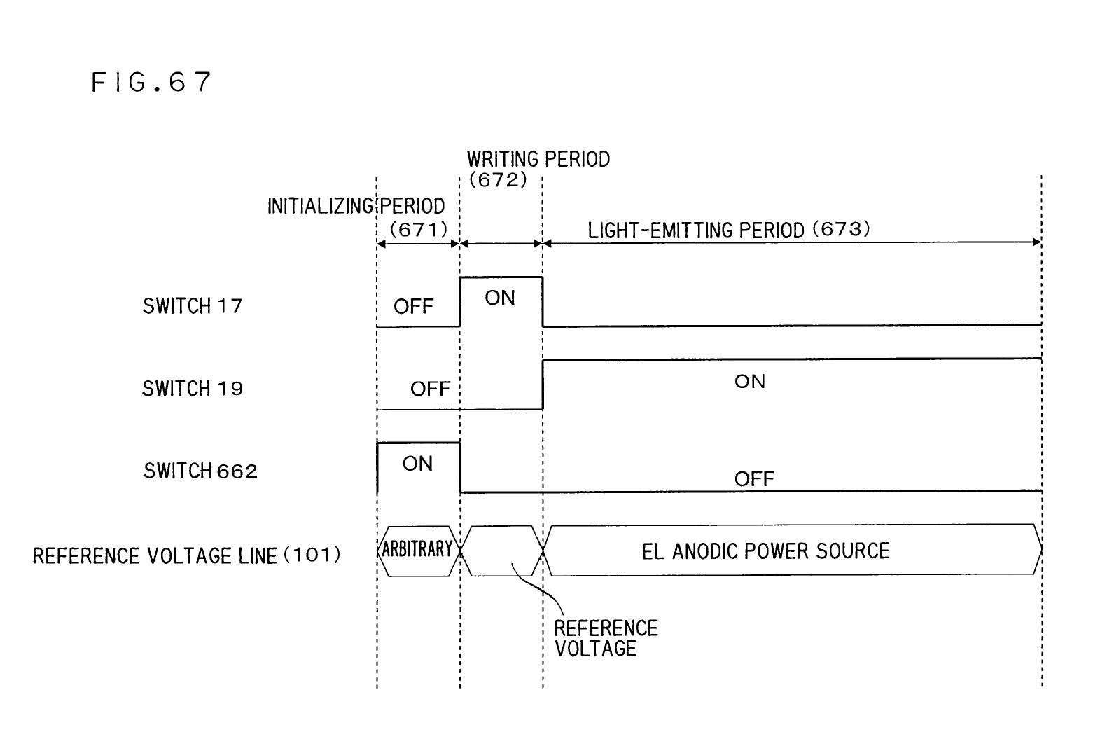

A timing chart in this embodiment will be shown in FIG. 67. In the pixel circuit shown in FIG. 66, an initializing period 671 is provided before writing the video signal in order to compensate the voltage current characteristic shift of the drive transistor 14, and the voltage of the initialization power source 661 is applied to the gate electrode of the drive transistor 14. The voltage of the initialization power source 661 is implemented by inputting a voltage higher than the EL anodic power source 13 or a voltage lower than the minimum voltage to be applied to the source signal line 10. The larger the voltage difference, the shorter time is required for obtaining the compensation effect of the characteristic shift.

The switch 19 is in the OFF state in the initializing period 671 in the timing chart in FIG. 67. However, when a voltage higher than the EL anodic power source 13 is input, it may be in the ON state. It is because that since the drain current of the drive transistor 14 does not flow, the EL element 81 is not illuminated irrespective of the state of the switch 19.

In the same manner, the switch 19 may be turned ON in the writing period 672.

The reference voltage line 101 may be any of the EL anodic power source 13 and the reference voltage 12 in the initializing period 671, and may be in the state of not being connected with any power sources depending on the configuration of the switching unit 102.

In the pixel circuit including the drive transistor 14, the switch 17 and the accumulation capacity Cs for deriving the video signal as shown in FIG. 64 and FIG. 65, the voltage of the EL anodic power source 13 may be lowered in the light-emitting period by the wiring resistance depending on the electric current flowing to the EL element 81.

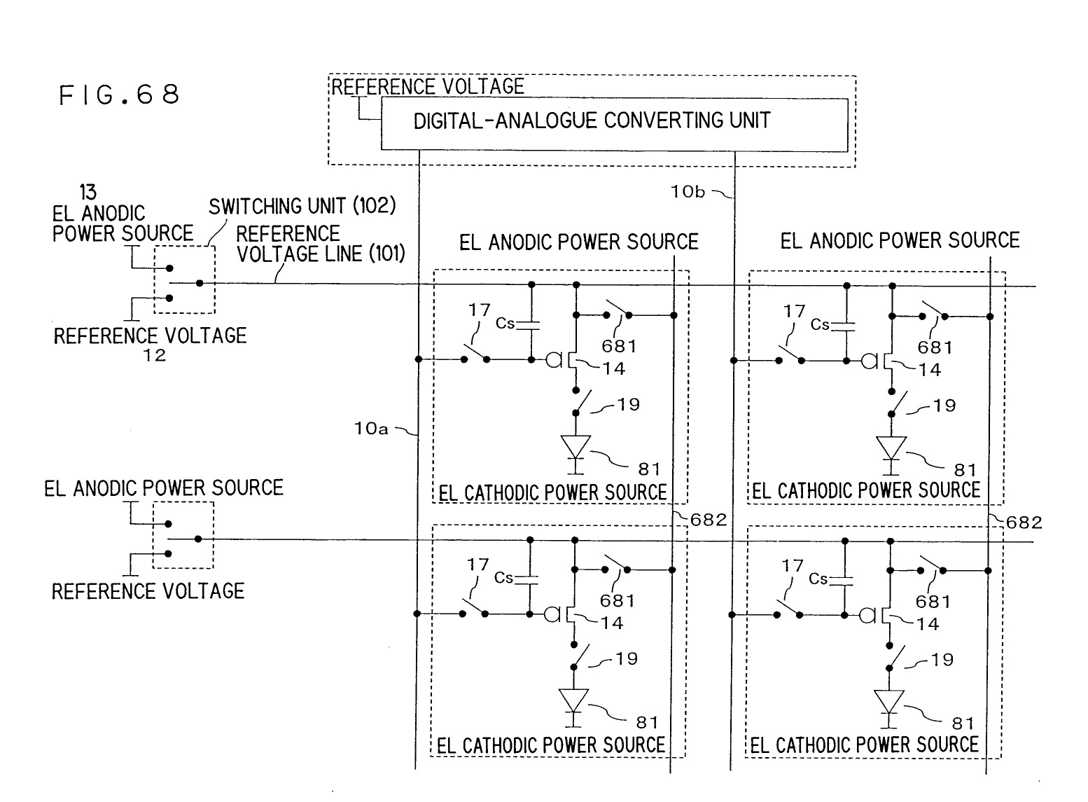

Therefore, as shown in FIG. 68, the EL anodic power sources 13 are wired not only in the lateral direction, but also in the vertical direction to supply the power sources from above, below, left, and right, whereby the wiring resistance and the current value are reduced and the voltage drop of the EL anodic power source 13 until the voltage is input to the pixel circuit 106 is reduced.

A switch 681 is added so as to avoid the application of the EL anodic power source 13 in the period where the reference voltage 12 is applied to the reference voltage line 101, so as to achieve the action in conjunction with the switching unit 102.

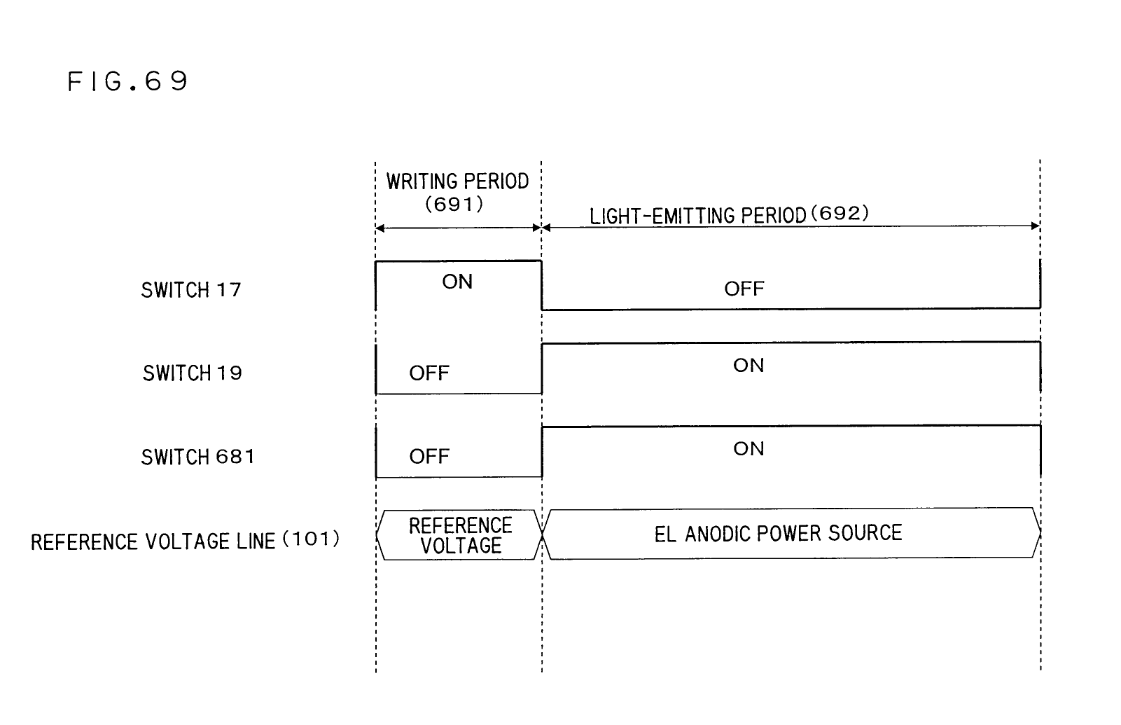

FIG. 69 shows an action waveform.

In a writing period 691, the switch 19 and the switch 681 are in the non-conducting state to block the power source supply from the EL anodic power source 13, and the potential of the accumulation capacity Cs is supported by the reference voltage 12. At the same time, the voltage of the source signal line 10 supports the potential of the other end of the accumulation capacity Cs by the switch 17, so that the effect of the voltage drop due to the wiring resistance of the EL anodic power source 13 is avoided, and the luminance fluctuation due to the display pattern or the like can be prevented.

In a light-emitting period 692, in addition to the current supply from the EL anodic power source 13 to the pixels of one row via the switching unit 102, the EL anodic power source is supplied in the column direction by a wiring line 682 to bring the switch 681 into the conducting state. Therefore, the electric current is supplied at least from two directions, and hence the electric current per wiring line is reduced, and the wiring resistance from the power source to the pixel circuit 106 is reduced. Consequently, the display device in which the voltage drop of the EL anodic power source 13 supplied to the interior of the pixel circuit 106 is small can be fabricated, and the display device having less fluctuations of the luminance due to the current value (display pattern) of the EL anodic power source 13 can be realized.

Also, the output voltage value at a power source circuit output unit can be reduced by an amount corresponding to the reduction of the voltage drop due to the wiring resistance (0.05 to 0.2V), so that reduction of the power consumption of the display device is effectively achieved.

In FIG. 68, an example of a configuration in which the power source is supplied from the left and above of the display section is shown. However, it may be supplied from the right or below, or a method of supplying the power from the both sides by providing switching units 102 on both left and right may be employed.

In the same manner, as regards the wiring line 682 as well, the EL anodic power source 13 may be supplied from one of above and below, or from both above and below.

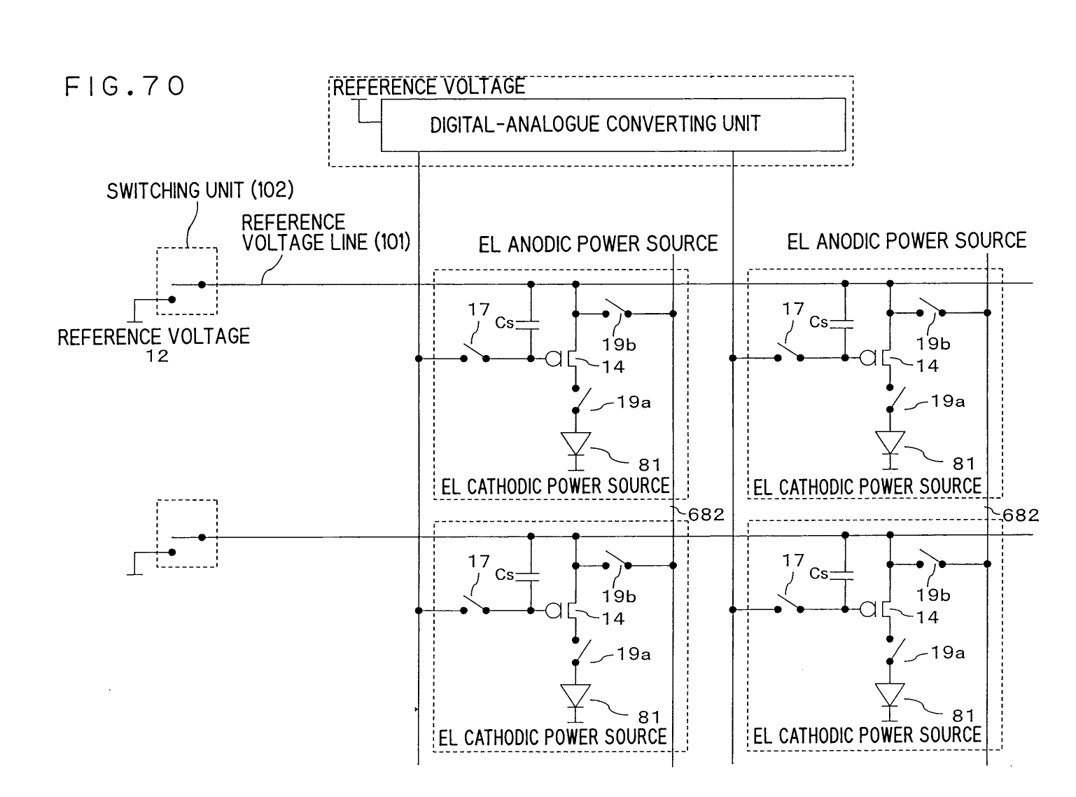

In a case where the device can be designed to be small enough to be able to ignore the voltage drop due to the wiring resistance only with the wiring line 682 of the EL anodic power source, as shown in FIG. 70, the input of the switching unit 102 may only be the reference voltage 12, and the EL anodic power source may be supplied only in the column direction.

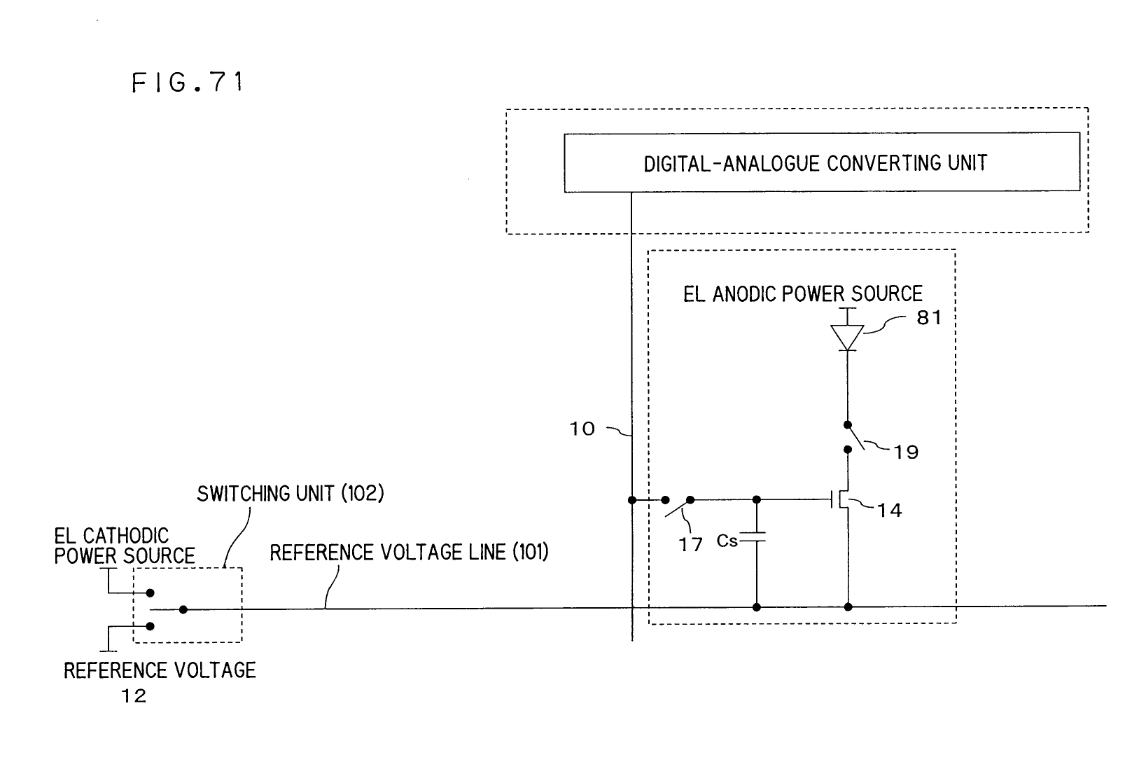

This embodiment can be implemented when the drive transistor 14 is of the n-type as shown in FIG. 71 in the same manner as being able to be implemented to the EL anodic power source 13 when the drive transistor 14 is of the p-type.

When the drive transistor 14 is of the n-type, the accumulation capacity Cs is connected to the EL cathodic power source, and hence the reference voltage line 101 may be configured to be switched between the reference voltage 12 and the EL cathodic power source.

### Third Embodiment

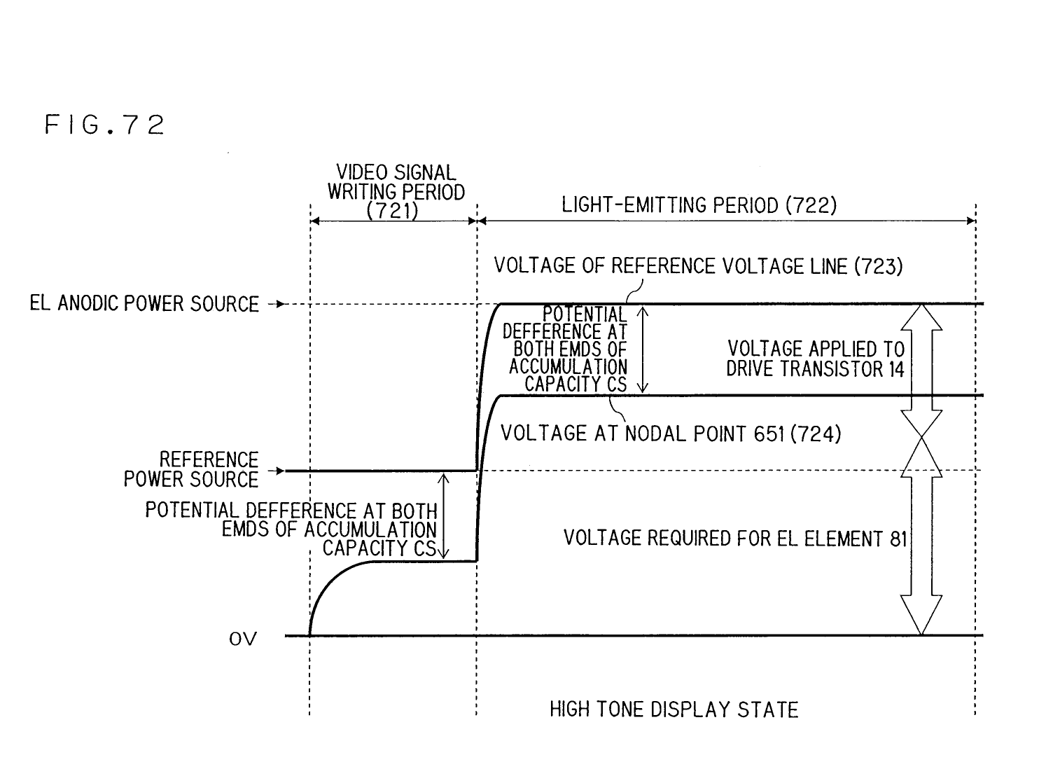

Referring now to FIG. 72, an EL display device according to a third embodiment will be described.

In the EL display device according to the second embodiment shown in FIG. 65 to FIG. 68, the voltage values of the reference voltage 12 and the EL anodic power source 13 can be changed for display.

When utilizing the variability of the voltage, the gate voltage of the drive transistor 14 can be changed in the writing period and the light-emitting period.

For example, in the configuration as described thus far, there is a case where the reference voltage 12 and the EL anodic power source 13 are set to 5V which is a breakdown voltage of the analogue output unit of the source driver and the EL cathodic power source is set to −5V in order to prepare a voltage required for the EL element 81 to emit light of white luminance.

Since two power sources, namely, the EL anodic power source 13 and the EL cathodic power source are needed to be prepared in order to drive the EL display device, and the EL cathodic power source is the power source which generates a negative voltage, it is a circuit in which a conversion efficiency for generating a predetermined voltage with respect to the input voltage is poor, and the loss in the power source circuit is significantly large.

Therefore, in this embodiment, as shown in FIG. 72, the voltage of the reference power source 12 is supplied at 5V corresponding to the breakdown voltage of an analogue output unit of the source driver in a writing period 721, and the video signal voltage from the source driver is written in a range from 0 to 5V.

Subsequently, in a light-emitting period 722, the voltage of the reference voltage 12 is set to 10V, and is applied to the reference voltage line 101.

The voltage of the gate voltage (nodal point 651) of the drive transistor 14 is in the non-conducting state while the switch 17 is in the light-emitting period 722. Therefore, the voltage fluctuates as shown by reference numeral 724 in FIG. 72 according to the voltage fluctuation of the reference voltage line 101 while maintaining the voltage accumulated in the accumulation capacity Cs during the writing period 721.

The voltage of the nodal point 651 is maintained to a potential equal to or higher than the voltage of the reference power source 12 during the light-emitting period. If the video signal voltage to the source signal line is 2V, the voltage at the nodal point 651 becomes 8V.

If the voltage required for the EL element 81 is 6V, the gate drain voltage of the drive transistor 14 is in the order of 2V even when the voltage of the EL cathodic power source is assumed to be 0V, so that the drive transistor 14 can be brought into action as a constant current source.

In this embodiment, by using the EL display device shown in FIG. 65 to FIG. 68, and differentiating the voltages of the reference power source 12 and the EL anodic power source 13, even when the source driver having a low breakdown voltage is used, the negative power source is eliminated while maintaining the video signal amplitude to a low level. The EL cathodic power source 20 is no longer necessary.

Accordingly, there is only the EL anodic power source 13 having a high power source generating efficiency, and hence the voltage of the EL anodic power source 13 is increased. However, a circuit with low power consumption can be realized as the display device.

### Fourth Embodiment

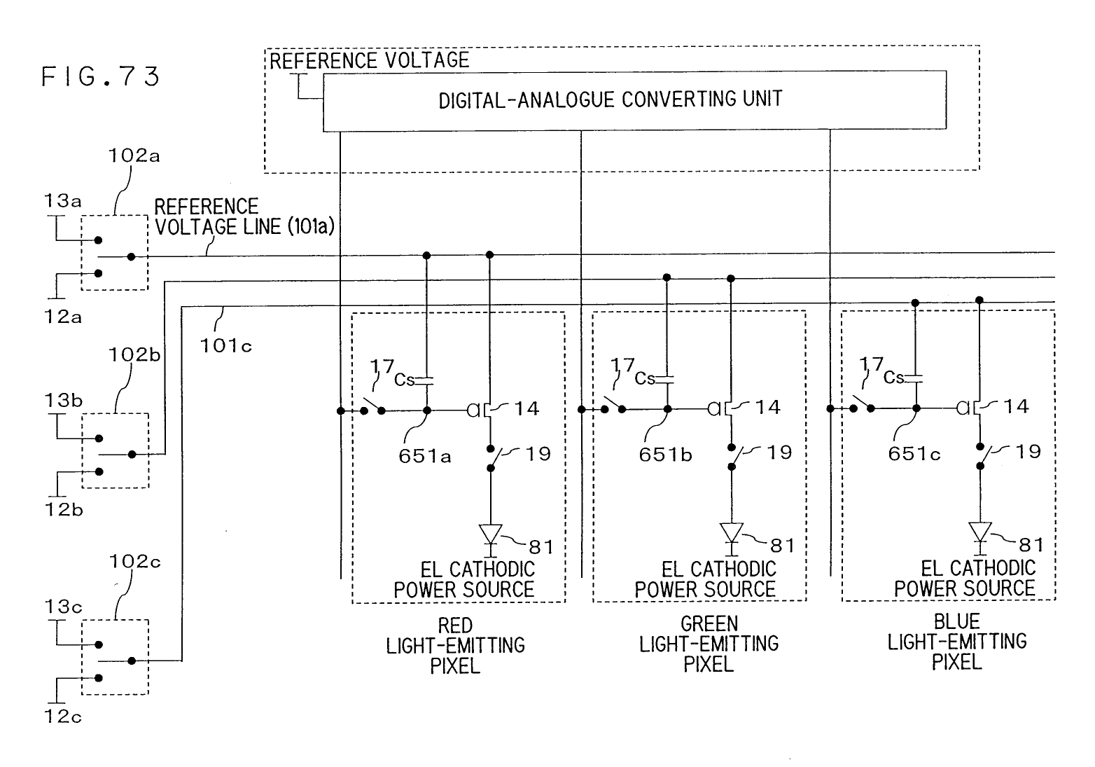

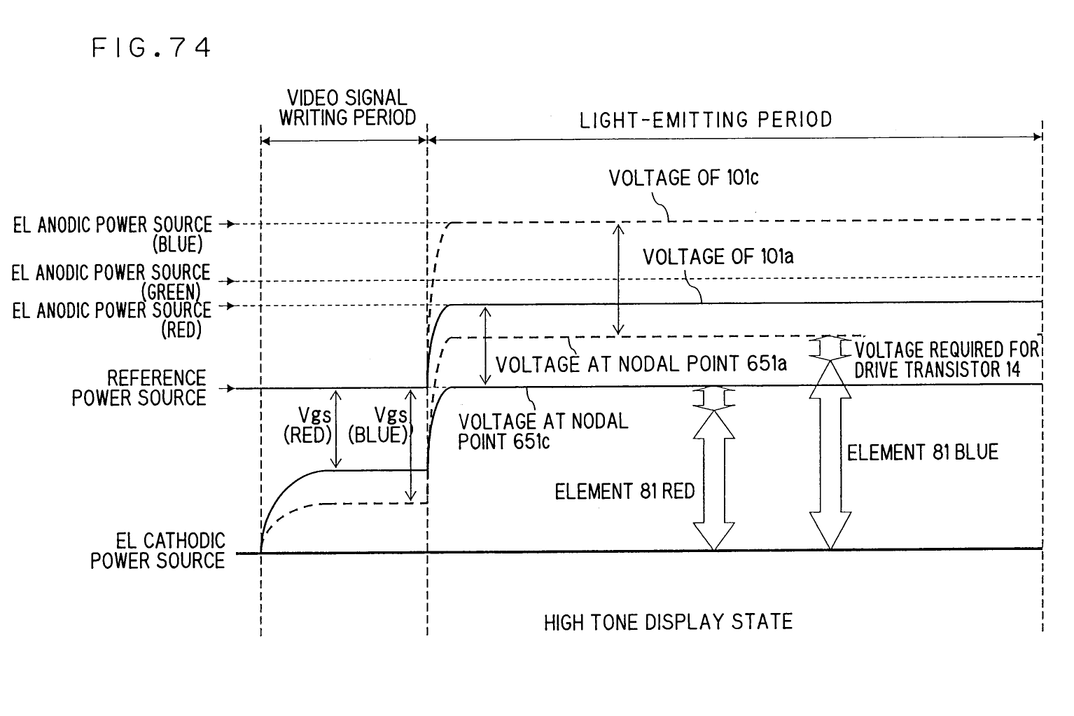

Referring now to FIG. 73 to FIG. 74, an EL display device according to a fourth embodiment will be described.

In order to save the electric power further from the EL display device according to the third embodiment, there is a method of differentiating the voltages of the EL anodic power sources 13 from one display color to another, and lowering the voltage of the EL anodic power source 13 for the display color whose voltage at the EL element 81 is low.

The circuit configuration in this embodiment is shown in FIG. 73. In this configuration, the reference voltage lines 101 can be arranged separately for the respective display colors, and the voltages of the EL anodic power sources 13 can be set individually.

In a case where the voltage required for the EL element 81 for red color is lower than the EL element 81 for blue color as shown in FIG. 74, by setting the voltage 101c of the EL anodic power source 13 for blue to a voltage 101a, the electric power can be reduced by an amount corresponding to (electric current flowing to red EL element 81)×(potential difference of EL anodic power sources).

Also, by separating the reference voltage lines 101 from one display color to another, the flowing current is reduced and the effect of the voltage drop due to the wiring resistance is reduced, so that the electric power can be lowered.

The EL cathodic power source may be set to 0V or may be a negative power source. Although the conversion efficiency is not improved, since the voltage is applied to the EL elements 81 by a minimum required level for the respective display colors in comparison with the system in the related art, a low-power configuration can be realized.

### Fifth Embodiment

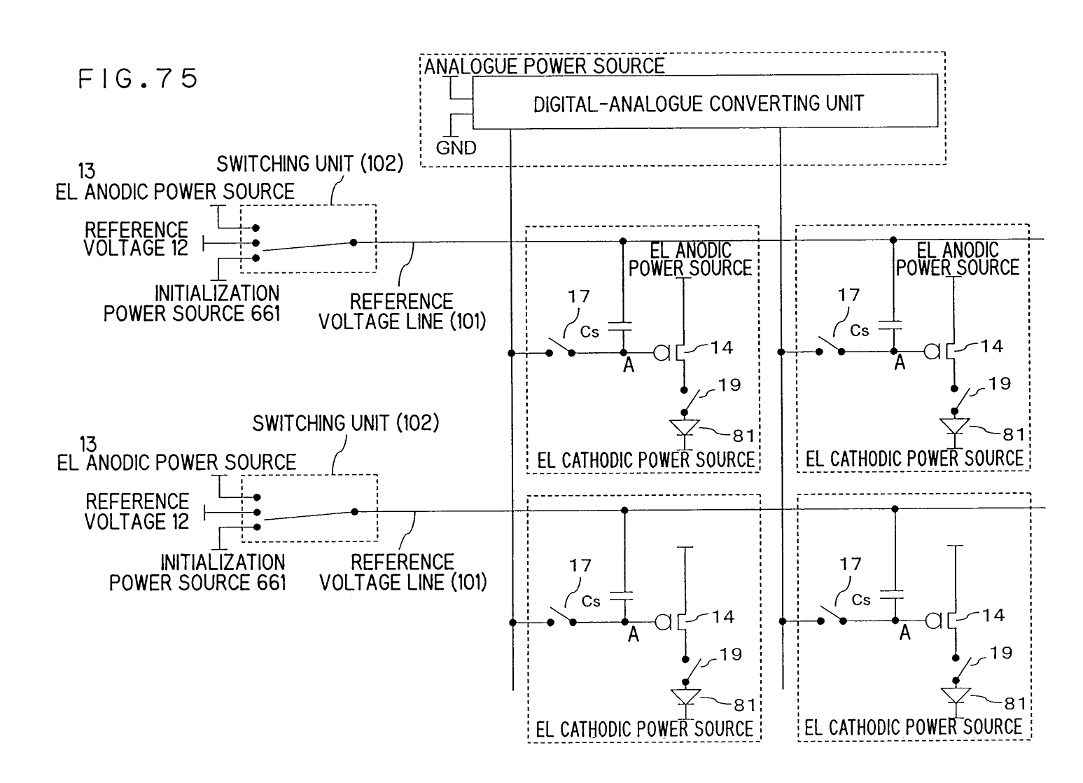

Referring now to FIG. 75 to FIG. 77, an EL display device according to a fifth embodiment will be described.

In FIG. 66, a method of forming a switch 662 for an initializing power source 661 in the pixel circuit in order to prevent the characteristic shift of the drive transistor 14 has been described.

In contrast, in this embodiment, utilizing the fact that the gate voltage of the drive transistor 14 can be fluctuated by fluctuating the voltage of the reference voltage line 101, it is configured to allow the initialization power source 661 to be input to the reference voltage line 101 as shown in FIG. 75.

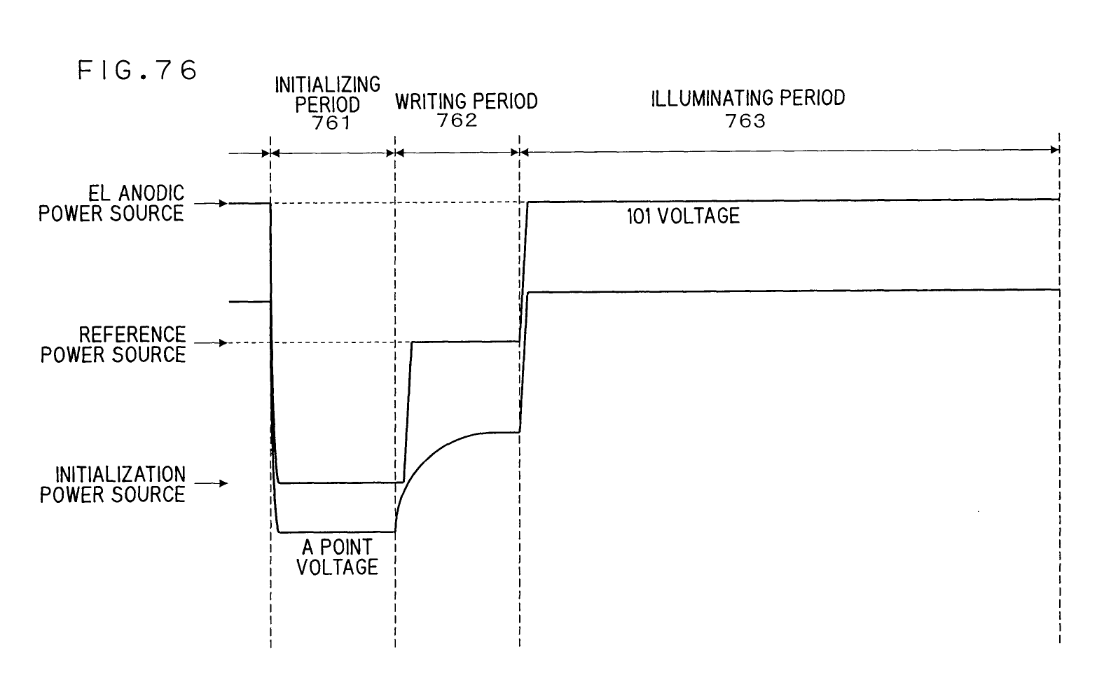

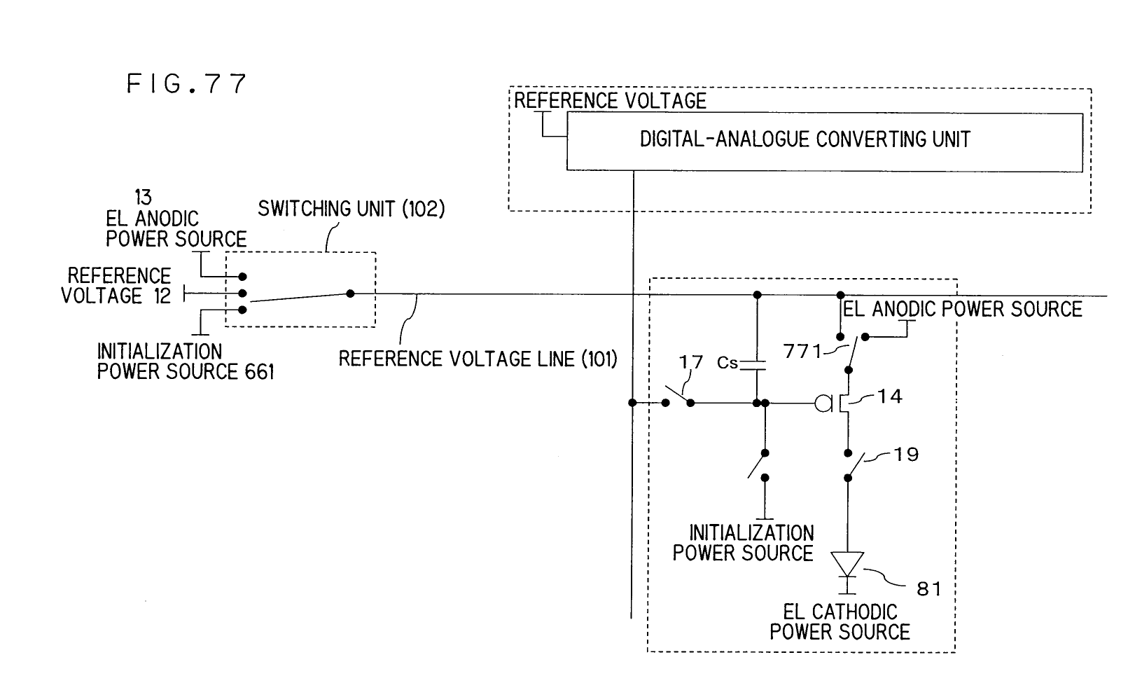

An operating method in this embodiment is shown in FIG. 76. In an initializing period 761, the voltage of the reference voltage line 101 is set to the initialization power source 661 for the display state of one frame before. The switch 17 and the switch 19 are brought into the non-conducting states. Since the source voltage of the drive transistor 14 is needed to be set to a high voltage, the EL anodic power source 13 is supplied. Accordingly, the nodal point A in FIG. 75 is lowered in association with the voltage fluctuation of the reference voltage line 101. The voltage at the nodal point A is different depending on the electric charge accumulated in the accumulation capacity Cs. Since only the application of a sufficiently low voltage is required (to increase the gate-source voltage of the drive transistor 14), what is essential is that the voltage at the nodal point A becomes the initialization power source in FIG. 66 when the amount of the electric charge in the accumulation capacity Cs is the amount after the black display, which is the least amount of accumulation. Setting of the voltage at the nodal point A is achieved by adjusting the voltage of the initialization power source 661. Here, although the description is made with an example in which the EL anodic power source is used as the source electrode of the drive transistor 14, another power source may be input using a switching device 771. Any system may be employed as long as a large voltage is applied between the gate-source electrodes of the drive transistor 14. A circuit in a modification is shown in FIG. 77.

As a method of implementing the characteristic compensation of the drive transistor, a method of applying a voltage higher than the source and drain electrodes to the gate voltage of the drive transistor 14 for initialization may be employed. In this case, the initialization power source 661 may be set to a voltage higher than the reference voltage so that the voltage at the point A becomes higher than the voltage supplied from the source driver. The higher the voltage, the faster compensation is possible. Therefore, a voltage higher than the EL anodic power source is preferably applied as the initialization power source.

Accordingly, application of a large voltage which is sufficient for the characteristic compensation of the drive transistor 14 is achieved to the source-gate voltage of the drive transistor 14 in the initializing period 761. The gate electrode may be any of a negative polarity and a positive polarity.

The initializing period 761 is preferably implemented for at least one horizontal scanning period, preferably, for a period of 10 to 50% of one frame. In order to shorten the initializing period 761, it is necessary to apply the power source of the initialization power source 661 so that an absolute value of the source-gate voltage of the drive transistor 14 becomes large. An absolute value of 5V or higher is preferable with respect to the source electrode. The higher the maximum voltage, the shorter time is required for the implementation. However, it is necessary to be set to a voltage equal to or lower than the breakdown voltage of the drive transistor 14.

After having ended the initializing period 761, a writing period 762 for writing the voltage on the basis of the video signal to the pixel is provided.

By bringing the switch 17 into the conducting state and causing the switching unit 102 to select the reference voltage 12 in the writing period 762, a voltage on the basis of the video signal is applied to the accumulation capacity Cs, and a voltage which is not fluctuated irrespective of the illumination pattern of other pixels is applied thereto.

After having written the video signal, in an illuminating period 763, the switching unit 102 selects the EL anodic power source 13, and hence the EL anodic power source voltage is input to the reference voltage line 101, so that the switch 19 is brought into the conducting state, and hence the EL element 81 emits light according to the video signal.

In the example shown in FIG. 76, an example in which one frame includes the initializing period 761, the writing period 762, and the illuminating period 763 is shown. However, the non-illuminating period may be provided in order to implement the black insertion. In this case, it can be realized by bringing the switch 19 into the non-conducting state in a given period of the illuminating period 763. It is also possible to input by dividing into a plurality of times.

Since it is the non-illuminating state in the initializing period 761, the non-illuminating period may be implemented by the initializing period 761.

It can be implemented by means other than the transistor as long as connection and non-connection can be electrically changed over. In the drawing, it is shown by a switch for the sake of convenience.

### [Modification]

The invention is not limited to the respective embodiments described above, and may be modified variously without departing the scope of the invention.

In the case of the transistor, the invention is applicable to both the n-type and the p-type. The invention can be realized in the same manner not only by the TFT, but also by the bi-polar transistor. As regards the TFT, the invention may be implemented in the same manner by any materials such as polysilicon, crystal silicon, amorphous silicon, oxide semiconductor, and so on.

This embodiment may be implemented in combination with respective embodiments. By being implemented in combination, a plurality of advantages can be obtained in combination or selectively.

The pixels of the EL display device in the embodiments such as a mono-color pixel configuration, three colors of red, green, and blue, four colors of red, green, blue, and white, three colors of cyan, yellow, and magenta, a Pen Tile pixel configuration, and so on may be applied irrespective of the display colors.

Although the pixel configuration for one column is described in FIG. 14 and FIG. 16, the configuration formed into a stripe pattern or into a delta arrangement may be applied in the same manner as long as there are a plurality of pixels using a common source signal line.

### INDUSTRIAL APPLICABILITY

The EL display device according to the embodiments of the invention is capable of displaying without display unevenness even though the voltage of the power source for the EL element fluctuates, so that a desirable image display is realized.

What is claimed is:

1. An EL display device including pixels having an EL element arranged into a matrix pattern comprising:
a drive transistor configured to determine an electric current to be supplied to the EL element; and
a capacity for retaining a gate voltage of the drive transistor, wherein
a gate electrode of the drive transistor is connected to a first electrode, which is one of electrodes of the capacity,
(1) a first power source is connected to a second electrode, which is the other electrode of the capacity, in a first period in which a signal from a source signal line is applied to the drive transistor, and
(2) a second power source is connected to the second electrode, which is the other electrode of the capacity, in a second period in which the drive transistor supplies an electric current to the EL element.

2. The EL display device according to claim 1, wherein the first power source supplies a reference voltage.

3. The EL display device according to claim 1, wherein the reference voltage fluctuates synchronously with a voltage of a signal supplied from the source signal line.

4. The EL display device according to claim 1, comprising a switching unit configured to connect the first power source and the second power source alternately.

5. The EL display device according to claim 4, wherein the switching unit is formed for each of the pixels.

6. The EL display device according to claim 5, wherein the switching unit connects the first power sources and the second power sources of all the pixels of a row or a plurality of rows formed into the matrix pattern alternately.

7. A method of driving an EL display device including:
a plurality of pixels formed into a matrix pattern;
EL elements included in the respective pixels;
a drive transistor configured to determine an electric current to be supplied to the EL element; and
a capacity configured to retain a gate voltage of the drive transistor; comprising:
connecting a gate electrode of the drive transistor to a first electrode, which is one of electrodes of the capacity;
connecting a first power source to a second electrode, which is the other electrode of the capacity in (1) a first period in which a signal from a source signal line is applied to the drive transistor; and
connecting a second power source to the second electrode, which is the other electrode of the capacity in (2) a second period in which the drive transistor supplies an electric current to the EL element.
